(19) United States
(12) Patent Application Publication
(10) Pub. No.: US 2025/0116156 A1
(43) Pub. Date: Apr. 10, 2025

(54) WINDOW TREATMENT MOUNTING SYSTEM

(71) Applicant: Lutron Technology Company LLC, Coopersburg, PA (US)

(72) Inventors: Melanie S. Goddard, Fogelsville, PA (US); Edward J. Blair, Telford, PA (US); David A. Kirby, Zionsville, PA (US); Mailing Ren Wu, Lansdale, PA (US)

(73) Assignee: Lutron Technology Company LLC, Coopersburg, PA (US)

(21) Appl. No.: 18/907,478

(22) Filed: Oct. 5, 2024

Related U.S. Application Data
(60) Provisional application No. 63/588,283, filed on Oct. 5, 2023.
(60) Provisional application No. 63/543,015, filed on Oct. 6, 2023.
(60) Provisional application No. 63/566,872, filed on Mar. 18, 2024.
(60) Provisional application No. 63/568,414, filed on Mar. 21, 2024.

(51) Int. Cl. E06B 9/42; E06B 9/72; F16M 13/02

(52) U.S. Cl. CPC E06B 9/42; E06B 9/72; F16M 13/02

(57) ABSTRACT

A motorized window treatment may include a roller tube, a motor drive unit, a mounting bracket, and a connector. The roller tube may have a flexible material attached thereto. The roller tube may have first and second ends. The roller tube may be configured to rotate about a longitudinal axis that defines a longitudinal direction. The motor drive unit may be configured to rotate the roller tube to adjust the flexible material between a raised position and a lowered position. The motor drive unit may include an end portion that is accessible via the first end of the roller tube. The connector may be configured to be disposed in the channel. The connector may be configured to electrically connect the motor drive unit to electrical wiring for powering the motor drive unit when the end portion of the motor drive unit is received within the channel.

### CROSS-REFERENCE TO RELATED APPLICATIONS

This application claims priority from Provisional U.S. Patent Application No. 63/588,283, filed Oct. 5, 2023, Provisional U.S. Patent Application No. 63/543,015, filed Oct. 6, 2023, Provisional U.S. Patent Application No. 63/566,872, filed Mar. 18, 2024, and Provisional U.S. Patent Application No. 63/568,414, filed Mar. 21, 2024, the entire disclosures of which are hereby incorporated by reference herein in their entirety.

### BACKGROUND

A window treatment may be mounted in front of one or more windows, for example to prevent sunlight from entering a space and/or to provide privacy. Window treatments may include, for example, roller shades, roman shades, venetian blinds, or draperies. A roller shade may include a flexible shade fabric wound onto an elongated roller tube. Such a roller shade may include a weighted hembar located at a lower end of the shade fabric. The hembar may assist the shade fabric hanging vertically in front of one or more windows over which the roller shade is mounted.

A window treatment may be mounted to a structure surrounding a window, such as a window frame. Such a window treatment may include brackets at opposed ends thereof. The brackets may be configured to operably support a roller tube, such that the flexible material may be raised and lowered. For example, the brackets may be configured to support respective ends of the roller tube. The brackets may be attached to a structure, such as a wall, ceiling, window frame, or other structure. Such a window treatment may be motorized.

### SUMMARY

As described herein, a motorized window treatment may include a roller tube having flexible material that is attached thereto, the roller tube may have first and second ends, and may be configured to rotate about a longitudinal axis that defines a longitudinal direction. The motorized window treatment may further include a motor drive unit located within the roller tube adjacent the first end of the roller tube. The motor drive unit may be configured to rotate the roller tube to adjust the flexible material between a raised position and a lowered position. The motor drive unit may include an end portion that is accessible via the first end of the roller tube. The motorized window treatment may further include a mounting bracket configured to support the first end of the roller tube. The mounting bracket may include an arm, an attachment member extending from the arm, and a channel defined by the attachment member. The channel may be configured to receive the end portion of the motor drive unit. The channel may define a rear wall that is proximate to the arm and a first opening that is distal from the rear wall in a radial direction. The motorized window treatment may further include a connector connected to the attachment member within the channel of the mounting bracket. The connector may include a plug portion configured to be received within a second opening on the end portion of the motor drive unit to electrically connect the motor drive unit to a power source for powering the motor drive unit when the end portion of the motor drive unit is received within the channel. The plug portion may extend towards the first opening of the channel.

A motorized window treatment may include a roller tube, a motor drive unit, and a mounting system. The roller tube may have a flexible material attached thereto. The roller tube may have first and second ends. The roller tube may be configured to rotate about a longitudinal axis that defines a longitudinal direction. The motor drive unit may be located within the roller tube adjacent the first end of the roller tube. The motor drive unit may be configured to rotate the roller tube to adjust the flexible material between a raised position and a lowered position. The motor drive unit may include an end portion that is accessible via the first end of the roller tube.

The mounting system may include a mounting bracket, a channel, and/or a connector. The mounting bracket may be configured to support the first end of the roller tube. The mounting bracket may include an arm configured to extend from the structure. The mounting bracket may include an attachment member extending from the arm. The channel may be defined by the attachment member. The channel may be configured to receive the end portion of the motor drive unit. The channel may define a rear wall that is proximate to the arm and a first opening that is distal from the rear wall in a radial direction. The connector may be configured to be affixed proximate the rear wall in the channel. The connector may include a plug portion configured to be received within a second opening on the end portion of the motor drive unit to electrically connect the motor drive unit to electrical wiring for powering the motor drive unit when the end portion of the motor drive unit is received within the channel. The plug portion may extend away from the rear wall and toward the first opening of the channel. The mounting bracket may be configured to mount the roller tube to a structure.

The connector may include a base portion configured to abut the rear wall of the channel. The connector may include a pair of connector arms that are configured to extend within the first channel in the radial direction. The channel may be defined by a first flange, a second flange, and a side wall that is distal from the first and second flanges in the longitudinal direction. A first connector arm of the pair of connector arms may be located within a first slot defined by the first flange. A second connector arm of the pair of connector arms may be located within a second slot defined by the second flange. The first connector arm may define a first ridge and a first tab that are configured to abut a first edge of the first slot. The second connector arm defines a second ridge and a second tab that are configured to abut a second edge of the second slot. The first connector arm may define a first groove that is configured to receive a first rail of the end portion of the motor drive unit. The second connector arm may define a second groove that is configured to receive a second rail of the end portion of the motor drive unit. The connector may be removably attached to the first mounting bracket. The plug portion may include a plurality of openings that are configured to receive conductors located within the second opening when the end portion of the motor drive unit is received within the first channel of the first mounting bracket.

The motorized window treatment may include a second mounting system comprising a second mounting bracket configured to support the second end of the roller tube. The second mounting bracket may include a second arm configured to extend from the structure. The second mounting bracket may include a second attachment member extending from the second arm. The second mounting bracket may include a second channel defined by the second attachment member. The second channel may be configured to slidingly receive the second end of the roller tube.

The mounting bracket may include a base that is configured to attach the mounting bracket to the structure. The base may include a notch on a face that is distal from the arm. The notch may be configured to receive electrical wiring for powering the motor drive unit such that the electrical wiring enters the structure proximate to the notch. The face may be parallel to the first arm. The face may be an interior face that faces a second mounting bracket. The mounting bracket may define a first trench in the arm that extends from the base to the channel. The mounting bracket may define a second trench defined in the base. The second trench may extend from the base to the notch. The first trench and the second trench may be configured to receive the electrical wiring. The first trench may be recessed from an inside surface of the arm and the second trench may be recessed from a front surface of the base. The first trench may be formed on an edge surface of the arm and the second trench may be defined in a rear surface of the base. The motorized window treatment may include a second connector configured to electrically couple the motor drive unit to a power source via the electrical wiring. The second connector may connect the electrical wiring to electrical conductors received through an electrical wallbox. The second connector may include a plurality of terminals that are located within the base. The motorized window treatment may include one or more covers that are configured to cover the first trench and the second trench.

### BRIEF DESCRIPTION OF THE DRAWINGS

FIG. 1 is an example motorized window treatment.

FIG. 2 is a partially exploded view of the example motorized window treatment shown in FIG. 1.

FIG. 3A is an enlarged perspective view of the example motorized window treatment shown in FIG. 1 with a sliding cover in a closed position.

FIG. 3B is an enlarged perspective view of the example motorized window treatment shown in FIG. 1 with the sliding cover in an open position.

FIG. 4 is an enlarged front cross-section view of the example motorized window treatment shown in FIG. 1.

FIG. 5A is a front perspective view of an example end portion of a roller tube of the example motorized window treatment shown in FIG. 1.

FIG. 5B depicts a rear perspective view of the motorized window treatment having the example end portion shown in FIG. 5A.

FIG. 6 is a block diagram of an example mounting system for mounting a roller tube assembly illustrating electrical wiring of the mounting system.

FIGS. 7A-7D depict an example mounting system for mounting a roller tube assembly of a motorized window treatment.

FIGS. 7E-7H depict another example mounting system for mounting one or more roller tube assemblies of a motorized window treatment.

FIG. 8A depicts another example mounting system for mounting a roller tube assembly of a motorized window treatment.

FIG. 8B depicts another example mounting system for mounting a roller tube assembly of a motorized window treatment.

FIG. 9A depicts another example mounting system for mounting a roller tube assembly of a motorized window treatment.

FIG. 9B depicts another example mounting system for mounting a roller tube assembly of a motorized window treatment.

FIGS. 10A-10B depict another example mounting system for mounting a roller tube assembly of a motorized window treatment.

FIG. 10C depicts another example mounting system for mounting a roller tube assembly of a motorized window treatment.

FIG. 10D depicts another example mounting system for mounting a roller tube assembly of a motorized window treatment.

FIGS. 11A-11B depict another example mounting system for mounting a roller tube assembly of a motorized window treatment.

FIGS. 12A-12D depict another example mounting system for mounting a roller tube assembly of a motorized window treatment.

FIGS. 13A-13C depict another example mounting system for mounting a roller tube assembly of a motorized window treatment.

FIGS. 14A-14B depict another example mounting system for mounting a roller tube assembly of a motorized window treatment.

FIGS. 14C-14D depict another example mounting system for mounting a roller tube assembly of a motorized window treatment.

FIGS. 14E-14F depict another example mounting system for mounting one or more roller tube assemblies of a motorized window treatment.

FIGS. 15A-15H depict another example mounting system for mounting a roller tube assembly of a motorized window treatment.

FIGS. 15I-150 depict another example mounting system for mounting a roller tube assembly of a motorized window treatment.

FIGS. 15P-15V depict another example mounting system for mounting one or more roller tube assemblies of a motorized window treatment.

FIG. 16 is a simplified block diagram of a motor drive unit of a motorized window treatment.

### DETAILED DESCRIPTION

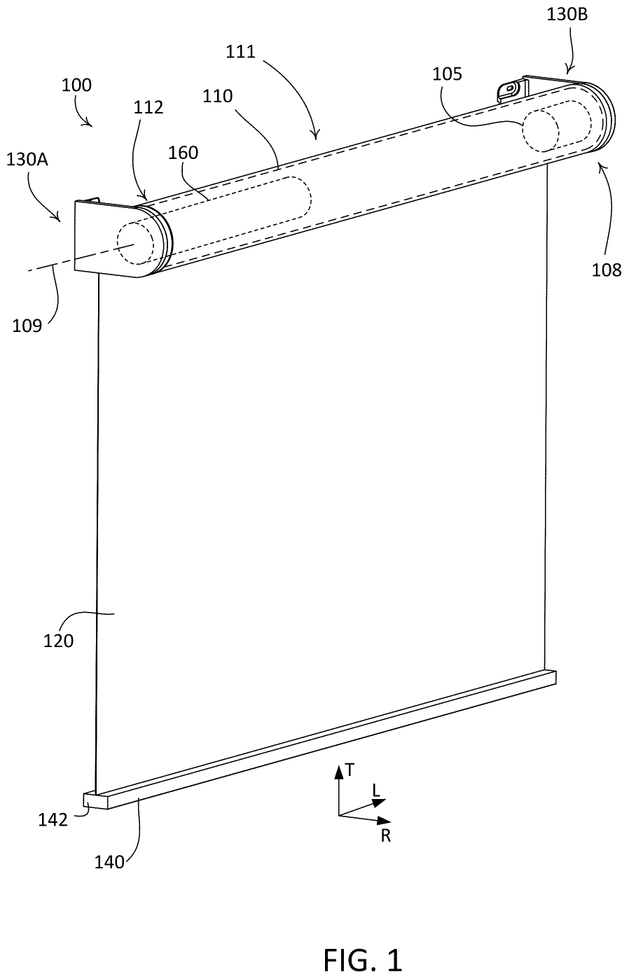

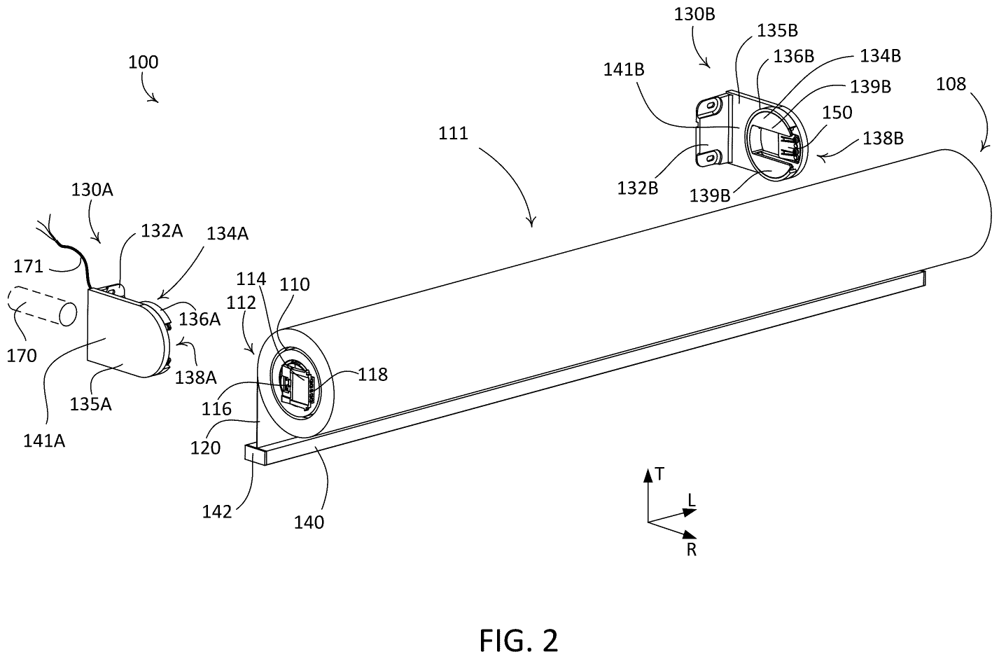

FIG. 1 depicts an example motorized window treatment 100 (e.g., a motorized window treatment system) that includes a roller tube 110 and a flexible material 120 (e.g., a covering material) windingly attached to the roller tube 110. FIG. 2 is a partially exploded view of the example motorized window treatment 100 shown in FIG. 1. The motorized window treatment 100 may be a window treatment assembly that includes a roller tube assembly 111 and one or more mounting systems 130A, 130B. The roller tube assembly 111 may include a roller tube 110, a flexible material 120, a drive assembly (e.g., a motor drive unit) 160 at a first end 112 of the roller tube assembly 111, and an idler 105 at a second end 108 of the roller tube assembly 111. Each of the mounting systems 130A, 130B may be configured to be coupled to or otherwise mounted to a structure. For example, each of the mounting systems 130A, 130B may be configured to be mounted to (e.g., attached to) a window frame, a wall, a ceiling, or other structure, such that the motorized window treatment 100 is mounted proximate to an opening (e.g., over the opening or in the opening), such as a window for example. Each of the mounting systems 130A, 103B may be configured to be mounted to a vertical structure (e.g., wall-mounted to a wall as shown in FIG. 1) and/or mounted to a horizontal structure (e.g., ceiling-mounted to a ceiling).

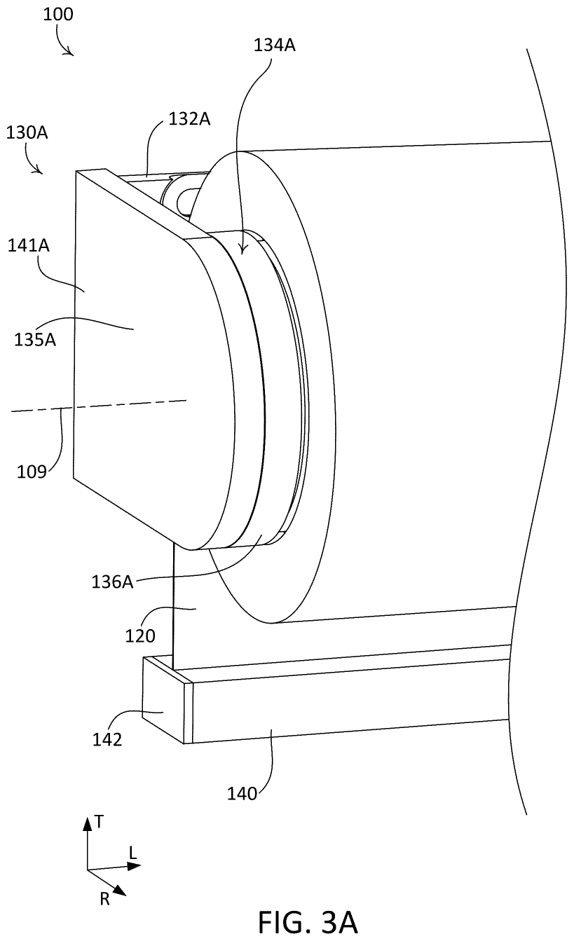

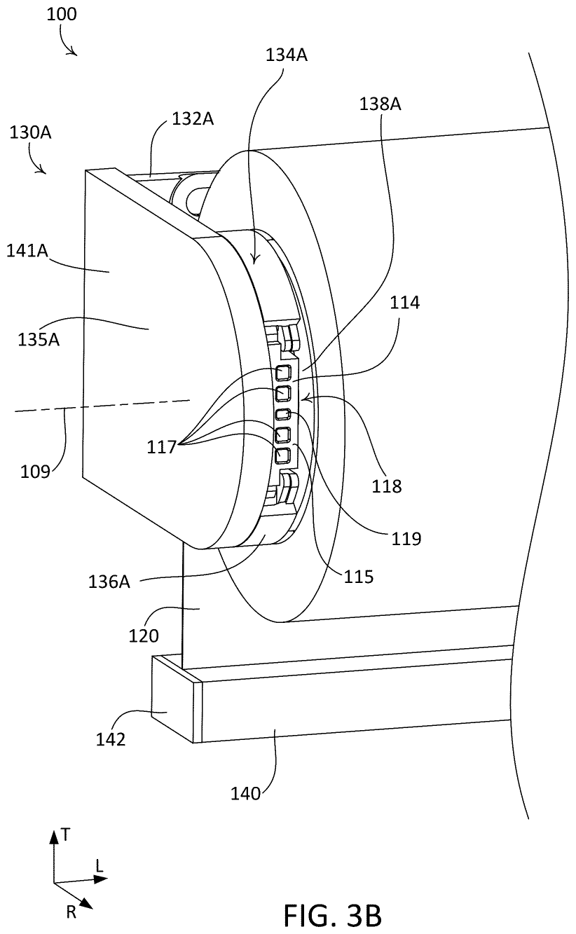

The roller tube 110 may operate as a rotational element of the motorized window treatment 100. The roller tube 110 may be elongate along a longitudinal direction L. The roller tube assembly 111 may be rotatably mounted to (e.g., rotatably supported by) the mounting systems 130A, 130B. The roller tube 110 may define a longitudinal axis 109. The longitudinal axis 109 may extend along the longitudinal direction L. The mounting systems 130A, 130B may extend from the structure in a radial direction R (e.g., when mounted to a vertical structure). The radial direction R may be defined as a direction perpendicular to the structure (e.g., vertical structure) and the longitudinal axis 109. The mounting systems 130A, 130B may extend from the structure in a transverse direction T (e.g., when mounted to a horizontal structure). The transverse direction T may be defined as a direction perpendicular to the horizontal structure and the longitudinal axis 109. The flexible material 120 may be windingly attached to the roller tube 110, such that rotation of the roller tube 110 causes the flexible material 120 to wind around or unwind from the roller tube 110 along the transverse direction T that extends perpendicular to the longitudinal direction L. For example, rotation of the roller tube 110 may cause the flexible material 120 to move between a raised (e.g., open) position (e.g., as shown in FIG. 3A/3B) and a lowered (e.g., closed) position (e.g., as shown in FIG. 1) along the transverse direction T.

The roller tube 110 may be a low-deflection roller tube and may be made of a material that has high strength and low density, such as carbon fiber. The roller tube 110 may have, for example, a diameter of approximately two inches. For example, the roller tube 110 may exhibit a deflection of less than ¼ of an inch when the flexible material 120 has a length of 12 feet and a width of 12 feet (e.g., and the roller tube 110 has a corresponding width of 12 feet and the diameter is two inches). Examples of low-deflection roller tubes are described in greater detail in U.S. Patent Application Publication No. 2016/0326801, published Nov. 10, 2016, entitled LOW-DEFLECTION ROLLER SHADE TUBE FOR LARGE OPENINGS, the entire disclosure of which is hereby incorporated by reference.

The flexible material 120 may include a first end (e.g., a top or upper end) that is coupled to the roller tube 110 and a second end (e.g., a bottom or lower end) that is coupled to a hembar 140. The hembar 140 may be configured, for example weighted, to cause the flexible material 120 to hang vertically. Rotation of the roller tube 110 may cause the hembar 140 to move toward or away from the roller tube 110 between the raised and lowered positions. A respective end cap 142 (FIG. 2) may be installed on each end of the hembar 140. The end caps 142 may be configured to cover the opposed ends of the hembar 140. For example, the end caps 142 may provide a finished end to the hembar 140.

The flexible material 120 may be any suitable material, or form any combination of materials. For example, the flexible material 120 may be “scrim,” woven cloth, non-woven material, light-control film, screen, and/or mesh. The motorized window treatment 100 may be any type of window treatment. For example, the motorized window treatment 100 may be a roller shade as illustrated, a soft sheer shade, a drapery, a cellular shade, a Roman shade, or a Venetian blind. As shown, the flexible material 120 may be a material suitable for use as a shade fabric, and may be alternatively referred to as a flexible material. The flexible material 120 is not limited to shade fabric. For example, in accordance with an alternative implementation of the motorized window treatment 100 as a retractable projection screen, the flexible material 120 may be a material suitable for displaying images projected onto the flexible material.

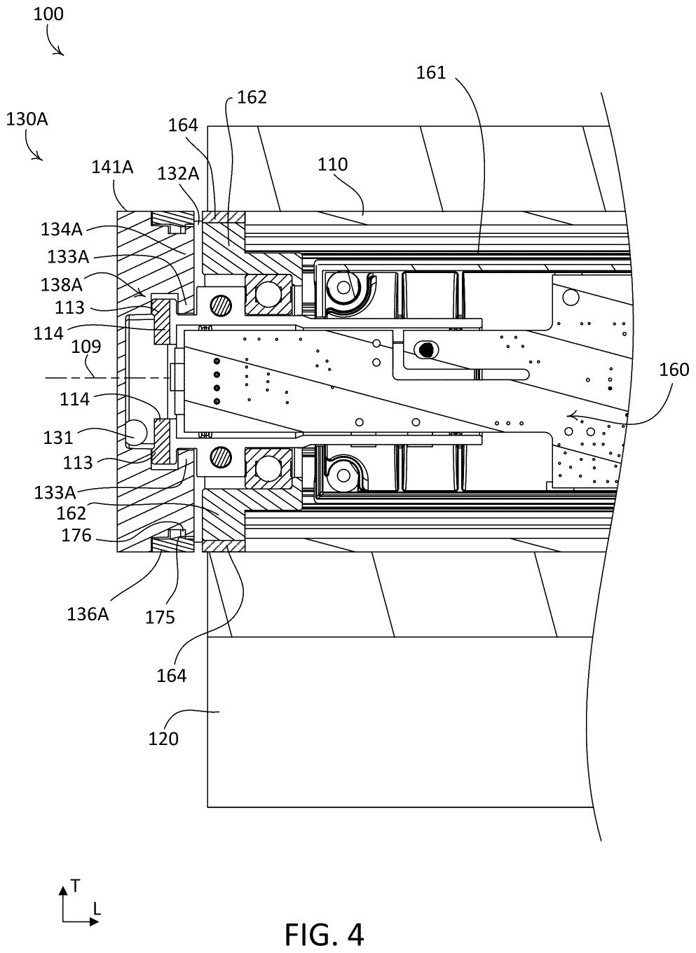

FIGS. 3A and 3B are enlarged perspective views of the first end 112 of the roller tube assembly 111 of the example motorized window treatment 100 showing the first mounting system 130A. FIG. 4 is an enlarged front cross-section view of the first end 112 of the roller tube assembly 111 of the example motorized window treatment 100. The motorized window treatment 100 may include a drive assembly 160 (e.g., a motor drive unit). The drive assembly 160 may at least partially be disposed within the roller tube 110. For example, the drive assembly 160 may include a control circuit that may include a microprocessor and may be mounted to a printed circuit board. The drive assembly 160 may be operably coupled to the roller tube 110 such that when the drive assembly is actuated, the roller tube 110 rotates. The drive assembly 160 may be configured to rotate the roller tube 110 of the example motorized window treatment 100 such that the flexible material 120 is operable between the raised position and the lowered position. The drive assembly 160 may be configured to rotate the roller tube 110 while reducing noise generated by the drive assembly (e.g., noise generated by one or more gear stages of the drive assembly). Examples of drive assemblies for motorized window treatments are described in greater detail in U.S. Pat. No. 6,497,267, issued Dec. 24, 2002, entitled MOTORIZED WINDOW SHADE WITH ULTRAQUIET MOTOR DRIVE AND ESD PROTECTION, and U.S. Pat. No. 9,598,901, issued Mar. 21, 2017, entitled QUIET MOTORIZED WINDOW TREATMENT SYSTEM, the entire disclosures of which are hereby incorporated by reference.

The drive assembly 160 may be powered by a power source (e.g., an alternating-current or direct-current power source) that provides power via electrical wiring 171, for example, of one of the mounting systems 130A, 130B (e.g., the first mounting system 130A as shown in FIG. 2). The electrical wiring 171 may be connected to wiring located within an electrical wallbox 170 mounted in the structure (e.g., the electrical wiring within the electrical wallbox 170 in turn being connected to a power source). In other words, the electrical wiring 171 may be electrically connected to an electric circuit within the electrical wallbox 170 (e.g., to be electrically connected to the power source). The electrical wallbox 170 may be located at the location of one of the mounting systems 130A, 130B (e.g., prior to installation of the mounting system). For example, the first mounting system 130A may be configured to conceal the electrical wallbox 170 (e.g., as with the motorized window treatment 100 shown in FIG. 2).

The mounting systems 130A, 130B may be configured to secure, without requiring a tool, the roller tube 110 in a first direction parallel to the longitudinal axis 109 (e.g., the longitudinal direction L), in a second direction that is parallel to the structure and perpendicular to the longitudinal axis (e.g., the transverse direction T), and in a third direction perpendicular to the structure and the longitudinal axis (e.g., the radial direction R). As shown in FIG. 2, each of the first and second mounting systems 130A, 130B may include a mounting bracket 141A, 141B (e.g., first and second mounting brackets 141A, 141B) that has a base 132A, 132B (e.g., a foot) and an attachment member 134A, 134B. The attachment member 134A, 134B may be connected to the base 132A, 132B of the respective mounting bracket 141A, 141B via a respective arm 135A, 135B of the respective mounting bracket 141A, 141B. The base 132A, 132B of each mounting bracket 141A, 141B may be configured to attach the mounting bracket 141A, 141B to a structure. The structure may include a window frame, a wall, a ceiling, or other structure, such that the motorized window treatment 100 is mounted proximate to an opening (e.g., over the opening or in the opening), such as a window for example. The arm 135A, 135B of each of the mounting brackets 141A, 141B may extend substantially perpendicular from the respective base 132A, 132B to the attachment member 134A, 134B, respectively. When the mounting brackets 141A, 141B are attached to a vertical structure, such as a wall (e.g., as shown in FIG. 1), the arm 135A, 135B of each of the first and second mounting brackets 141A, 141B may extend horizontally (e.g., in the radial direction R) from the base 132A, 132B to the attachment member 134A, 134B, respectively. When the mounting brackets 141A, 141B are attached to a horizontal structure, such as to the bottom of a ceiling, the arm 135A, 135B of each the first and second mounting brackets 141A, 141B may extend vertically (e.g., in the transverse direction T) from the base 132A, 132B to the attachment member 134A, 134B, respectively.

Each mounting system 130A, 130B of the motorized window treatment 100 may also include a respective sliding cover 136A, 136B configured to be located around the attachment members 134A, 134B of the respective mounting brackets 141A, 141B. The sliding covers 136A, 136B of each mounting system 130A, 130B may be operated into a closed position and an open position. For example, the sliding cover 136A attached to the first mounting bracket 141A is shown in the closed position and the open position in FIGS. 3A and 3B, respectively. The sliding covers 136A, 136B may each have a circular shape and may be received by the respective attachment member 134A, 134B. As shown in FIG. 4, the sliding cover 136A attached to the attachment member 134A of the first mounting bracket 141A may include a rib 175 extending from an inner surface of the sliding cover (e.g., towards the attachment member 134A). The rib 175 may stretch between the ends of the sliding cover 136A. The rib 175 may be received in a slot 176 in the attachment member 134A. The slot 176 may stretch around the circumference of the attachment member 134A. The rib 175 and the slot 176 may be configured to guide the sliding cover 136A as it operates between the open position and the closed position. For example, the rib 175 and the slot 176 may be configured to operably couple the sliding cover 136A to the attachment member 134A. The sliding cover 136B of the second mounting system 130B that is attached to the attachment member 134B of the second mounting bracket 141B may have a similar structure as the sliding cover 136A of the first mounting system 130A that is attached to the first mounting bracket 141A.

The attachment member 134A, 134B of each of the first and second mounting brackets 141A, 141B may define a respective channel 138A, 138B. As shown in FIG. 3B, the channel 138A of the first mounting bracket 141A may be configured to receive an end portion 114 of the roller tube assembly 111 (e.g., the end portion 114 may be part of the drive assembly 160) that is received in the roller tube 110 (e.g., the first end 112 of the roller tube assembly 111 of the motorized window treatment 100). For example, the end portion 114 of the roller tube assembly 111 may define the first end 112 of the roller tube assembly 111. The channel 138B of the second mounting bracket 141B may be configured to receive an end portion (not shown) of the idler 105 at an opposite end of the roller tube 110 (e.g., the second end 108 of the roller tube assembly 111 of the motorized window treatment 100). The end portion of the idler 105 may have a similar mechanical configuration to the end portion 114 for interfacing with and connecting to the second mounting bracket 141B. The channel 138A, 138B of the each of the first and second mounting brackets 141A, 141B may be configured for sliding receipt of the end portion 114 of the roller tube assembly 111 (e.g., the drive assembly 160) and the end portion of the idler 105, respectively. The sliding covers 136A, 136B may each rotate around the longitudinal axis 109 between the closed position and the open position. When the sliding covers 136A, 136B attached to the first and second mounting brackets 141A, 141B are each in the open position, the end portion 114 of the roller tube assembly 111 may be installed into the channel 138A of the attachment member 134A and the end portion of the idler 105 may be installed into the channel 138B of the attachment member 134B. When the end portion 114 of the roller tube assembly 111 is fully installed in the channel 138A, the sliding cover 136A may be rotated into the closed position in which the sliding cover 136A hides the end portion 114 and the channel 138A from view. When the end portion of the idler 105 is fully installed in the channel 138B, the sliding cover 136B may be rotated into the closed position in which the sliding cover 136B hides the end portion of the idler 105 and the channel 138B from view.

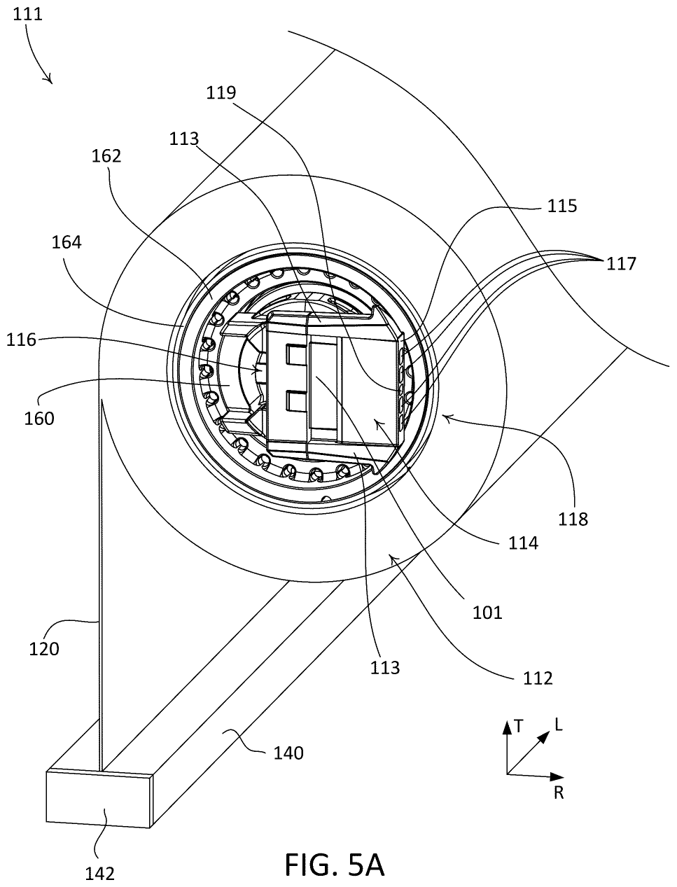

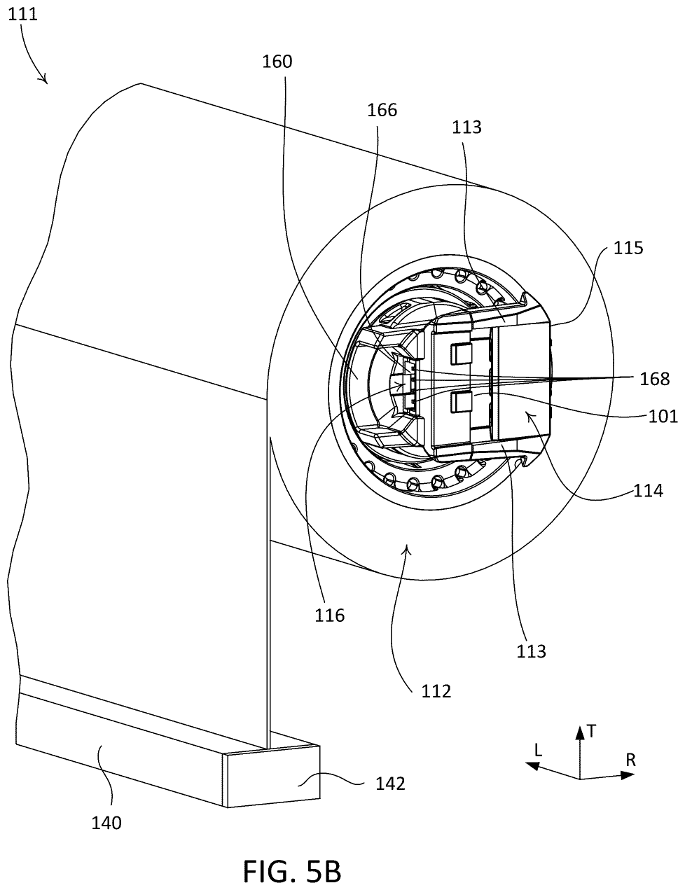

FIG. 5A is a perspective view of the first end 112 of the roller tube assembly 111 of the example motorized window treatment 100 detached from the first mounting bracket 141A showing the end portion 114 of the roller tube assembly 111. FIG. 5B depicts a partial exploded view of the first end 112 of the roller tube assembly 111 of the motorized window treatment 100. The end portion 114 of the roller tube assembly 111 may include a front surface 115 having a user interface 118 that may be accessible when the roller tube assembly 111 is received within the channel 138A of the first mounting bracket 141A and the sliding cover 136A is in the open position. For example, the user interface 118 may include one or more buttons and/or visual indicators arranged on the front surface 115 of the end portion 114, e.g., four buttons 117 and one visual indicator 119, as shown in FIG. 3B.

As shown in FIG. 4, the drive assembly 160 may include a body 161 that may be received in the roller tube 110 and a mandrel 162 that may be coupled to an end of the roller tube 110. The body 161 may be cylindrical. The drive assembly 160 may include a drive member (not shown) that may be located at the end of the drive assembly 160 opposite the mandrel 162. The drive member may be coupled to an interior surface of the roller tube 110 and may be driven (e.g., rotated) by a motor of the drive assembly for rotating the roller tube 110 and mandrel 162 with respect to the body 161 of the drive assembly 160 and with respect to the first mounting bracket 141A. The mandrel 162 may be surrounded by a ring portion 164. For example, the ring portion 164 may have a thickness that is sized such that an outer surface of the ring portion 164 is substantially flush with an outer surface of the roller tube 110. The flexible material 120 may be wrapped around both the roller tube 110 and the ring portion 164 as shown in FIG. 4.

As shown in FIG. 4, the end portion 114 of the roller tube assembly 111 may extend from the body 161 and may be received within the channel 138A defined by the attachment member 134A of the first mounting bracket 141A. The drive assembly 160 may be configured to rotate the roller tube 110 about the longitudinal axis 109 when the end portion 114 of the roller tube assembly 111 is received within the channel 138A of the first mounting bracket 141A. The end portion 114 of the roller tube assembly 111 may include rails 113 (e.g., two rails) at opposing sides of the end portion. The rails 113 may define an extension of the end portion 114 having a wider cross section. The channel 138A of the first mounting bracket 141A may have a T-shaped cross section. For example, the channel 138A of the first mounting bracket 141A may be configured to receive the rails 113 (e.g., the wider cross section portion) of the end portion 114 of the roller tube assembly 111. The channel 138A of the first mounting bracket 141A may define one or more flanges 133A (e.g., two flanges) to secure the end portion 114 within the channel 138A. The flanges 133A may secure the rails 113 within the channel 138A. For example, the flanges 133A may engage the rails 113 of the end portion 114 of the roller tube assembly 111 such that movement of the roller tube 110 in the longitudinal direction L and transverse direction T, for example, is limited/prevented.

The end portion of the idler 105 may have a similar shape and configuration (e.g., rails, such as two rails, similar to rails 113) as the end portion 114 of the roller tube assembly 111 and the channel 138B of the second mounting bracket 141B may have a similar construction as the channel 138A of the first mounting bracket 141A for receiving the rails of the end portion of the idler 105. For example, the channel 138B of the second mounting bracket 141B may have respective flanges 139B (e.g., as shown in FIG. 2) and may have a T-shaped cross section (e.g., similar to that of the channel 138A of the first mounting bracket 141A). The channels 138A, 138B of the first and second mounting brackets 141A, 141B may be configured to secure the roller tube 110 and the roller tube assembly 111 in position in the longitudinal direction L (e.g., along the longitudinal axis 109). For example, the channels 138A, 138B of the first and second mounting brackets 141A, 141B may be configured to lock the roller tube 110 and the roller tube assembly 111 in position along the longitudinal axis 109 such that translational movement of the roller tube 110 and the roller tube assembly 111 in the longitudinal direction L is prevented. The channels 138A, 138B may also be configured to lock the roller tube 110 and the roller tube assembly 111 in position along the transverse direction T. When the end portion 114 of the roller tube assembly 111 is fully received in the channel 138A of the first mounting bracket 141A and the end portion of the idler 105 is fully received in the channel 138B of the second mounting bracket 1414B, the centers of the respective attachment members 134A, 134B may be aligned with the center of the roller tube 110 along the longitudinal axis 109.

The first and second mounting systems 130A, 130B may each include a spring 150, which may be secured in the respective channel 138A, 138B of the respective mounting bracket 141A, 141B. For example, as shown in FIG. 2, the second mounting system 130B may comprise a spring 150 in the channel 138B of the mounting bracket 141B. The spring of the first mounting system 130A may be similar to spring 150 and be configured to secure the end portion 114 of the roller tube assembly 111 within the channel 138A of the mounting bracket 141A. The spring 150 of the second mounting system 130B may be configured to secure the end portion of the idler 105 within the channel 138B of the mounting bracket 141B.

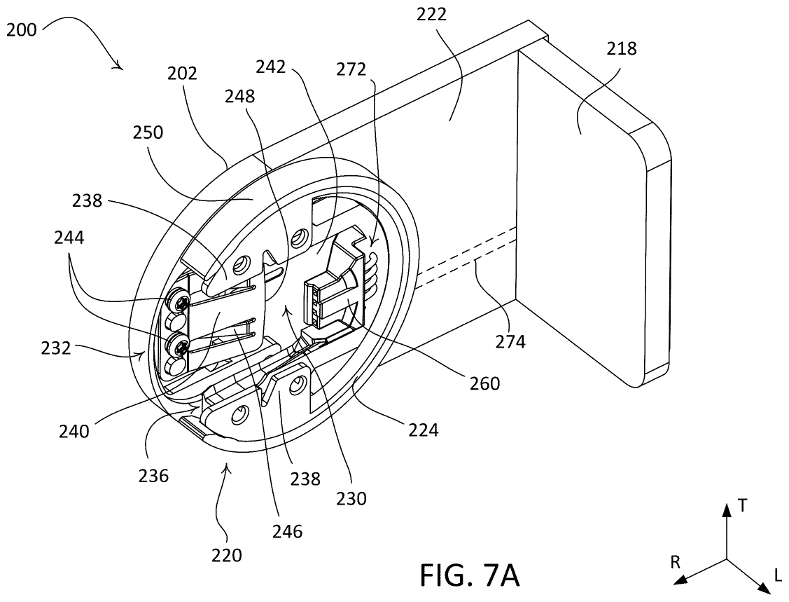

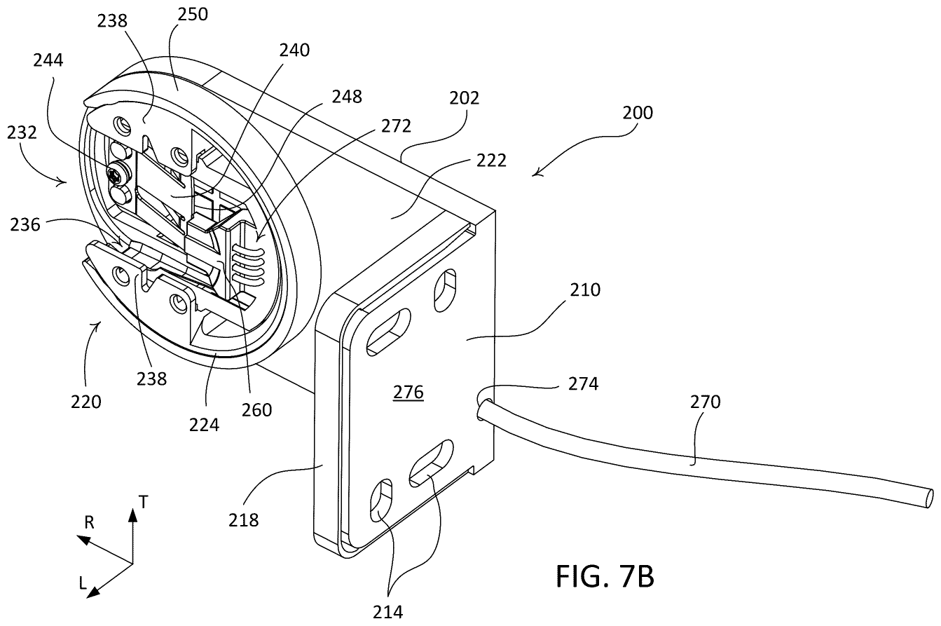

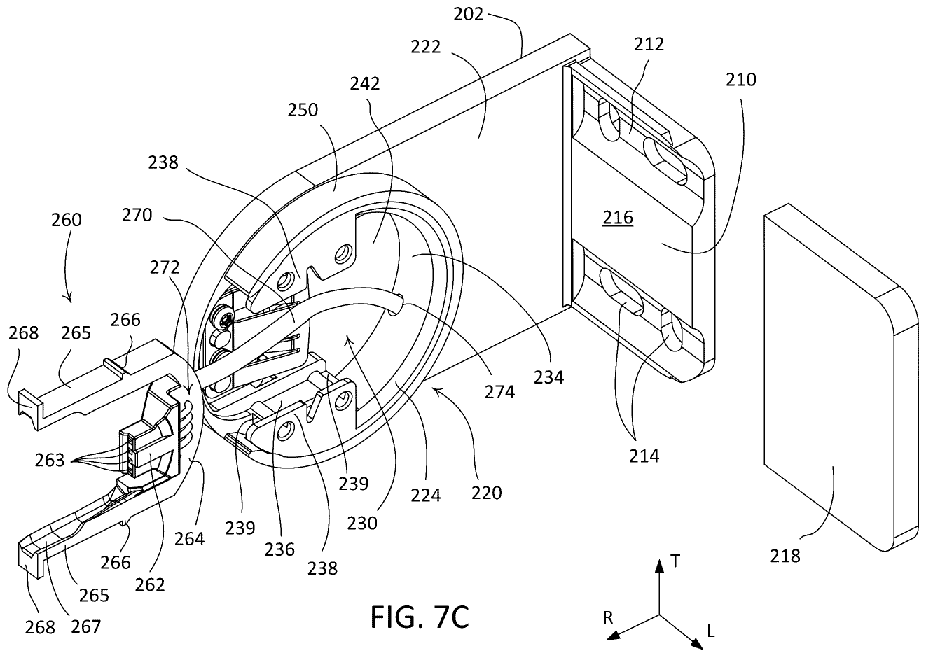

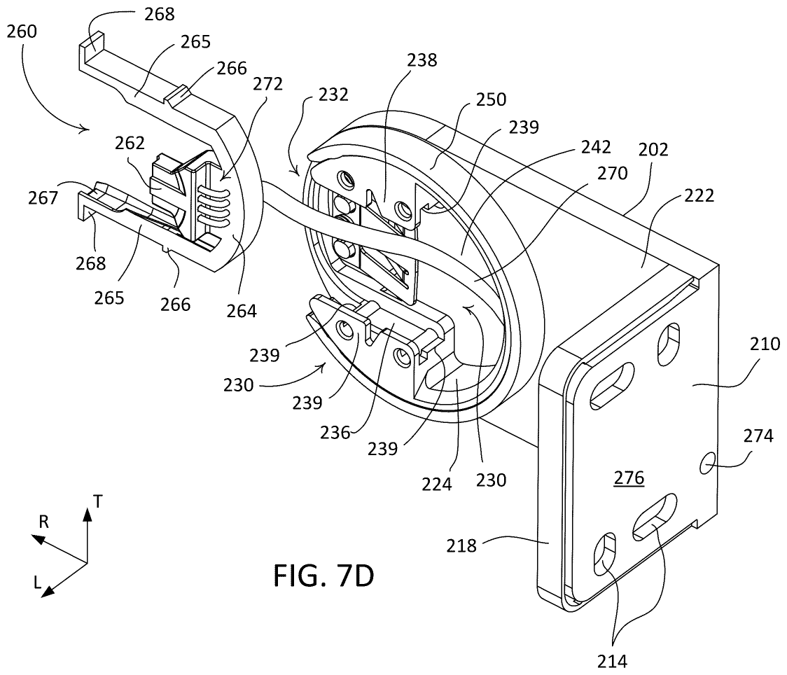

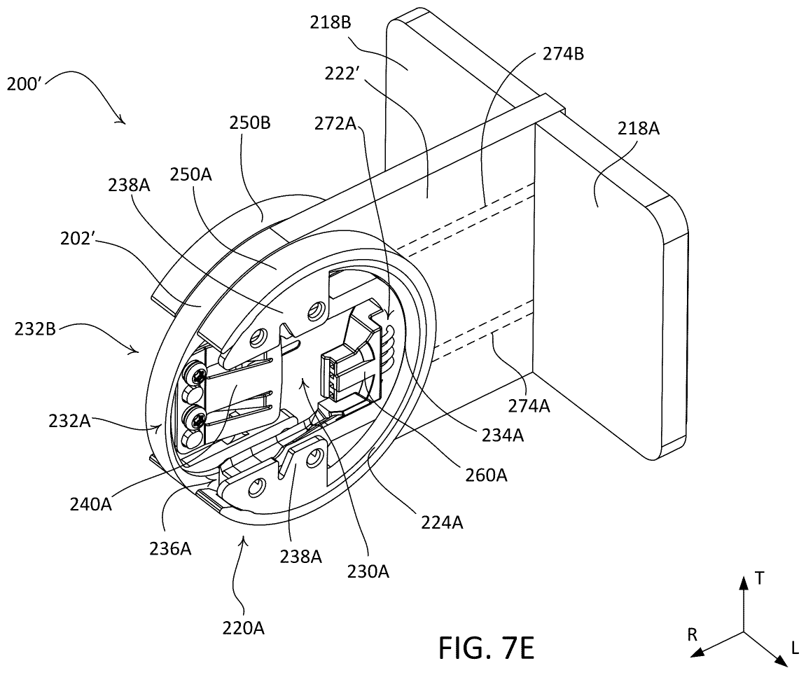

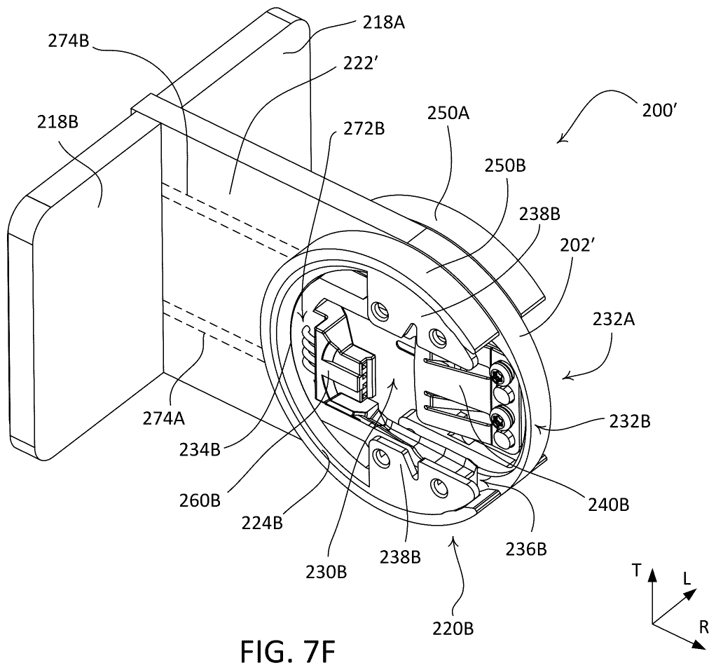

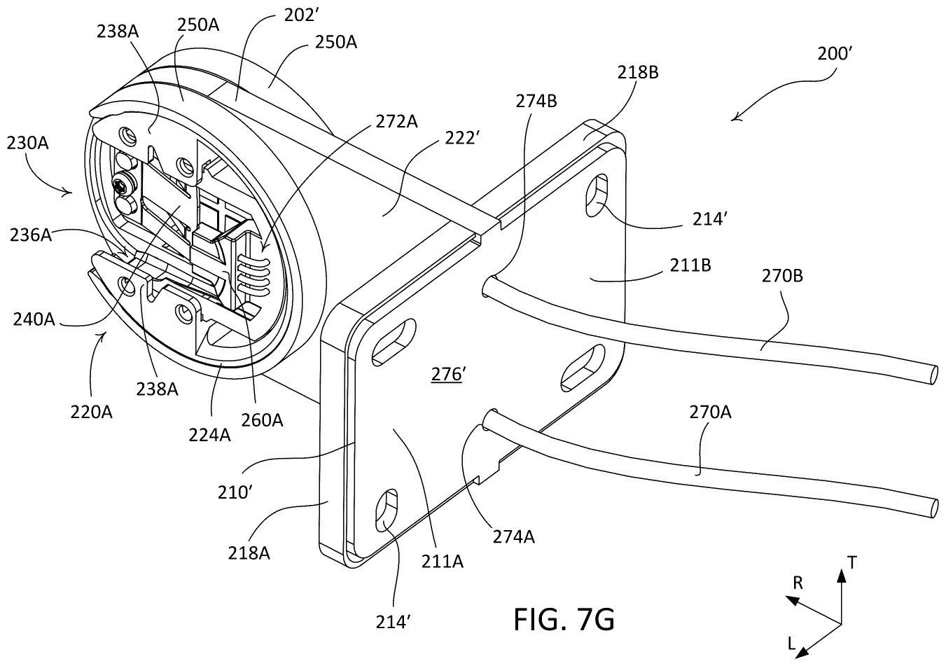

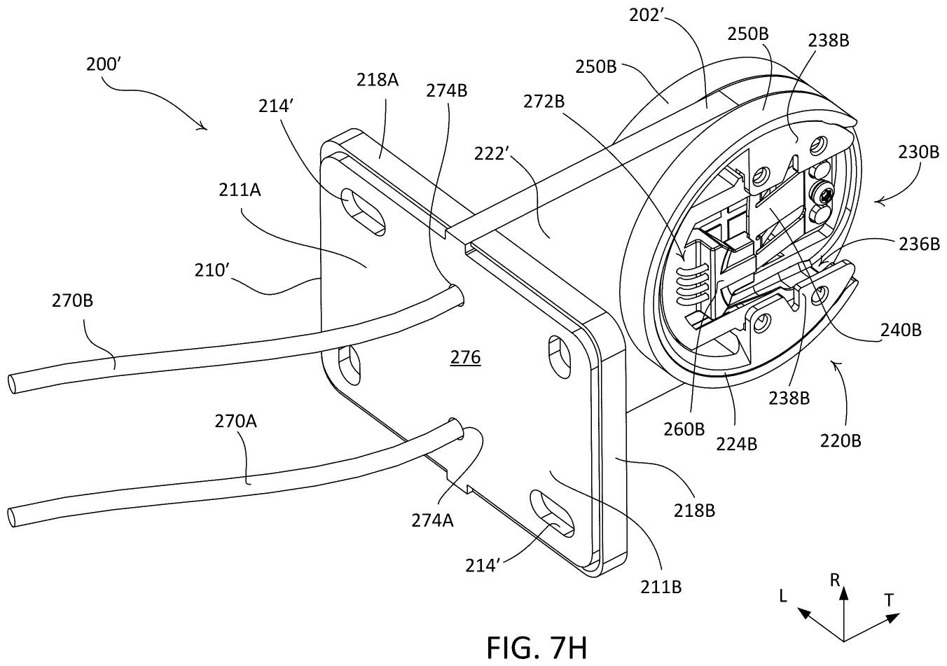

The first and second mounting systems 130A, 130B of the motorized window treatment 100 may have similar geometries (e.g., may be identical). However, in some examples described herein the first mounting system 130A (e.g., only one of the two mounting systems) may comprise one or more connectors (e.g., such as the connector 260, 260A, 360, 360′, 460, 460′, 560, 560′, 660, 760, 860, 960, 960′, 1160, and/or 1160′ as shown in FIGS. 7A-15M and further discussed herein) configured to be electrically coupled to electrical wiring, such as electrical wiring 171, and received in the drive assembly 160 within the roller tube 110 for powering the drive assembly 160. The connector of the first mounting system 130A may be configured to engage a corresponding socket 166 within an opening 116 in the end portion 114 of the roller tube assembly 111. The socket 166 may comprise pins 168 that may be electrically coupled to electrical circuitry of the drive assembly 160 within the roller tube 110. As shown in FIG. 4, the first mounting bracket 141A may define a bore 131 that extends through the arm 135A and/or the base 132A and may be configured to receive electrical wiring (e.g., the electrical wiring 171 shown in FIG. 2) that is coupled to the connector (e.g., connector 260, 360′, etc.) for powering the motorized window treatment 100. The connector of the first mounting bracket system 130A, for example, may be inserted into the socket 166 in the opening 116 of the drive assembly 160 during installation of the end portion 114 of the roller tube assembly 111 into the channel 138A of the first mounting bracket 141A. For example, the connector of the first mounting bracket system 130A may be inserted into the socket 166 in the opening 116 of the drive assembly 160 during insertion of the end portion 114 of the roller tube assembly 111 and insertion of the end portion of the idler 105 as the end portions are slid into the respective channels 138A 138B of the first and second mounting brackets 141A, 141B (e.g., in the radial direction R when the mounting brackets are wall-mounted as shown in FIG. 5A or in the transverse direction T when the mounting brackets are ceiling-mounted). Although the electrical wiring 171 is shown in FIG. 2 as received via the first mounting bracket 141A, it should be appreciated that the second mounting bracket 141B may alternatively receive the electrical wiring if the drive assembly 160 is installed at the opposite end of the roller tube 110. It should also be appreciated that while socket 166 is shown with pins 168 for insertion into a connector, the connector may include pins that are inserted into openings in the socket 166.

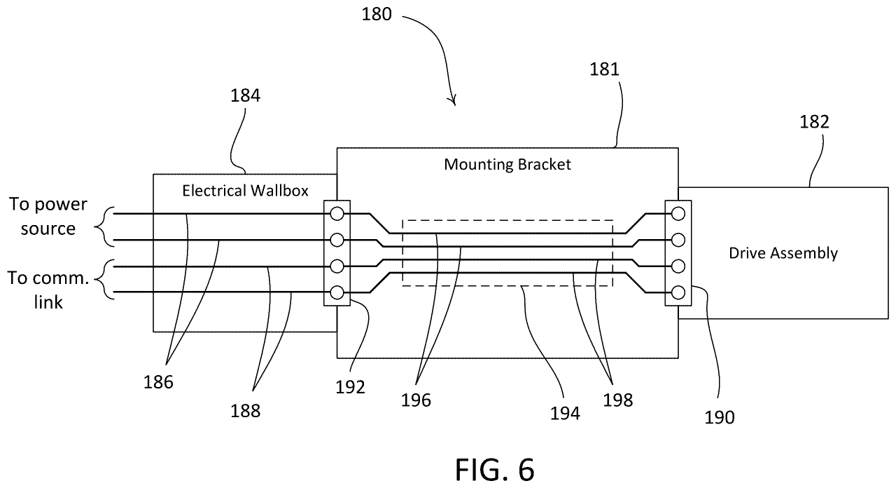

FIG. 6 is a block diagram of an example mounting system 180 (e.g., such as the mounting systems 130A, 130B, 200, 200′, 300, 300′, 400, 400′, 500, 500′, 600, 700, 800, 900, 900′, 1000, 1100, 1100′, 1200 shown in FIGS. 1-4 and 7A-15V) for mounting a motorized window treatment (e.g., such as the motorized window treatment 100 shown in FIGS. 1-5B). For example, the mounting system 180 may comprise a mounting bracket 181, such as the first mounting bracket 141A of the motorized window treatment. The mounting system 180 (e.g., the mounting bracket) may be configured to support a drive assembly 182 (e.g., the drive assembly 160) of the motorized window treatment. The mounting system 180 (e.g., the mounting bracket 181) may be configured to receive electrical wiring via an electrical wallbox 184. For example, the electrical wallbox 184 may receive two electrical conductors 186 (e.g., wires) that may be electrically coupled to a power source, e.g., such as an alternating-current (AC) power source and/or a direct-current (DC) power source. In addition, the electrical wallbox 184 may receive one or more electrical conductors 188 (e.g., wires) that may be electrically coupled to a communication link (e.g., a wired communication link and/or a wireless communication module that may be coupled to a wireless communication link).

The mounting system 180 may be configured to electrically couple the power source (e.g., the electrical conductors 186) and/or the communication link (e.g., the electrical conductors 188) to the drive assembly 182 of the motorized window treatment. For example, the mounting system 180 may comprise a first connector 190 configured to be electrically coupled to the drive assembly 182 and a second connector 192 configured to be electrically coupled to the electrical conductors 186, 188 in the electrical wallbox 184. The mounting system 180 may comprise electrical conductors that may extend through a bore 194 of the mounting bracket 180 (e.g., such as the bore 131) and/or a trench (as further described herein) for electrically coupling the first connector 190 to the second connector 192. For example, the mounting system 180 may comprise two electrical conductors 196 electrically coupled to the electrical conductors 186 in the electrical wallbox 184 via the second connector 192, e.g., for electrically coupling the drive assembly 182 to the power source. In addition, the mounting system 180 may comprise two electrical conductors 198 electrically coupled to the electrical conductors 188 in the electrical wallbox 184 via the second connector 192, e.g., for electrically coupling the drive assembly 182 to the communication link.

FIG. 7A-7D depict an example mounting system 200 for mounting a roller tube assembly (e.g., roller tube assembly 111 of motorized window treatment 100 shown in FIGS. 1-5B). FIG. 7A is a front perspective view and FIG. 7B is a rear perspective view of the mounting system 200. FIG. 7C is a front exploded view and FIG. 7D is a rear exploded view of the mounting system 200. For example, the mounting system 200 may comprise a mounting bracket 202, which may be deployed as the first mounting bracket 141A of the motorized window treatment 100. The mounting bracket 202 may be configured (e.g., with another mounting bracket such as the mounting bracket 141B shown in FIG. 2) to mount the roller tube assembly of the motorized window treatment to a structure. The mounting bracket 202 may include a base 210 (e.g., a foot) and an attachment member 220 that may be connected to the base 210 via an arm 222. The base 210 may be configured to attach the mounting bracket 202 to a structure (e.g., a window frame, a wall, a ceiling, or other structure as with the motorized window treatment 100 shown in FIG. 1). The arm 222 may extend substantially perpendicular from the base 210 to the attachment member 220. When the mounting bracket 202 is attached to a vertical structure (e.g., such as a wall), the arm 222 may extend horizontally (e.g., in the radial direction R) from the base 210 to the attachment member 220. When the mounting bracket 202 is attached to a horizontal structure (e.g., such as a ceiling), the arm 222 may extend vertically (e.g., in the transverse direction T) from the base 210 to the attachment member 220.

As shown in FIG. 7C, the base 210 may define depressions 212 that may have a reduced thickness when compared to a remainder of the base 210. The base 210 may include holes 214 therethrough. Each of the holes 214 may be configured to receive a fastener (not shown) for securing the mounting bracket 202 to the structure. The holes 214 may be located within the depressions 212, such that the fasteners may be countersunk with respect to a front surface 216 of the base 210. Each of the holes 214 may be oblong shaped. For example, the holes 214 may be oblong shaped to allow for alignment of the mounting bracket 202 and/or alignment of the fasteners. The mounting system 200 may comprise a base cover 218 that may be configured to be detachably mounted over the base 210 of the mounting bracket 202, e.g., for covering and/or concealing the base 210 and fasteners.

The attachment member 220 may include a drum 224 (e.g., a cylindrical drum). The drum 224 may extend in the longitudinal direction L. The drum 224 may be configured to receive an end portion of a roller tube assembly of a motorized window treatment (e.g., the end portion 114 of the roller tube assembly 111 of the motorized window treatment 100). For example, the drum 224 may define a channel 230 that may be configured receive (e.g., for sliding receipt of) the end portion of the roller tube assembly of the motorized window treatment (e.g., similar to the channel 138A of the first mounting bracket 141A). The channel 230 may define an opening 232 in the attachment member 220. The channel 230 may extend from the opening 232 to a rear wall 234. The channel 230 may define slots 236 (such as two slots) on either side of the channel 230. The slots 236 may be configured such that the channel 230 is T-shaped (e.g., has a T-shaped cross section). The slots 236 may be defined by respective flanges 238 (such as two flanges) of the drum 224 of the attachment member 220. The slots 236 may also be defined by a side wall 242 of the channel 230. The flanges 238 may be configured to retain the end portion of the roller tube assembly within the channel 230. The flanges 238 may be configured to secure the roller tube in the transverse direction T and/or longitudinal direction L.

The attachment member 220 of the mounting bracket 202 may also comprise a spring 240, which may be secured to the attachment member 220, for example, in the channel 230. For example, the spring 240 may be secured to a side wall 242 of the channel 230. As shown in FIG. 7A, the spring 240 may be positioned at the opening 232 of the channel 230 and secured in the channel 230 using one or more fasteners 244. The spring 240 may include compliant fingers 246 that are configured to engage the side wall 242 of the channel 230 and bias a rear edge 248 of the spring 240 away from the side wall 242. For example, the rear edge 248 may be spaced away from the side wall 242. The compliant fingers 246 may be configured to flex as the end portion of the roller tube assembly is inserted into the channel 230. For example, the end portion of the roller tube assembly may apply a force on the spring 240 that pushes the rear edge 248 closer to the side wall 242. The spring 240 may be configured to engage the end portion of the roller tube assembly to secure the end portion within the channel 230. When the end portion is fully inserted into the channel 230, the compliant fingers 246 may enable the rear edge 248 to exert a force on the end portion of the roller tube assembly such that the end portion is retained within the channel 230 (e.g., the rear edge 248 of the spring may engage ridge 101 (see FIG. 5A) of the end portion 114). The rear edge 248 may exert the force on the end portion of the roller tube assembly in the radial direction R when the mounting bracket 202 is wall-mounted thereby preventing removal of the end portion from the channel 230 in the radial direction R.

The mounting system 200 may include a sliding cover 250 that may be operated into a closed position and an open position (e.g., as with the sliding cover 136A of the motorized window treatment 100). For example, the sliding cover 250 is shown in the open position in FIG. 7A. The sliding cover 250 may be received by the drum 224 of the attachment member 220 of the mounting bracket 202 and may surround or partially surround the drum 224. The sliding cover 250 may have a circular shape and may rotate around the attachment member 220/drum 224 between the open position and the closed position. When the sliding cover 250 is in the open position, the end portion of the roller tube assembly may be installed into the channel 230 of the attachment member 220. When the end portion of the roller tube assembly is fully installed in the channel 230, the sliding cover 250 may be rotated into the closed position in which the sliding cover 250 hides the end portion and the channel 230 from view. When the sliding cover 250 is in the closed position, the channel 230 and the end portion of the roller tube assembly are not accessible. When the sliding cover 250 is in the open position, the channel 230 and the end portion of the roller tube assembly may be exposed and/or accessible.

The mounting system 200 may comprise a connector 260 configured to provide electrical connection to the drive assembly of the motorized window treatment. The connector 260 may be provided at the end of a cable 270 and may be received in the channel 230 of the attachment member 220 of the mounting bracket 202. For example, the connector 260 may be disposed and fixed within the channel 230. The connector 260 may be removably attached to the mounting bracket 202. The cable 270 may have one or more electrical conductors, such as wires 272. The cable 270 may extend through a bore 274 in the arm 222 of the mounting bracket 202 that begins in the channel 230 and may exit the mounting bracket 202 at a rear surface 276 of the mounting bracket 202 to be received in an electrical wallbox (e.g., such as the electrical wallbox 170) mounted to the structure behind the base 210, for example.

The connector 260 may comprise a plug portion 262 configured to be received in an opening of the drive assembly (e.g., the opening 116 of the drive assembly 160 shown in FIGS. 5A and 5B). The plug portion 262 of the connector 260 may be configured to be electrically connected to a connector located on the end portion of the roller tube assembly (e.g., such as end portion 114 shown in FIGS. 5A and 5B). The connector 260 (e.g., the plug portion 262) may be configured to engage with a socket of the drive assembly (e.g., the socket 166 of the drive assembly 160 shown in FIG. 5B). The plug portion 262 of the connector 260 may comprise one or more openings 263 for housing electrical conductors that may be electrically coupled to pins (e.g., the pins 168) of the socket. For example, the opening(s) 263 may be configured to receive the pins of the socket of the drive assembly when the end portion is received within the channel 230. The connector 260 may be configured to electrically connect the motorized window treatment (e.g., the drive assembly) to electrical wiring (e.g., the cable 270) for powering the drive assembly. As another example, the plug portion 262 may alternatively comprise pins and the socket of the drive assembly may comprise openings for housing electrical conductors. Other variations are also possible. The plug portion 262 may be chamfered at one end to allow easier insertion of the plug portion 262 into a socket, for example (e.g., the socket 166 of the drive assembly 160).

The connector 260 may comprise a base portion 264 configured to rest against the rear wall 234 of the channel 230, such that the plug portion 262 may extend towards the opening 232 of the channel 230 (e.g., as shown in FIG. 7A). For example, the base portion 264 may abut the rear wall 234 of the channel 230 when the connector 260 is disposed within the channel 230. The base portion 264 may define a curved edge that corresponds with a shape of the rear wall 234 of the channel 230. The connector 260 may comprise a pair of opposing arms 265 that extend from the base portion 264. The arms 265 may extend within the channel 230 in the radial direction, R (e.g., from the base portion 264). The arms 265 may be configured to be received in respective slots 236 of the channel 230 when the connector 260 is received in the channel 230 thereby aiding to affix the connector 260 in the channel 230. Each of the arms 265 may comprise a ridge 266 and a tab 268 configured to abut edges 239 of the respective slots 236 of the channel 230 when the connector 260 is received in the channel 230. The ridge 266 and the tab 268 may extend in the transverse direction. The tab 268 may be located at a distal end of the arms 265. The ridge 266 may be located at an intermediate (e.g., between the distal end and the base portion 264) location of the arms 265. Each of the arms 265 may define a groove 267 on the opposite side as the ridge 266 and tab 268. Each groove 267 may be configured to receive a respective rail of the end portion of the roller tube assembly (e.g., such as the rails 113 of the end portion 114 of the roller tube assembly 111 shown in FIGS. 4, 5A, and 5B). According to one example, connector 260 (e.g. at least each of the arms 265) may be made of a material, such as plastic or rubber, that may act to mechanically isolate/cushion the drive assembly from the mounting bracket 202 thereby helping to reduce noise as the motorized window treatment operates.

It should be appreciated that the base 210 may be substantially the width of the arm 222 such that the base 210 does not extend beyond the arm 222. According to another example, a mounting system may be configured similar to mounting system 200 but not include a base.

FIG. 7E-7H depict an example mounting system 200′ for mounting one or more roller tube assemblies (e.g., multiple roller tube assemblies 111 of motorized window treatment 100 shown in FIGS. 1-5B). FIG. 7E is a right-side front perspective view and FIG. 7F is a left-side front perspective view of the mounting system 200′. FIG. 7G is a right-side rear perspective view and FIG. 7H is a left-side rear perspective view of the mounting system 200′. For example, the mounting system 200′ may comprise a center mounting bracket 202′, which may be located between two roller tube assemblies of respective adjacent motorized window treatments (e.g., which each may be similar to the roller tube assembly 111 of the motorized window treatment 100).

The mounting bracket 202′ may include a base 210′ (e.g., a foot), which may comprise a first portion 211A (e.g., on the right side of the mounting bracket 202′) and a second portion 211B adjacent the first portion (e.g., on the left side of the mounting bracket 202′). The mounting bracket 202′ may also comprise a first attachment member 220A (e.g., on the right side of the mounting bracket 202′) and a second attachment member 220B opposite the first attachment member (e.g., on the left side of the mounting bracket 202′). The first and second attachment members 220A, 220B may be connected to the base 210′ via an arm 222′. The second portion 211B of the base 210′ may be located on an opposite side of the arm 222′ as the first portion 211A of the base 210′, and may be a mirror copy of the first portion 211A of the base 210′. The second attachment member 220B may be located on an opposite side of the arm 222′ as the first attachment member 220A, and may be a mirror copy of the first attachment member 220A. The base 210′ may be configured to attach the mounting bracket 202′ to a structure (e.g., a window frame, a wall, a ceiling, or other structure as with the motorized window treatment 100 shown in FIG. 1). The arm 222′ may extend substantially perpendicular from the base 210′ to the first and second attachment members 220A, 220B. When the mounting bracket 202′ is attached to a vertical structure (e.g., such as a wall), the arm 222′ may extend horizontally (e.g., in the radial direction R) from the base 210′ to the first and second attachment members 220A, 220B. When the mounting bracket 202′ is attached to a horizontal structure (e.g., such as a ceiling), the arm 222′ may extend vertically (e.g., in the transverse direction T) from the base 210′ to the first and second attachment members 220A, 220B.

The base 210′ may define depressions (e.g., such as the depressions 212) that may have a reduced thickness when compared to a remainder of the base 210′ as similarly described for base 210. The base 210′ may include holes 214′ therethrough. Each of the holes 214′ may be configured to receive a fastener (not shown) for securing the mounting bracket 202′ to the structure. The holes 214′ may be located within the depressions, such that the fasteners may be countersunk with respect to a front surface (e.g., such as the front surface 216) of the base 210. Each of the holes 214′ may be oblong shaped. For example, the holes 214′ may be oblong shaped to allow for alignment of the mounting bracket 202′ and/or alignment of the fasteners. The mounting system 200′ may comprise a first base cover 218A that may be configured to be detachably mounted over the first portion 211A of the base 210′ and a second base cover 218B that may be configured to be detachably mounted over the second portion 211B of the base 210′, e.g., for covering and/or concealing the base 210′ and fasteners.

The first and second attachment members 220A, 220B of the mounting bracket 202′ may include respective drums 224A, 224B (e.g., cylindrical drums). The drums 224A, 224B may extend in the longitudinal direction L. The drums 224A, 224B may each be configured to receive an end portion of a roller tube assembly of a respective motorized window treatment (e.g., such as the end portion 114 of the roller tube assembly 111 of the motorized window treatment 100 or an end portion of the idler 105). For example, the drums 224A, 224B may define respective channels 230A, 230B that each may be configured receive (e.g., for sliding receipt of) the end portion of the roller tube assembly of the respective motorized window treatment (e.g., similar to the channel 138A of the first mounting bracket 141A). The channels 230A, 230B may each define a respective opening 232A, 232B. The channels 230A, 230B may each extend from the opening 232A, 232B to a rear wall 234A, 234B of the drum 224A, 224B of the attachment member 220A, 220B respectively (e.g., similar to rear wall 234). The channel 230A of the first attachment member 220A may define slots 236A (similar to slots 236) located on either side of the channel 230A. The channel 230B of the second attachment member 220B may define slots 236B (similar to slots 236) on either side of the channel 230B. The slots 236A, 236B may be configured such that the channels 230A, 230B are each T-shaped (e.g., having a T-shaped cross section). The slots 236A of the channel 230A of the first attachment member 220A may be defined by respective flanges 238A of the respective drum 224A. The slots 236A may also be defined by a side wall 242A of the channel 230A. The slots 236B of the channel 230B of the second attachment member 220B may be defined by respective flanges 238B of the respective drum 224B. The slots 236B may also be defined by a side wall 242B of the channel 230B. The flanges 238A, 238B may be configured to retain the end portion of respective roller tube assemblies within the respective channel 230A, 230B, and may be configured to secure the roller tube assemblies in the transverse direction T and/or longitudinal direction L.

The first and second attachment members 220A, 220B of the mounting bracket 202′ may also comprise respective springs 240A, 240B, which may be secured to the attachment member 220A, 220B, for example, in the respective channels 230A, 230B. The springs 240A, 240B may each have a similar structure to the spring 240 of the mounting bracket 202, and may operate in a similar manner as the spring 240 of the mounting bracket 202 to retain the end portion of the respective roller tube assembly within the respective channel 230A, 230B (e.g., a rear edge of the springs 240A, 240B may engage ridge 101 (see FIG. 5A) of a respective end portion 114).

The mounting system 200′ may include a first sliding cover 250A that may be rotatably mounted around the drum 224A of the first attachment member 220A and a second sliding cover 250B that may be rotatably mounted around the drum 224B of the second attachment member 220B. The first and second sliding covers 250A, 250B may each have a similar structure to the sliding cover 250 of the mounting system 200, and may function in a similar manner as the sliding cover 250 of the mounting system 200 to be operated into an open position in which the end portion of the respective roller tube assembly may be installed into the respective channel 230A, 230B and into a closed position in which the end portion of the respective roller tube assembly is not accessible and hidden from view.

The mounting system 200′ may comprise a first connector 260A that may be removably attached to the mounting bracket 202′ within the channel 230A of the first attachment member 220A, and a second connector 260B that may be removably attached to the mounting bracket 202′ within the channel 230B of the second attachment member 220B. The first and second connectors 260A, 260B may each have a similar structure to the connector 260 of the mounting system 200 (e.g., comprise a base portion, a plug portion, a pair of arms, etc.), and may operate in a similar manner as the connector 260 of the mounting system 200 to receive and connect to the end portion of a respective roller tube assembly to provide electrical connection to the drive assembly of the respective roller tube assembly mounted to the first and second attachment members 220A, 220B, respectfully. The first connector 260A may be provided at the end of a first cable 270A, which may include one or more electrical conductors, such as wires 272A. The second connector 260B may be provided at the end of a second cable 270B, which may include one or more electrical conductors, such as wires 272B. The first cable 270A may extend through a first bore 274A in the arm 222′ that extends from the channel 230A to the rear surface 276′ of the base 210′, and the second cable 270B may extend through a second bore 274B in the arm 222′ that extends from the channel 230B to the rear surface 276′ of the base 210′. The first and second cables 270A, 270B may exit the first and second bores 274A, 274B, respectively, at a rear surface 276′ of the mounting bracket 202′ to be received in an electrical wallbox (e.g., such as the electrical wallbox 170) mounted to the structure behind the base 210′, for example. The cables 270A, 270B may extend through the respective bores 274A, 274B from the respective channels 230A, 230B to the rear surface 276′ of the mounting bracket 202′. In some examples, the arm 222′ of the mounting bracket 202′ may comprise a single bore through which both of the cables 270A, 270B may extend between the respective channel 230A, 230B and the rear surface 276′ of the mounting bracket 202′. According to another example, either of the connectors 260A, 260B and/or the respective wires 272A, 272B may be omitted if the respective roller tube assembly connected to the bracket on the respective left or right side does not include a drive assembly at that end of the roller tube assembly (e.g., respective roller tube assembly connected to the bracket includes an idler, such as an idler 105). The slots 236A, 236B may be configured to receive a respective rail of the end portion (e.g., respective rails of an idler) of the roller tube assembly when inserted therein if a connector 260A, 260B is omitted from the mounting system 200′.

It should be appreciated that the base 210′ may be substantially the width of the arm 222′ such that the base 210′ does not extend beyond the arm 222′. According to another example, a mounting system may be configured similar to mounting system 200′ but not include a base.

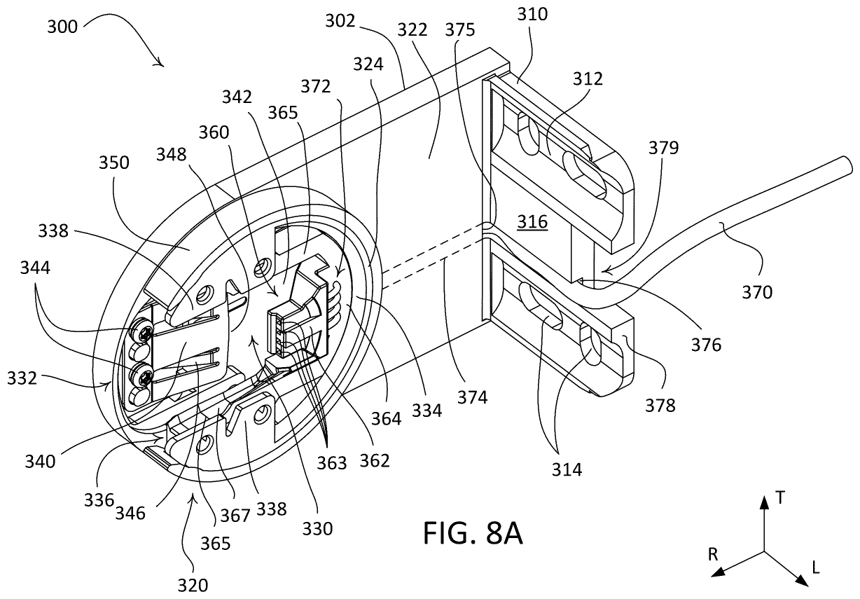

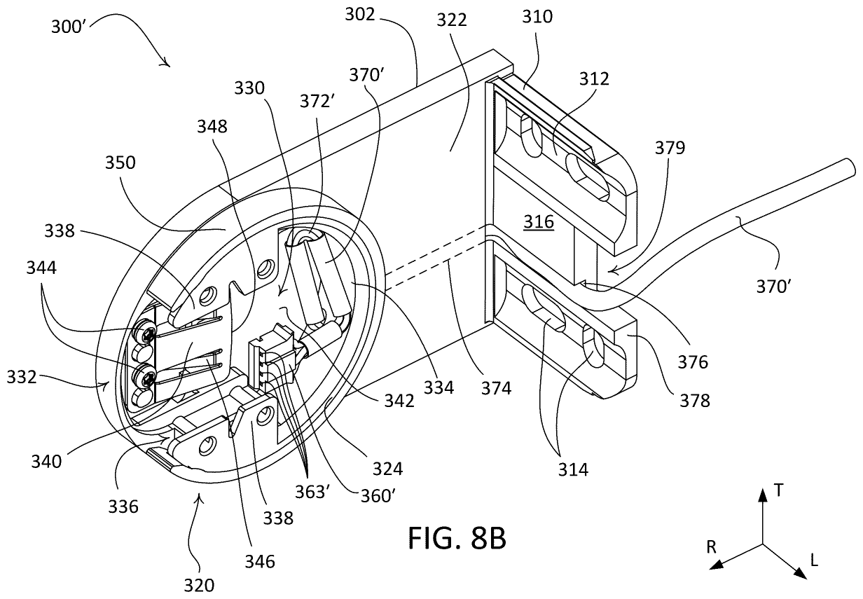

FIG. 8A is a front perspective view of another example mounting system 300 for mounting a roller tube assembly (e.g., roller tube assembly 111 of motorized window treatment 100 shown in FIGS. 1-5B). For example, the mounting system 300 may comprise a mounting bracket 302, which may be deployed as the first mounting bracket 141A of the motorized window treatment 100. The mounting bracket 302 may include a base 310 (e.g., a foot) and an attachment member 320 that may be connected to the base 310 via an arm 322. The base 310 may be configured to attach the mounting bracket 302 to a structure (e.g., a window frame, a wall, a ceiling, or other structure as with the motorized window treatment 100 shown in FIG. 1). The arm 322 may extend substantially perpendicular from the base 310 to the attachment member 320. When the mounting bracket 302 is attached to a vertical structure (e.g., such as a wall), the arm 322 may extend horizontally (e.g., in the radial direction R) from the base 310 to the attachment member 320. When the mounting bracket 302 is attached to a horizontal structure (e.g., such as a ceiling), the arm 322 may extend vertically (e.g., in the transverse direction T) from the base 310 to the attachment member 320.

The base 310 may define depressions 312 that may have a reduced thickness when compared to a remainder of the base 310. The base 310 may include holes 314 therethrough. Each of the holes 314 may be configured to receive a fastener (not shown) for securing the mounting bracket 302 to the structure. The holes 314 may be located within the depressions 312, such that the fasteners may be countersunk with respect to a front surface 316 of the base 310. Each of the holes 314 may be oblong shaped. For example, the holes 314 may be oblong shaped to allow for alignment of the mounting bracket 302 and/or alignment of the fasteners. While not shown in FIG. 8A, the mounting system 300 may have a detachable base cover (e.g., such as the base cover 218 shown in FIG. 7A) that may be mounted to/over the base 310, e.g., for covering and/or concealing the base 310 and fasteners.

The attachment member 320 may include a drum 324 (e.g., a cylindrical drum). The drum 324 may extend in the longitudinal direction L. The drum 324 may be configured to receive an end portion of a roller tube assembly of a motorized window treatment (e.g., the end portion 114 of the roller tube assembly 111 of the motorized window treatment 100). For example, the drum 324 may define a channel 330 that may be configured receive (e.g., for sliding receipt of) the end portion of the roller tube assembly of the motorized window treatment (e.g., similar to the channel 138A of the first mounting bracket 141A). The channel 330 may define an opening 332 in the attachment member 320. The channel 330 may extend from the opening 332 to a rear wall 334. The channel 330 may define slots 336 (e.g., two slots) on either side of the channel 330. The slots 336 may be configured such that the channel 330 is T-shaped (e.g., has a T-shaped cross section). The slots 336 may be defined by respective flanges 338 of the drum 324 of the attachment member 320. The flanges 338 may be configured to retain the end portion of the roller tube assembly within the channel 330. The flanges 338 may be configured to secure the roller tube assembly in the transverse direction T and/or longitudinal direction L.

The mounting bracket 302 may also comprise a spring 340, which may be secured to the attachment member 320, for example, in the channel 330. For example, the spring 340 may be secured to a side wall 342 of the channel 330. The spring 340 may be positioned at the opening 332 of the channel 330 and secured in the channel 330 using one or more fasteners 344. The spring 340 may include compliant fingers 346 that are configured to engage the side wall 342 of the channel 330 and bias a rear edge 348 of the spring 340 away from the side wall 342. For example, the rear edge 348 may be spaced away from the side wall 342. The compliant fingers 346 may be configured to flex as the end portion of the roller tube assembly is inserted into the channel 330. For example, the end portion of the roller tube assembly may apply a force on the spring 340 that pushes the rear edge 348 closer to the side wall 342. The spring 340 may be configured to engage the end portion of the roller tube assembly to secure the end portion within the channel 330. When the end portion is fully inserted into the channel 330, the compliant fingers 346 may enable the rear edge 348 to exert a force on the end portion of the roller tube assembly such that the end portion is retained within the channel 330 (e.g., the rear edge 348 of the spring 340 may engage ridge 101 (see FIG. 5A) of the end portion 114). The rear edge 348 may exert the force on the end portion of the roller tube assembly in the radial direction R when the mounting bracket 302 is wall-mounted.

The mounting system 300 may include a sliding cover 350 that may be operated into a closed position and an open position (e.g., as with the sliding cover 136A of the motorized window treatment 100). For example, the sliding cover 350 is shown in the open position in FIG. 8A. The sliding cover 350 may be received by the drum 324 of the attachment member 320 of the mounting bracket 302 and may surround or partially surround the drum 324. The sliding cover 350 may have a circular shape and may rotate around the drum 324/attachment member 320 between the open position and the closed position. When the sliding cover 350 is in the open position, the end portion of the roller tube assembly may be installed into the channel 330 of the attachment member 320. When the end portion of the roller tube assembly is fully installed in the channel 330, the sliding cover 350 may be rotated into the closed position in which the sliding cover 350 hides the end portion and the channel 330 from view. When the sliding cover 350 is in the closed position, the channel 330 and the end portion of the roller tube assembly are not accessible. When the sliding cover 350 is in the open position, the channel 330 and the end portion of the roller tube assembly may be exposed.

The mounting bracket 302 (e.g., the base 310) may define a notch 379 on an interior face 378 of the base 310. The interior face 378 may be distal from the arm 322. For example, the interior face 378 may face another mounting bracket (e.g., such as the mounting bracket 141B shown in FIG. 2) of the motorized window treatment. The interior face 378 may be parallel to the arm 322. The notch 379 may extend from the interior face 378 towards arm 322. The notch 379 may be configured to receive electrical wiring (e.g., the cable 370) for powering the drive assembly such that the electrical wiring (e.g., the cable 370) enters the structure proximate to the notch 379 when the mounting bracket 302 is mounted to the structure. The notch 379 may be rectangular or U-shaped, for example, as shown in FIG. 8A. It should be appreciated that the notch 379 may be alternatively shaped. For example, the notch 379 may be circular, semi-circular, polygonal, and/or the like.

The mounting system 300 may comprise a connector 360 configured to provide electrical connection to the drive assembly of the motorized window treatment. The connector 360 may be provided at the end of the cable 370 and may be received in the channel 330 of the attachment member 320 of the mounting bracket 302 and affixed (e.g., removably affixed) therein.

The cable 370 may have one or more electrical conductors, such as wires 372. The cable 370 may extend through a bore 374 (e.g., an internal bore) in the arm 322 of the mounting bracket 302 that begins in the channel 330 and ends at an opening 375 at the junction of the arm 322 and the base 310. The cable 370 may further extend through a trench 376 in (e.g., cut into) the front surface 316 of the base 310. The bore 374 and the trench 376 may be configured to receive the cable 370. The trench 376 may extend from the arm 322/opening 375 toward the interior face 378 of the base 310, such that the cable 370 may be received through the notch 379 in the base 322 and into an electrical wallbox (e.g., such as the electrical wallbox 170) mounted in the structure behind the base 322. The bore 374 of the mounting bracket 302 may not extend to a rear surface of the base 322 (e.g., such as the bore 274 extends to the rear surface 276 of the base 210 of the mounting bracket 202 shown in FIG. 7B).

The connector 360 may have a similar structure as the connector 260 shown in FIGS. 7C and 7D. The connector 360 may comprise a plug portion 362 configured to be received in an opening of the drive assembly (e.g., the opening 116 of the drive assembly 160 shown in FIGS. 5A and 5B). The plug portion 362 of the connector 360 may be configured to be electrically connected to a connector located on the end portion of the roller tube assembly. The connector 360 (e.g., the plug portion 362) may be configured to engage with a socket of the drive assembly (e.g., the socket 166 of the drive assembly 160 shown in FIG. 5B) when the end portion of the roller tube assembly is inserted into the channel 330. The plug portion 362 of the connector 360 may comprise one or more openings 363 for housing electrical conductors that may be electrically coupled to pins (e.g., the pins 168) of the socket. For example, the opening(s) 363 may be configured to receive the pins of the socket of the drive assembly when the end portion is received within the channel 330. The connector 360 may be configured to electrically connect the motorized window treatment (e.g., the drive assembly) to electrical wiring (e.g., the cable 370) for powering the drive assembly. As another example, the plug portion 362 may alternatively comprise pins and the socket of the drive assembly may comprise openings for housing electrical conductors. Other variations are also possible.

The connector 360 may comprise a base portion 364 configured to rest against the rear wall 334 of the channel 330, such that the plug portion 362 may extend towards the opening 332 of the channel 330. For example, the base portion 364 may abut the rear wall 334 of the channel 330 when the connector 360 is disposed within the channel 330. The base portion 364 may define a curved edge that corresponds with a shape of the rear wall 334 of the channel 330. The connector 360 may comprise a pair of arms 365 configured to be received in respective slots 336 of the channel 330 when the connector 360 is received in the channel 330, thereby aiding to affix the connector 360 in the channel 330. The slots 336 may be defined by the flanges 338 and/or a side wall 342 of the channel 330. Each of the arms 365 may comprise a ridge (e.g., such as the ridge 266) and a tab (e.g., such as the tab 268) configured to abut edges (e.g., such as the edges 239) of the respective slots 336 of the channel 330 when the connector 360 is received in the channel 330. The ridge and the tab may extend in the transverse direction T. The tab may be located at a distal end of the arms 365. The ridge may be located at an intermediate (e.g., between the distal end and the base portion 364) location of the arms 365. Each of the arms 365 may define a groove 367 on the opposite side as the ridge and tab. Each groove 367 may be configured to receive a respective rail of the end portion of the roller tube assembly (e.g., such as the rails 113 of the end portion 114 of the roller tube assembly 111 shown in FIGS. 4, 5A, and 5B). According to one example, the connector 360 (e.g. at least each of the arms 365) may be made of a material, such as plastic or rubber, that may act to mechanically isolate/cushion the drive assembly from the mounting bracket 302 thereby helping to reduce noise as the motorized window treatment operates.

As another example, the mounting system 300 may be configured as a center mounting bracket (e.g., such as the center mounting bracket 202′ of the mounting system 200′ shown in FIGS. 7E-7H). Such a center mounting bracket of such a mounting system may comprise a base having a first portion (e.g., like base 310 with a notch 379 and trench 376) and a second portion, which may be located on an opposite side of the arm 322 for example as the first portion of the base, and may be a mirror copy of the first portion of the base (e.g., similar to base 310) (i.e., a first and second portion as similarly described herein for center mounting bracket 202′ for example). The center mounting bracket may comprise a first attachment member (e.g., similar to the attachment member 320) and a second attachment member, which may be located on an opposite side of the arm 322 for example as the first attachment member, and may be a mirror copy of the first attachment member (e.g., the attachment member 320) (as similarly described herein for center mounting bracket 202′ for example). A connector (e.g., the connector 360) may be located in each of the first and second attachment members. The center mounting bracket may comprise a first bore in the arm (e.g., like bore 374) and a first trench in the first portion of the base (e.g., like the trench 376 in the base 310) through which a first cable (e.g., the cable 370) may extend for powering a drive assembly of the roller tube assembly coupled to the first attachment member. The center mounting bracket may comprise a second bore in the arm (e.g., in addition to the first bore) and a second trench in the second portion of the base through which a second cable may extend for powering a drive assembly of the roller tube assembly coupled to the second attachment member. In some examples, the arm of the mounting bracket may comprise a single bore through which both of the cables may extend between the first and second attachment members and the first and second trenches in the first and second portions of the base, respectively. Each of the first and second portions of the base may include a notch similar to notch 379.

It should be appreciated that the base 310 may be substantially the width of the arm 322 such that the base 310 does not extend beyond the arm 322. According to another example, a mounting system may be configured similar to mounting system 300 but not include a base.

FIG. 8B is a front perspective view of another example mounting system 300′ for mounting a roller tube assembly (e.g., roller tube assembly 111 of motorized window treatment 100 shown in FIGS. 1-5B) (e.g., mounting system 300′ is a variation of the mounting system 300 shown in FIG. 8A). For example, the mounting system 300′ may comprise a mounting bracket 302, which may be deployed as the first mounting bracket 141A of the motorized window treatment 100. The mounting system 300′ may comprise a connector 360′ that is configured to freely float in the channel 330 (e.g., rather than the connector 360 that is received and fixed within the channel 330). The connector 360′ may be provided at the end of a cable 370′ and may have one or more electrical conductors, such as wires 372′. For example, as shown in FIG. 8B, the cable 370′ may have a flexible sleeve, which may be cut into segments to allow the cable 370′ to be easily bent to fit within the channel 330 when the end portion of the roller tube assembly is fully inserted into the channel 330. The cable 370′ may extend through the bore 374 in the arm 322 and the trench 376 in the base 310, and be received through the notch 379 and into the electrical wallbox. The connector 360′ may be configured to be received in an opening of the drive assembly (e.g., the opening 116 of the drive assembly 160 shown in FIGS. 5A and 5B). The connector 360′ may be configured to be electrically connected to a connector located on the end portion of the roller tube assembly. The connector 360′ may be configured to engage with a socket of the drive assembly (e.g., the socket 166 of the drive assembly 160 shown in FIG. 5B). The connector 360′ may comprise one or more openings 363′ for housing electrical conductors that may be electrically coupled to pins (e.g., the pins 168) of the socket. For example, the opening(s) 363′ may be configured to receive the pins of the socket of the drive assembly when the end portion is received within the channel 330. The connector 360′ may be configured to electrically connect the motorized window treatment (e.g., the drive assembly) to electrical wiring (e.g., the cable 370′) for powering the drive assembly. As another example, the connector 360′ may alternatively comprise pins and the socket of the drive assembly may comprise openings for housing electrical conductors. Other variations are also possible. In this configuration, each of the slots 336 of the channel 332 of the attachment member 320 may be configured to receive a respective rail of the end portion of the roller tube assembly when inserted therein.

As another example, the mounting system 300′ may be configured as a center mounting bracket (e.g., similar to the center mounting bracket 202′ of the mounting system 200′ shown in FIGS. 7E-7H), as similarly described with respect to mounting system 300, with one or both of the connectors located in the first and second attachment members replaced with a connector 360′ and respective wire 370′.

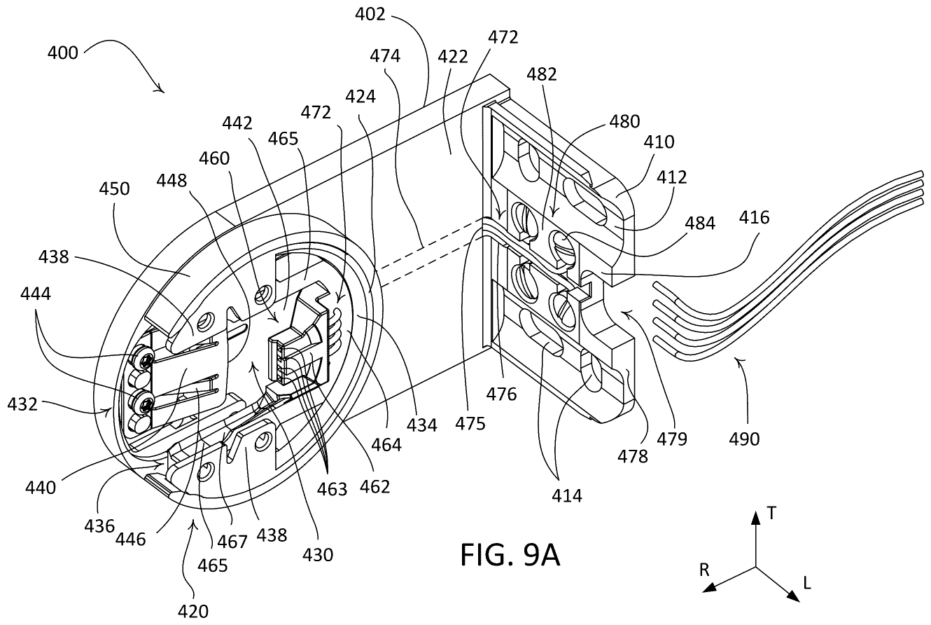

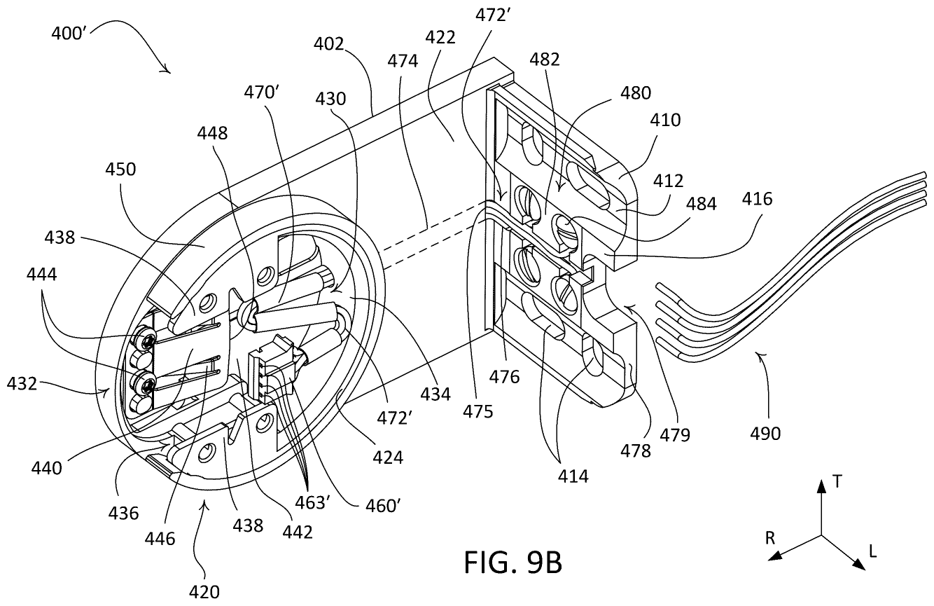

FIG. 9A is a front perspective view of an example mounting system 400 for mounting a roller tube assembly (e.g., roller tube assembly 111 of motorized window treatment 100 shown in FIGS. 1-5B). For example, the mounting system 400 may comprise a mounting bracket 402, which may be deployed as the first mounting bracket 141A of the motorized window treatment 100. The mounting bracket 402 may include a base 410 (e.g., a foot) and an attachment member 420 that may be connected to the base 410 via an arm 422. The base 410 may be configured to attach the mounting bracket 402 to a structure (e.g., a window frame, a wall, a ceiling, or other structure as with the motorized window treatment 100 shown in FIG. 1). The arm 422 may extend substantially perpendicular from the base 410 to the attachment member 420. When the mounting bracket 402 is attached to a vertical structure (e.g., such as a wall), the arm 422 may extend horizontally (e.g., in the radial direction R) from the base 410 to the attachment member 420. When the mounting bracket 402 is attached to a horizontal structure (e.g., such as a ceiling), the arm 422 may extend vertically (e.g., in the transverse direction T) from the base 410 to the attachment member 420.

The base 410 may define depressions 412 that may have a reduced thickness when compared to a remainder of the base 410. The base 410 may include holes 414 therethrough. Each of the holes 414 may be configured to receive a fastener (not shown) for securing the mounting bracket 402 to the structure. The holes 414 may be located within the depressions 412, such that the fasteners may be countersunk with respect to a front surface 416 of the base 410. Each of the holes 414 may be oblong shaped. For example, the holes 414 may be oblong shaped to allow for alignment of the mounting bracket 402 and/or alignment of the fasteners. While not shown in FIG. 9A, the mounting system 400 may include a detachable base cover (e.g., such as the base cover 218 shown in FIG. 7A) that may be mounted thereto, e.g., for covering and/or concealing the base 410 and fasteners.

The attachment member 420 may include a drum 424 (e.g., a cylindrical drum). The drum 424 may extend in the longitudinal direction L. The drum 424 may be configured to receive an end portion of a roller tube assembly of a motorized window treatment (e.g., the end portion 114 of the roller tube assembly 111 of the motorized window treatment 100). For example, the drum 424 may define a channel 430 (e.g., similar to the channel 138A of the first mounting bracket 141A) that may be configured to receive (e.g., for sliding receipt of) the end portion of the roller tube assembly of the motorized window treatment. The channel 430 may define an opening 432 in the attachment member 420. The channel 430 may extend from the opening 432 to a rear wall 434. The channel 430 may define slots 436 (for example 2 slots) on either side of the channel 430. The slots 436 may be configured such that the channel 430 is T-shaped (e.g., has a T-shaped cross section). The slots 436 may be defined by respective flanges 438 of the drum 424 of the attachment member 420. The slots 436 may also be defined by a side wall 442 of the channel 430. The flanges 438 may be configured to retain the end portion of the roller tube assembly within the channel 430. The flanges 438 may be configured to secure the roller tube in the transverse direction T and/or longitudinal direction L.

The mounting bracket 402 may also comprise a spring 440, which may be secured to the attachment member 420, for example, in the channel 430. For example, the spring 440 may be secured to a side wall 442 of the channel 430. The spring 440 may be positioned at the opening 432 of the channel 430 and be secured in the channel 430 using one or more fasteners 444. The spring 440 may include compliant fingers 446 that are configured to engage the side wall 442 of the channel 430 and bias a rear edge 448 of the spring 440 away from the side wall 442. For example, the rear edge 448 may be spaced away from the side wall 442. The compliant fingers 446 may be configured to flex as the end portion of the roller tube assembly is inserted into the channel 430. For example, the end portion of the roller tube assembly may apply a force on the spring 440 that pushes the rear edge 448 closer to the side wall 442. The spring 440 may be configured to engage the end portion of the roller tube assembly to secure the end portion within the channel 430. When the end portion is fully inserted into the channel 430, the compliant fingers 446 may enable the rear edge 448 to exert a force on the end portion of the roller tube assembly such that the end portion is retained within the channel 430 (e.g., the rear edge 448 of the spring may engage the ridge 101 (see FIG. 5A) of the end portion 114). The rear edge 448 may exert the force on the end portion of the roller tube assembly in the radial direction R when the mounting bracket 402 is wall-mounted, for example.

The mounting system 400 may include a sliding cover 450 that may be operated into a closed position and an open position (e.g., as with the sliding cover 136A of the motorized window treatment 100). For example, the sliding cover 450 is shown in the open position in FIG. 9A. The sliding cover 450 may be received by the drum 424 of the attachment member 420 of the mounting bracket 402 and may surround or partially surround the drum 424. The sliding cover 450 have a circular shape and may rotate around the drum 424/attachment member 420 between the open position and the closed position. When the sliding cover 450 is in the open position, the end portion of the roller tube assembly may be installed into the channel 430 of the attachment member 420.

When the end portion of the roller tube assembly is fully installed in the channel 430, the sliding cover 450 may be rotated into the closed position in which the sliding cover 450 hides the end portion and the channel 430 from view. When the sliding cover 450 is in the closed position, the channel 430 and the end portion of the roller tube assembly are not accessible. When the sliding cover 450 is in the open position, the channel 430 and the end portion of the roller tube assembly may be exposed and/or accessible.

The mounting bracket 402 (e.g., the base 410) may define a notch 479 on an interior face 478 of the base 410. The interior face 478 may be distal from the arm 422. For example, the interior face 478 may be configured to face another mounting bracket (e.g., such as the mounting bracket 141B shown in FIG. 2) of the motorized window treatment when the mounting bracket 402 is mounted to the structure. The interior face 478 may be parallel to the arm 422. The notch 479 may extend from the interior face 478 towards the arm 422. The notch 479 may be configured to receive electrical wiring (e.g., wires 490) for powering the drive assembly such that the electrical wiring (e.g., wires 490) exits the structure proximate to the notch 479 when the mounting bracket 402 is mounted to the structure.

The mounting system 400 may comprise a connector 460 (e.g., a first connector) configured to provide electrical connection to the drive assembly of the motorized window treatment. The connector 460 may be received in the channel 430 of the attachment member 420 of the mounting bracket 402. For example, the connector 460 may be disposed and fixed within the channel 430. The connector 460 may be removably attached to the mounting bracket 402. The connector 460 may be connected to one or more electrical conductors, such as wires 472 which may extend through one or more bores 474 in the arm 422 of the mounting bracket 402. The bore 474 may extend from the channel 430 to one or more openings, such as opening 475. While not shown in FIG. 9A, the wires 472 may be within a flexible sleeve (e.g., as with the cables 272, 372). The wires 472 may exit the bore 474 through the one or more openings 475 at the junction of the arm 422 and the base 410, and extend through a trench 476 in (e.g., cut into) the front surface 416 of the base 410. The trench 476 may be configured to receive the wires 472 and/or the wires 490. The trench 476 may extend from the arm 422 and opening(s) 475 towards the interior face 478 of the base 410/the notch 479, such that the wires 490 are received through the notch 479 in the base 410 from an electrical wallbox (e.g., such as the electrical wallbox 170) mounted in the structure behind the base 410. For example, the trench 476 may extend between the arm 422 and the notch 479.

The mounting system 400 may comprise a second connector, such as a terminal block 480. The terminal block 480 may be located in the front surface 416 of the base 410 of the mounting bracket 402. The terminal block 480 may allow for connection to electrical conductors, such as wires 490, that may be received through an electrical wallbox (e.g., the electrical wallbox 170) mounted in the structure behind the base 410, for example. The terminal block 480 may comprise a body 482 (e.g., a non-conductive body) and a plurality of screw terminals 484 (e.g., four screw terminals). The screw terminals 484 may be electrically coupled to the wires 472 that extend through the bore 474 from the first connector 460. The wires 490 may be electrically coupled to the screw terminals 484 for electrically coupling a drive assembly to a power source and/or a communication link. For example, during installation of the motorized window treatment, the wires 490 may be inserted into/onto the screw terminals 484, which may be tightened to lock the wires 490 in place (e.g., in electrical connection with the screw terminals 484). The wires 490 may be received through the notch 479 in the base 410 and into the electrical wallbox mounted behind the base 410 for example. One will recognize that terminal block 480 may include more than or fewer than four screw terminals 484.

The connector 460 may have a similar structure and features as the connector 260 shown in FIGS. 7C and 7D. The connector 460 may comprise a plug portion 462 configured to be received in an opening of the drive assembly (e.g., the opening 116 of the drive assembly 160 shown in FIGS. 5A and 5B). The plug portion 462 of the connector 460 may be configured to be electrically connected to a connector located on the end portion of the roller tube assembly (e.g., such as end portion 114 shown in FIGS. 5A and 5B). The connector 460 (e.g., the plug portion 462) may be configured to engage with a socket of the drive assembly (e.g., the socket 166 of the drive assembly 160 shown in FIG. 5B). The plug portion 462 of the connector 460 may comprise one or more openings 463 for housing electrical conductors that may be electrically coupled to pins (e.g., the pins 168) of the socket. For example, the opening(s) 463 may be configured to receive the pins of the socket of the drive assembly when the end portion is received within the channel 430. The connector 460 may be configured to electrically connect the motorized window treatment (e.g., the drive assembly) to electrical wiring (e.g., the wires 472) for powering the drive assembly. As another example, the plug portion 462 may alternatively comprise pins and the socket of the drive assembly may comprise openings for housing electrical conductors. Other variations are also possible.

The connector 460 may comprise a base portion 464 configured to rest against the rear wall 434 of the channel 430, such that the plug portion 462 may extend towards the opening 432 of the channel 430. For example, the base portion 464 may abut the rear wall 434 of the channel 430 when the connector 460 is disposed within the channel 430. The base portion 464 may define a curved edge that corresponds with a shape of the rear wall 434 of the channel 430. The connector 460 may comprise a pair of arms 465 that extend within the channel 430 in the radial direction, R (e.g., from the base portion 464). The arms 465 may be configured to be received in respective slots 436 of the channel 430 when the connector 460 is received in the channel 430. Each of the arms 465 may comprise a ridge (e.g., such as the ridge 266) and a tab (e.g., such as the tab 268) configured to abut edges (e.g., such as the edges 239) of the respective slots 436 of the channel 430 when the connector 460 is received in the channel 430. The ridge and the tab may extend in the transverse direction. The tab may be located at a distal end of the arms 465. The ridge may be located at an intermediate (e.g., between the distal end and the base portion 464) location of the arms 465. Each of the arms 465 may define a groove 467 on the opposite side as the ridge and tab. Each of the grooves 467 may be configured to receive a respective rail of the end portion of the roller tube assembly (e.g., such as the rails 113 of the end portion 114 of the roller tube assembly 111 shown in FIGS. 4, 5A, and 5B).

As another example, the mounting system 400 may be configured as a center mounting bracket (e.g., such as the center mounting bracket 202′ of the mounting system 200′ shown in FIGS. 7E-7H). Such a center mounting bracket of such a mounting system may comprise a base having a first portion (e.g., like base 410 with a notch 479 and trench 476) and a second portion, which may be located on an opposite side of the arm 422 for example as the first portion of the base, and may be a mirror copy of the first portion of the base (e.g., similar to base 410) (i.e., a first and second portion as similarly described herein for center mounting bracket 202′ for example). The center mounting bracket may comprise a first attachment member (e.g., similar to attachment member 420) and a second attachment member, which may be located on an opposite side of the arm 422 for example as the first attachment member, and may be a mirror copy of the first attachment member (e.g., the attachment member 420) (as similarly described herein for center mounting bracket 202′ for example). A first connector (e.g., the connector 460) may be located in each of the first and second attachment members. The center mounting bracket may comprise a first bore in the arm (e.g., like bore 474) and a first trench in the first portion of the base (e.g., like the trench 476 in the base 410) through which a first cable or wires (e.g., the wires 472) may extend for powering a drive assembly of a roller tube assembly coupled to the first attachment member. The first portion of the base may also include a notch (e.g., like notch 479 in the base 410). The center mounting bracket may comprise a second bore in the arm (e.g., in addition to the first bore) and a second trench (e.g., similar to the trench 476) in the second portion of the base through which a second cable or wires may extend for powering a drive assembly of the roller tube assembly coupled to the second attachment member. The second portion of the base may also include a notch (e.g., similar to the notch 479 in the base 410). In some examples, the arm of the mounting bracket may comprise a single bore through which both sets of the wires/cables may extend between the first and second attachment members and the first and second trenches in the first and second portions of the base, respectively. A respective second connector (e.g., like terminal block 488) may be located in each of the first portion and second portion of the base of the center bracket with each second connector electrically connected to a respective first connector (e.g., like connector 460) located in each of the first and second attachment members, as similarly described for mounting system 400. In this fashion, sets of wires (e.g., the wires 490) may be connected to each of the second connectors in each of the first and second portions of the base to power respective drive assemblies of respective roller tube assemblies that may be coupled to the first and second attachment members. In some examples, only one side (left side or right side) of the center bracket may include a second connector in the respective base portion and a corresponding first connector in the respective attachment member. Here, an idler of a roller tube assembly may be inserted into the attachment member for example.

It should be appreciated that the base 410 may be substantially the width of the arm 422 such that the base 410 does not extend beyond the arm 422. According to another example, a mounting system may be configured similar to mounting system 400 but not include a base.

FIG. 9B is a front perspective view of another example mounting system 400′ for mounting a roller tube assembly (e.g., roller tube assembly 111 of motorized window treatment 100 shown in FIGS. 1-5B (e.g., mounting system 400′ is a variation of the mounting system 400 shown in FIG. 9A). For example, the mounting system 400′ may comprise a mounting bracket 402, which may be deployed as the first mounting bracket 141A of the motorized window treatment 100. The mounting system 400′ may comprise a connector 460′ that is configured to freely float in the channel 430 (e.g., rather than the connector 460 that is received and fixed within the channel 430). The connector 460′ may be provided at the end of a cable 470′ and may have one or more electrical conductors, such as wires 472′. For example, as shown in FIG. 9B, the cable 470′ may have a flexible sleeve, which may be cut into segments to allow the cable 470′ to be easily bent to fit within the channel 430 when the end portion of the drive assembly is fully inserted into the channel 430. The wires 472′ may extend through the bore 474 in the arm 422 and opening 475 and may be electrically coupled to the screw terminals 484 in the terminal block 480. The connector 460′ may be configured to be received in an opening of the drive assembly (e.g., the opening 116 of the drive assembly 160 shown in FIGS. 5A and 5B). The connector 460′ may be configured to be electrically connected to a connector located on the end portion of the roller tube assembly. The connector 460′ may be configured to engage with a socket of the drive assembly (e.g., the socket 166 of the drive assembly 160 shown in FIG. 5B). The connector 460′ may comprise one or more openings 463′ for housing electrical conductors that may be electrically coupled to pins (e.g., the pins 168) of the socket. For example, the opening(s) 463′ may be configured to receive the pins of the socket of the drive assembly when the end portion is received within the channel 430. The connector 460′ may be configured to electrically connect the motorized window treatment (e.g., the drive assembly) to electrical wiring (e.g., the wires 490) for powering the drive assembly. As another example, the connector 460′ may alternatively comprise pins and the socket of the drive assembly may comprise openings for housing electrical conductors. Other variations are also possible.

As another example, the mounting system 400′ may also be configured as a center mounting bracket (e.g., such as the center mounting bracket 202′ of the mounting system 200′ shown in FIGS. 7E-7H), as similarly described with respect to mounting system 400 with a respective connector 460′ (and respective wire 470′) located in one or both of the first and second attachment members.

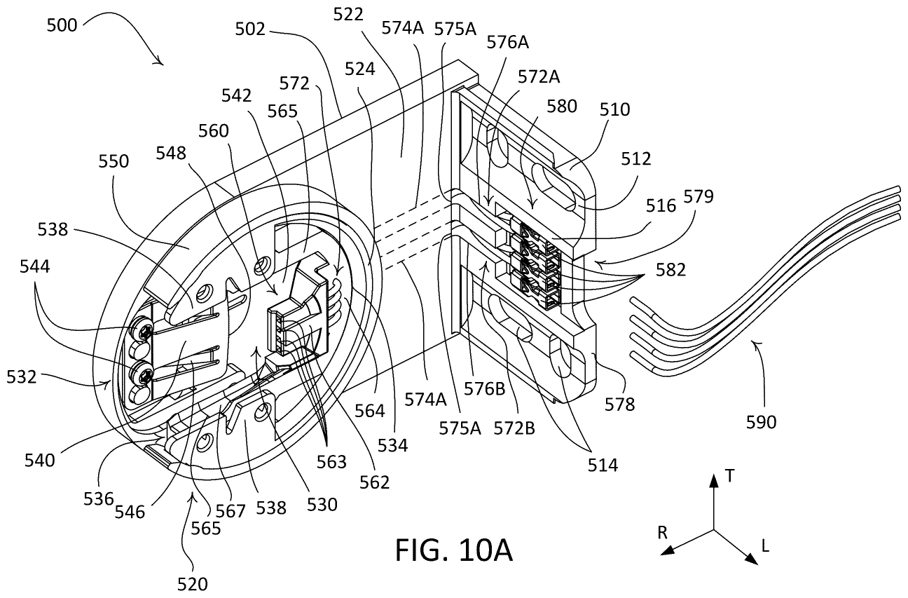

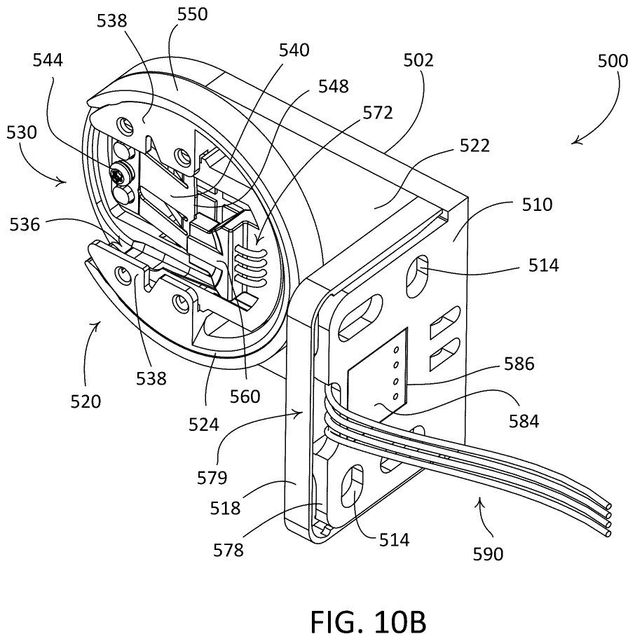

FIG. 10A is a front perspective view and FIG. 10B is a rear perspective view of an example mounting system 500 for mounting a roller tube assembly (e.g., roller tube assembly 111 of motorized window treatment 100 shown in FIGS. 1-5B. For example, the mounting system 500 may comprise a mounting bracket 502 that may be deployed as the first mounting bracket 141A of the motorized window treatment 100. The mounting bracket 502 may include a base 510 (e.g., a foot) and an attachment member 520 that may be connected to the base 510 via an arm 522. The base 510 may be configured to attach the mounting bracket 502 to a structure (e.g., a window frame, a wall, a ceiling, or other structure as with the motorized window treatment 100 shown in FIG. 1). The arm 522 may extend substantially perpendicular from the base 510 to the attachment member 520. When the mounting bracket 502 is attached to a vertical structure (e.g., such as a wall), the arm 522 may extend horizontally (e.g., in the radial direction R) from the base 510 to the attachment member 520. When the mounting bracket 502 is attached to a horizontal structure (e.g., such as a ceiling), the arm 522 may extend vertically (e.g., in the transverse direction T) from the base 510 to the attachment member 520.

The base 510 may define depressions 512 that may have a reduced thickness when compared to a remainder of the base 510. The base 510 may include holes 514 therethrough. Each of the holes 514 may be configured to receive a fastener (not shown) for securing the mounting bracket 502 to the structure. The holes 514 may be located within the depressions 512, such that the fasteners may be countersunk with respect to a front surface 516 of the base 510. Each of the holes 514 may be oblong shaped. For example, the holes 514 may be oblong shaped to allow for alignment of the mounting bracket 502 and/or alignment of the fasteners. The mounting system 500 may comprise a detachable base cover 518 that may be configured to be detachably mounted over the base 510, e.g., for covering and/or concealing the base 510 and fasteners.

The attachment member 520 may include a drum 524 (e.g., a cylindrical drum). The drum 524 may extend in the longitudinal direction L. The drum 524 may be configured to receive an end portion of a roller tube assembly of a motorized window treatment (e.g., the end portion 114 of the roller tube assembly 111 of the motorized window treatment 100). For example, the drum 524 may define a channel 530 that may be configured to receive (e.g., for sliding receipt of) the end portion of the roller tube assembly of the motorized window treatment (e.g., similar to the channel 138A of the first mounting bracket 141A). The channel 530 may define an opening 532 in the attachment member 520. The channel 530 may extend from the opening 532 to a rear wall 534. The channel 530 may define slots 536 (e.g., two slots) on either side of the channel 530. The slots 536 may be configured such that the channel 530 is T-shaped (e.g., has a T-shaped cross section). The slots 536 may be defined by respective flanges 538 of the drum 524 of the attachment member 520. The slots 536 may also be defined by a side wall 542 of the channel 530. The flanges 538 may be configured to retain the end portion of the roller tube assembly within the channel 530. The flanges 538 may be configured to secure the roller tube in the transverse direction T and/or longitudinal direction L.

The mounting bracket 502 may also comprise a spring 540, which may be secured to the attachment member 520, for example, in the channel 530. For example, the spring 540 may be secured to a side wall 542 of the channel 530. The spring 540 may be positioned at the opening 532 of the channel 530 and secured in the channel 530 using one or more fasteners 544. The spring 540 may include compliant fingers 546 that are configured to engage the side wall 542 of the channel 530 and bias a rear edge 548 of the spring 540 away from the side wall 542. For example, the rear edge 548 may be spaced away from the side wall 542. The compliant fingers 546 may be configured to flex as the end portion of the roller tube assembly is inserted into the channel 530. For example, the end portion of the roller tube assembly may apply a force on the spring 540 that pushes the rear edge 548 closer to the side wall 542. The spring 540 may be configured to engage the end portion of the roller tube assembly to secure the end portion within the channel 530. When the end portion is fully inserted into the channel 530, the compliant fingers 546 may enable the rear edge 548 to exert a force on the end portion of the roller tube assembly such that the end portion is retained within the channel 530 (e.g., the rear edge 548 of the spring may engage ridge 101 (see FIG. 5A) of the end portion 114). The rear edge 548 may exert the force on the end portion of the roller tube assembly in the radial direction R when the mounting bracket 502 is wall-mounted.

The mounting system 500 may include a sliding cover 550 that may be operated into a closed position and an open position (e.g., as with the sliding cover 136A of the motorized window treatment 100). For example, the sliding cover 550 is shown in the open position in FIG. 10A. The sliding cover 550 may be received by the drum 524 of the attachment member 520 of the mounting bracket 502 and may surround or partially surround the drum 524. The sliding cover 550 have a circular shape and may rotate around the drum 524/attachment member 520 between the open position and the closed position. When the sliding cover 550 is in the open position, the end portion of the roller tube assembly may be installed into the channel 530 of the attachment member 520. When the end portion of the roller tube assembly is fully installed in the channel 530, the sliding cover 550 may be rotated into the closed position in which the sliding cover 550 hides the end portion and the channel 530 from view. When the sliding cover 550 is in the closed position, the channel 530 and the end portion of the roller tube assembly are not accessible. When the sliding cover 550 is in the open position, the channel 530 and the end portion of the roller tube assembly may be exposed.

The mounting bracket 502 (e.g., the base 510) may define a notch 579 on an interior face 578 of the base 510. The interior face 578 may be distal from the arm 522. For example, the interior face 578 may be configured to face another mounting bracket (e.g., such as the mounting bracket 1141B shown in FIG. 2) of the motorized window treatment when the mounting bracket 502 is mounted to the structure. The interior face 578 may be parallel to the arm 522. The notch 579 may extend from the interior face 578 towards the arm 522. The notch 579 may be configured to receive electrical wiring (e.g., wires 590) for powering the drive assembly. The electrical wiring (e.g., wires 590) may extend from or exit the structure proximate to the notch 579 when the mounting bracket 502 is mounted to the structure.

The mounting system 500 may comprise a connector 560 (e.g., a first connector) configured to provide electrical connection to the drive assembly of the motorized window treatment. The connector 560 may be received in the channel 530 of the attachment member 520 of the mounting bracket 502. The connector 560 may be connected to one or more electrical conductors, such as wires 572. For example, the wires 572 may comprise a first pair 572A of wires (e.g., the electrical conductors 196) and a second pair 572B of wires (e.g., the electrical conductors 198). While not shown in FIG. 10A, the wires 572 may be included in a flexible sleeve (e.g., as with the cables 272, 372). The first pair 572A and the second pair 572B of wires may extend through respective one or more bores, such as bores 574A, 574B in the arm 522 of the mounting bracket 502. The bores 574A, 574B may extend from the attachment member 520 to one or more respective openings, such as openings 575A, 575B at the junction of the arm 522 and the base 510. The first pair 572A and the second pair 572B of wires may exit the arm 522 through the respective one or more openings 575A, 575B at the junction of the arm 522 and the base 510, and may extend through one or more trenches, such as respective trenches 576A, 576B cut into the front surface 516 of the base 510. One will recognize that arm 522 may include a single bore and the base may include a single trench with both the first and second pairs of wires extending through the single bore and single trench.

The mounting system 500 may comprise a second connector, such as a plug-in connector assembly 580. The plug-in connector assembly 580 may comprise a plurality of plug-in terminals 582 (e.g., four plug-in terminals) mounted to a printed circuit board 584. The printed circuit board 584 may be received in an opening 586 that extends through the base 510 of the mounting bracket 502, such that the plug-in terminals 582 are located adjacent the front surface 516 of the base 510. The trenches 576A, 576B may extend from the arm 522 and openings 575A, 575B to the opening 586. The plug-in connector assembly 580 may allow for connection to electrical conductors, such as wires 590, that may be received from an electrical wallbox (e.g., the electrical wallbox 170) mounted in the structure behind the base 522, for example. The plug-in terminals 582 may be electrically coupled to the first pair 572A and the second pair 572B of wires that extend through the bores 574A, 574B. The wires 590 may be electrically coupled to the plug-in terminals 582 for electrically coupling the drive assembly to a power source and/or a communication link. For example, during installation of the motorized window treatment, the wires 590 may be inserted (e.g., plugged and/or stabbed) into the plug-in terminals 582 (e.g., put in electrical connection with the plug-in terminals 582). The wires 590 may be received through the notch 579 in the base 522 and may extend into the electrical wallbox mounted behind the base 522. One will recognize that the plug-in connector assembly 580 may include more than or fewer than four plug-in terminals 582.

The connector 560 may have a similar structure and features as the connector 260 shown in FIGS. 7C and 7D. The connector 560 may comprise a plug portion 562 configured to be received in an opening of the drive assembly (e.g., the opening 116 of the drive assembly 160 shown in FIGS. 5A and 5B). The plug portion 562 of the connector 560 may be configured to be electrically connected to a connector located on the end portion of the roller tube assembly. The connector 560 (e.g., the plug portion 562) may be configured to engage with a socket of the drive assembly (e.g., the socket 166 of the drive assembly 160 shown in FIG. 5B). The plug portion 562 of the connector 560 may comprise one or more openings 563 for housing electrical conductors that may be electrically coupled to pins (e.g., the pins 168) of the socket. For example, the opening(s) 563 may be configured to receive the pins of the socket of the drive assembly when the end portion is received within the channel 530. The connector 560 may be configured to electrically connect the motorized window treatment (e.g., the drive assembly) to electrical wiring (e.g., the cable 590) for powering the drive assembly. As another example, the plug portion 562 may alternatively comprise pins and the socket of the drive assembly may comprise openings for housing electrical conductors. Other variations are also possible.

The connector 560 may comprise a base portion 564 configured to rest against the rear wall 534 of the channel 530, such that the plug portion 562 may extend towards the opening 532 of the channel 530. For example, the base portion 564 may abut the rear wall 534 of the channel 530 when the connector 560 is disposed within the channel 530. The base portion 564 may define a curved edge that corresponds with a shape of the rear wall 534 of the channel 530. The connector 560 may comprise a pair of arms 565 configured to be received in respective slots 536 of the channel 530 when the connector 560 is received in the channel 530. Each of the arms 565 may comprise a ridge (e.g., such as the ridge 266) and a tab (e.g., such as the tab 268) configured to abut edges (e.g., such as the edges 239) of the slots 536 of the channel 530 when the connector 560 is received in the channel 530, thereby fixing the connector within the channel. The ridge and the tab may extend in the transverse direction. The tab may be located at a distal end of the arms 565. The ridge may be located at an intermediate (e.g., between the distal end and the base portion 564) location of the arms 565. Each of the arms 565 may define a groove 567 on the opposite side as the ridge and tab. Each groove 567 may be configured to receive a respective rail of the end portion of the roller tube assembly (e.g., such as the rails 113 of the end portion 114 of the roller tube assembly 111 shown in FIGS. 4, 5A, and 5B).

FIG. 10C is a front perspective view of the mounting system 500 having an extended base cover 518′ covering the base 510 of the mounting bracket 502. The extended base cover 518′ may be longer in the longitudinal direction than the base cover 518 shown in FIG. 10B to allow for additional area for the electrical wallbox to be covered by the extended base cover 518′ than with the base cover 518. As another example, a similar base cover(s) to base cover 518′ may be used with any of the mounting systems disclosed herein.

As another example, the mounting system 500 may be configured as a center mounting bracket (e.g., such as the center mounting bracket 202′ of the mounting system 200′ shown in FIGS. 7E-7H). Such a center mounting bracket of such a mounting system may comprise a base having a first portion (e.g., like base 510 with a notch 579 and trenches 576A and 576B) and a second portion, which may be located on an opposite side of the arm 522 for example as the first portion of the base, and may be a mirror copy of the first portion of the base (e.g., similar to base 510) (i.e., a first and second portion as similarly described herein for center mounting bracket 202′ for example). The center mounting bracket may comprise a first attachment member (e.g., similar to attachment member 520) and a second attachment member, which may be located on an opposite side of the arm 522 for example as the first attachment member, and may be a mirror copy of the first attachment member (e.g., the attachment member 520) (as similarly described herein for center mounting bracket 202′ for example). A first connector (e.g., the connector 560) may be located in each of the first and second attachment members. The center mounting bracket may comprise a first set of one or more bores in the arm for the first attachment member (similar to first and second bores 574A, 574B in the arm 522) a first set of one or more trenches, such as first and second trenches, in the first portion of the base (e.g., like trenches 576A, 576B in the base 510) through which a first cable or wires (e.g., like the wires 572) may extend for powering a drive assembly of the roller tube assembly coupled to the first attachment member. The first portion of the base may also include a notch (e.g., like the notch 579 in the base 510). The center mounting bracket may comprise a second set of one or more bores in the arm (e.g., in addition to the first set of bores) for the second attachment member, and a second set of one or more trenches in the second portion of the base (e.g., similar to the trenches 576A, 576B in the base 510) through which a second set of cable or wires may extend for powering a drive assembly of the roller tube assembly that may be coupled to the second attachment member. The second portion of the base may also include a notch (e.g., similar to the notch 579 in the base 510). In some examples, the arm of the center mounting bracket may comprise a single bore through which all sets of the wires/cables may extend between the first and second attachment members and the first and second sets of trenches in the first and second portions of the base, respectively. A respective second connector (e.g., like plug-in connector assembly 580) may be located in each of the first portion and second portion of the base of the center bracket with each second connector electrically connected to a respective first connector (e.g., like connector 560) located in each of the first and second attachment members, as similarly described for mounting system 500. In this fashion, sets of wires (e.g., the wires 590) may be connected to each of the second connectors in each of the first and second portions of the base to power respective drive assemblies of respective roller tube assemblies that may be coupled to the first and second attachment members. As a further example, one side of an example center mounting bracket may resemble bracket assembly 500, with the other side of the center bracket not having, for example, any of a connector 560 or plug-in connector assembly 580, for example. Here, an idler of a roller tube assembly may be inserted into the attachment member for example.

It should be appreciated that the base 510 may be substantially the width of the arm 522 such that the base 510 does not extend beyond the arm 522. According to another example, a mounting system may be configured similar to mounting system 500 but not include a base.

FIG. 10D is a front perspective view of another example mounting system 500′ for mounting a roller tube assembly (e.g., roller tube assembly 111 of motorized window treatment 100 shown in FIGS. 1-5B). Mounting system 500′ may be similar to mounting system 500. For example, the mounting system 500′ may comprise a mounting bracket 502, which may be deployed as the first mounting bracket 141A of the motorized window treatment 100. The mounting system 500′ may comprise a connector 560′ that is configured to freely float in the channel 530 (e.g., rather than the connector 560 that is received and fixed within the channel 530). The connector 560′ may be provided at the end of a cable 570′ and may have one or more electrical conductors, such as wires 572′ (e.g., a first pair 572A′ and a second pair 572B′ of wires). For example, as shown in FIG. 10D, the cable 570′ may have a flexible sleeve, which may be cut into segments to allow the cable 570′ to be easily bent to fit within the channel 530 when the end portion of the roller tube assembly is fully inserted into the channel 530. The first pair 572A′ and the second pair 572B′ of wires may extend through one or more bores in the arm 522, such as the respective bores 574A, 574B in the arm 522, and may be electrically coupled to the plug-in terminals 582 of the plug-in connector assembly 580. The connector 560′ may be configured to be received in an opening of the drive assembly (e.g., the opening 116 of the drive assembly 160 shown in FIGS. 5A and 5B). The connector 560′ may be configured to be electrically connected to a connector located on the end portion of the roller tube assembly. The connector 560′ may be configured to engage with a socket of the drive assembly (e.g., the socket 166 of the drive assembly 160 shown in FIG. 5B). The connector 560′ may comprise one or more openings 563′ for housing electrical conductors that may be electrically coupled to pins (e.g., the pins 168) of the socket. For example, the opening(s) 563′ may be configured to receive the pins of the socket of the drive assembly when the end portion is received within the channel 530. The connector 560′ may be configured to electrically connect the motorized window treatment (e.g., the drive assembly) to electrical wiring (e.g., the wires 590) for powering the drive assembly. As another example, the connector 560′ may alternatively comprise pins and the socket of the drive assembly may comprise openings for housing electrical conductors. Other variations are also possible. The mounting system 500′ may comprise the plug-in connector assembly 580.

As another example, the mounting system 500′ may be configured as a center mounting bracket (e.g., such as the center mounting bracket 202′ of the mounting system 200′ shown in FIGS. 7E-7H), as similarly described with respect to mounting system 500 with a respective connector 560′ (and respective wire 570′) located in one or both of the first and second attachment members.

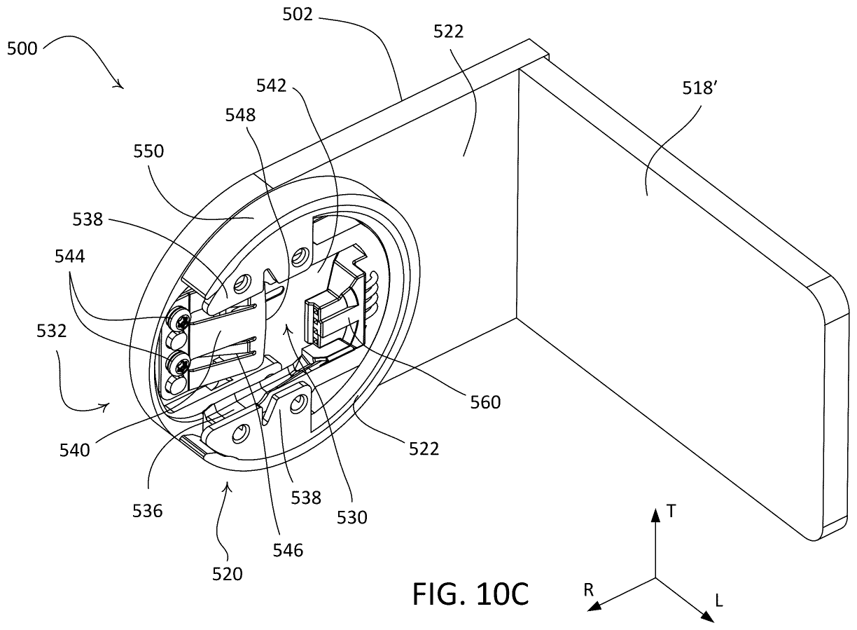

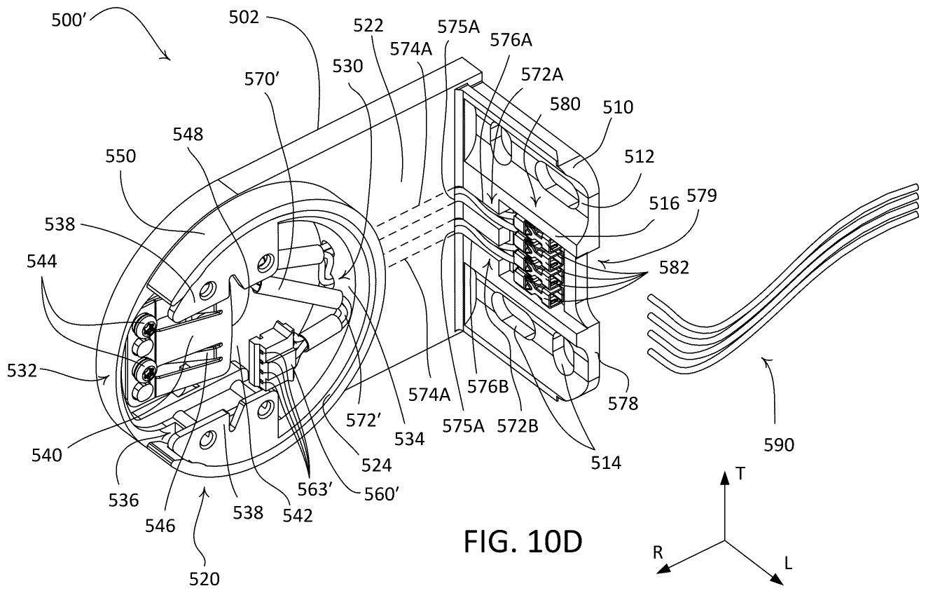

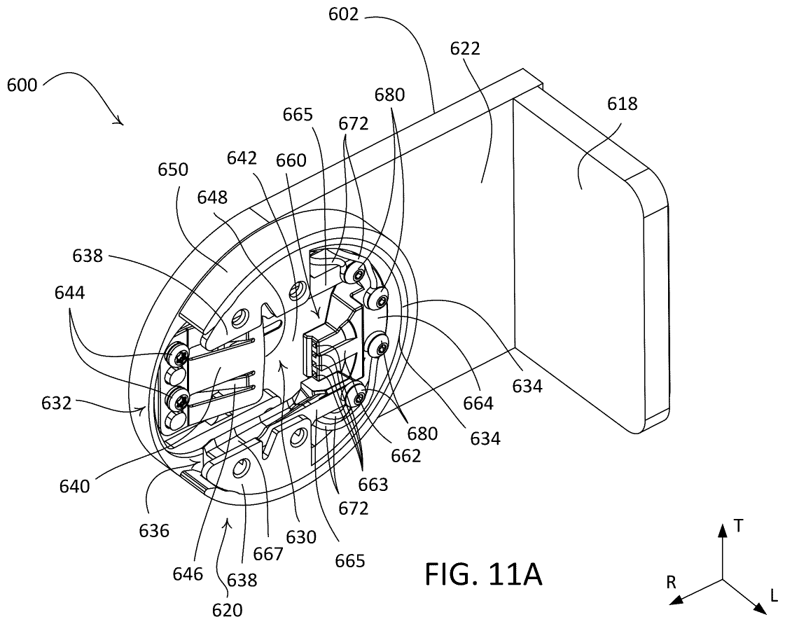

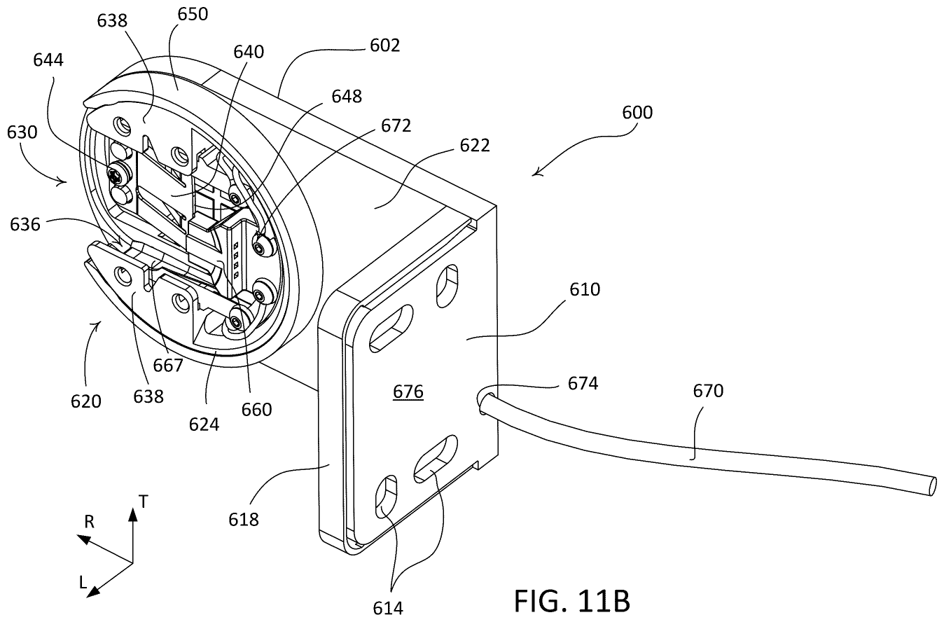

FIG. 11A is a front perspective view and FIG. 11B is a rear perspective view of an example mounting system 600 for mounting a roller tube assembly (e.g., roller tube assembly 111 of motorized window treatment 100 shown in FIGS. 1-5B). For example, the mounting system 600 may comprise a mounting bracket 602, which may be deployed as the first mounting bracket 141A of the motorized window treatment 100. The mounting bracket 602 may include a base 610 (e.g., a foot) and an attachment member 620 that may be connected to the base 610 via an arm 622. The base 610 that may be configured to attach the mounting bracket 602 to a structure (e.g., a window frame, a wall, a ceiling, or other structure as with the motorized window treatment 100 shown in FIG. 1). An arm 622 may extend substantially perpendicular from the base 610 to an attachment member 620. When the mounting bracket 602 is attached to a vertical structure (e.g., such as a wall), the arm 622 may extend horizontally (e.g., in the radial direction R) from the base 610 to the attachment member 620. When the mounting bracket 602 is attached to a horizontal structure (e.g., such as a ceiling), the arm 622 may extend vertically (e.g., in the transverse direction T) from the base 610 to the attachment member 620.

The base 610 may define depressions in a front surface of the base 610 (e.g., similar to the depressions 212, 312, 412, 512) that may have a reduced thickness when compared to a remainder of the base 610. The base 610 may include holes 614 therethrough. Each of the holes 614 may be configured to receive a fastener (not shown) for securing the mounting bracket 602 to the structure. The holes 614 may be located within the depressions 612, such that the fasteners may be countersunk with respect to a front surface of the base 610. Each of the holes 614 may be oblong shaped. For example, the holes 614 may be oblong shaped to allow for alignment of the mounting bracket 602 and/or alignment of the fasteners. The mounting system 600 may comprise a base cover 618 that may be configured to be detachably mounted over the base 610, e.g., for covering and/or concealing the base 610 and fasteners.

The attachment member 620 may include a drum 624 (e.g., a cylindrical drum). The drum 624 may extend in the longitudinal direction L. The drum 624 may be configured to receive an end portion of a roller tube assembly of a motorized window treatment (e.g., the end portion 114 of the roller tube assembly 111 of the motorized window treatment 100). For example, the drum 624 may define a channel 630 that may be configured receive (e.g., for sliding receipt of) the end portion of the roller tube assembly of the motorized window treatment (e.g., similar to the channel 138A of the first mounting bracket 141A). The channel 630 may define an opening 632 in the attachment member 620. The channel 630 may extend from the opening 632 to a rear wall 634. The channel 630 may define slots 636 (for example two slots) on either side of the channel 630. The slots 636 may be configured such that the channel 630 is T-shaped (e.g., has a T-shaped cross section). The slots 636 may be defined by respective flanges 638 of the drum 624 of the attachment member 620. The slots 636 may also be defined by a side wall 642 of the channel 630. The flanges 638 may be configured to retain the end portion of the roller tube assembly within the channel 630. The flanges 638 may be configured to secure the roller tube in the transverse direction T and/or longitudinal direction L.

The mounting bracket 602 may also comprise a spring 640, which may be secured to the attachment member 620, for example, in the channel 630. For example, the spring 640 may be secured to a side wall 642 of the channel 630. The spring 640 may be positioned at the opening 632 of the channel 630 and secured in the channel 630 using one or more fasteners 644. The spring 640 may include compliant fingers 646 that are configured to engage the side wall 642 of the channel 630 and bias a rear edge 648 of the spring 640 away from the side wall 642. For example, the rear edge 648 may be spaced away from the side wall 642. The compliant fingers 646 may be configured to flex as the end portion of the roller tube assembly is inserted into the channel 630. For example, the end portion of the roller tube assembly may apply a force on the spring 640 that pushes the rear edge 648 closer to the side wall 642. The spring 640 may be configured to engage the end portion of the roller tube assembly to secure the end portion within the channel 630 (e.g., the rear edge 648 of the spring may engage ridge 101 (see FIG. 5A) of the end portion 114). When the end portion is fully inserted into the channel 630, the compliant fingers 646 may enable the rear edge 648 to exert a force on the end portion of the roller tube assembly such that the end portion is retained within the channel 630. The rear edge 648 may exert the force on the end portion of the roller tube assembly in the radial direction R when the mounting bracket 602 is wall-mounted.

The mounting system 600 may include a sliding cover 650 that may be operated into a closed position and an open position (e.g., as with the sliding cover 136A of the motorized window treatment 100). For example, the sliding cover 650 is shown in the open position in FIG. 11A. The sliding cover 650 may be received by the drum 624 of the attachment member 620 of the mounting bracket 602 and may surround or partially surround the drum 624. The sliding cover 650 have a circular shape and may rotate around the drum 624/attachment member 620 between the open position and the closed position. When the sliding cover 650 is in the open position, the end portion of the roller tube assembly may be installed into the channel 630 of the attachment member 620. When the end portion of the roller tube assembly is fully installed in the channel 630, the sliding cover 650 may be rotated into the closed position in which the sliding cover 650 hides the end portion and the channel 630 from view. When the sliding cover 650 is in the closed position, the channel 630 and the end portion of the roller tube assembly are not accessible. When the sliding cover 650 is in the open position, the channel 630 and the end portion of the roller tube assembly may be exposed.

The mounting system 600 may comprise a connector 660 configured to provide electrical connection to the drive assembly of the motorized window treatment. The connector 660 may be received in the channel 630 of the attachment member 620 of the mounting bracket 602. For example, the connector 660 may be disposed within the channel 630. The connector 660 may be removably attached to the mounting bracket 602. The connector 660 may comprise a first connector portion, such as a plug portion 662 configured to be received in an opening of the drive assembly (e.g., the opening 116 of the drive assembly 160 shown in FIGS. 5A and 5B). The plug portion 662 of the connector 660 may be configured to be electrically connected to a connector located on the end portion of the roller tube assembly (e.g., such as end portion 114 shown in FIGS. 5A and 5B). The connector 660 (e.g., the plug portion 662) may be configured to engage with a socket of the drive assembly (e.g., the socket 166 of the drive assembly 160 shown in FIG. 5B). The plug portion 662 of the connector 660 may comprise one or more openings 663 for housing electrical conductors that may be electrically coupled to pins (e.g., the pins 168) of the socket. For example, the opening(s) 663 may be configured to receive the pins of the socket of the drive assembly when the end portion is received within the channel 630. As another example, the plug portion 662 may alternatively comprise pins and the socket of the drive assembly may comprise openings for housing electrical conductors. Other variations are also possible. The plug portion 626 may be chamfered at one end to allow easier insertion of the plug portion into a socket, for example (e.g., the socket 166 of the drive assembly 160).

The connector 660 may also comprise a second connector portion, such as a plurality of terminals 680 (e.g., four terminals) (e.g., such as screw terminals), configured to be electrically connected to a cable 670 having electrical connectors, such as wires 672. The cable 670 may extend from the channel 630 through a bore 674 (similar to bore 274 of FIG. 7A for example) in the arm 622 of the mounting bracket 602 and that may exit the mounting bracket 602 at a rear surface 676 of the mounting bracket 602 to be received in an electrical wallbox (e.g., such as the electrical wallbox 170) mounted to the structure behind the base 610, for example. The electrical conductors inside the openings 663 of the plug portion 662 may be electrically connected to the terminals 680 via internal electrical conductors for electrically coupling the drive assembly to a power source and/or a communication link. One will recognize that connector 660 may include more than or fewer than four screw terminals 680.

The connector 660 may have a similar structure and features as the connector 260 shown in FIGS. 7C and 7D for example for receiving the connector 660 into the channel 630. The connector 660 may comprise a base portion 664 configured to rest against the rear wall 634 of the channel 630, such that the plug portion 662 may extend towards the opening 632 of the channel 630. For example, the base portion 664 may abut the rear wall 634 of the channel 630 when the connector 660 is disposed within the channel 630. The base portion 664 may define a curved edge that corresponds with a shape of the rear wall 634 of the channel 630. The connector 660 may comprise a pair of arms 665 configured to be received in respective slots 636 of the channel 630 when the connector 660 is received in the channel 630. Each of the arms 665 may comprise a ridge (e.g., such as the ridge 266) and tab (e.g., such as the tab) configured to abut edges (e.g., such as the edges 239) of the slots 636 of the channel 630 when the connector 660 is received in the channel 630 to fix the connector 660 within the channel 630. The ridge and the tab may extend in the transverse direction. The tab may be located at a distal end of the arms 665. The ridge may be located at an intermediate (e.g., between the distal end and the base portion 664) location of the arms 665. Each of the arms 665 may define a groove 667 on the opposite side as the ridge and tab. Each groove 667 may be configured to receive a respective rail of the end portion of the roller tube assembly (e.g., such as the rails 113 of the end portion 114 of the roller tube assembly 111 shown in FIGS. 4, 5A, and 5B). As an alternative, mounting system 600 may include connector 660 but be configured similar to any of mounting system 300 (with cable 670 routed through a trench 376 and notch 379 in the base), mounting system 400 (with a terminal block 480), or mounting system 500 (with a plug-in connector assembly 580). Similarly, any of the center brackets described herein may be configured to include a first connector (similar to connector 660) located in a first attachment member and a second connector (similar to connector 660) located in a second attachment member.

It should be appreciated that the base 610 may be substantially the width of the arm 622 such that the base 610 does not extend beyond the arm 622. According to another example, a mounting system may be configured similar to mounting system 600 but not include a base.

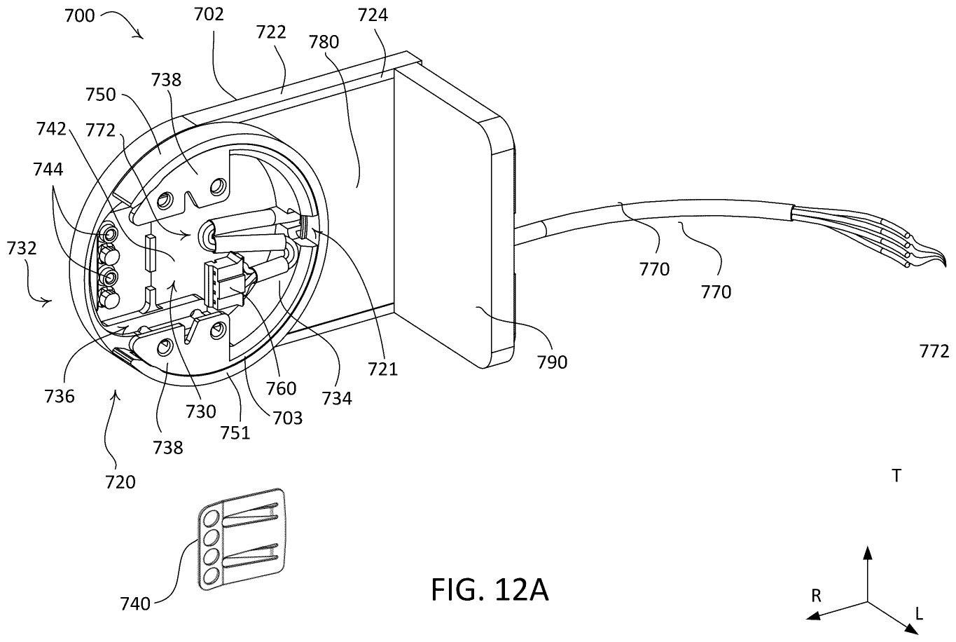

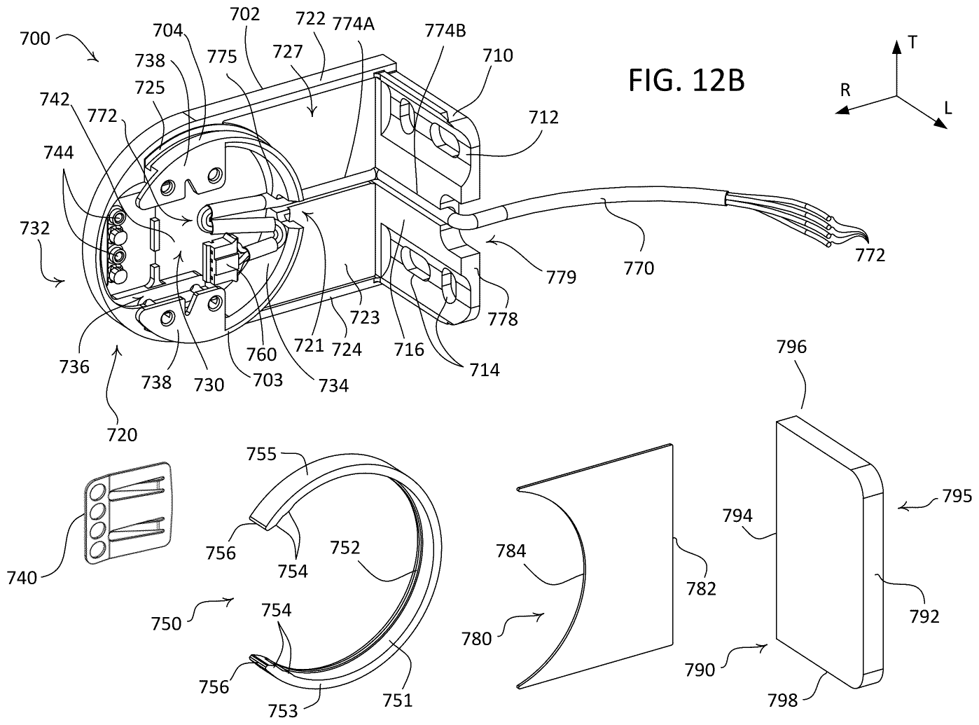

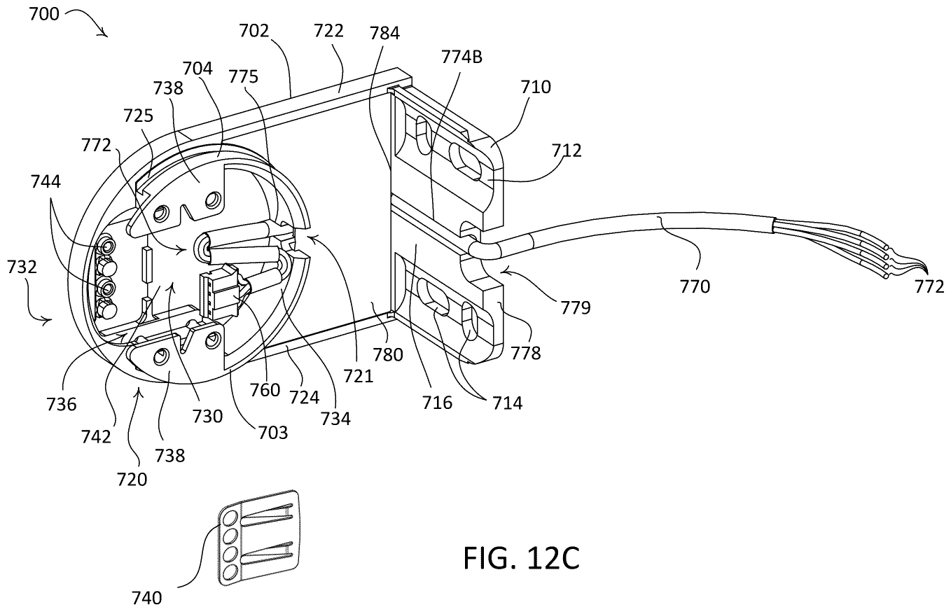

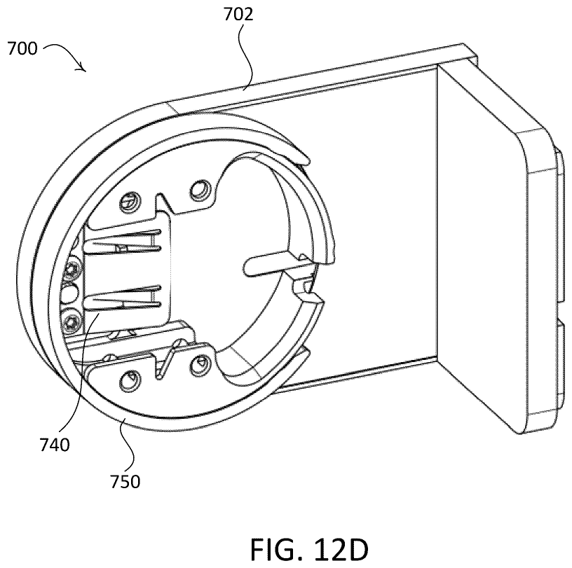

FIG. 12A is a front perspective view, FIG. 12B is a partially exploded view, FIG. 12C is another front perspective view, and FIG. 12D is a further front perspective view of an example mounting system 700 for mounting a roller tube assembly (e.g., roller tube assembly 111 of motorized window treatment 100 shown in FIGS. 1-5B). For example, the mounting system 700 may comprise a mounting bracket 702, which may be deployed as the first mounting bracket 141A of the motorized window treatment 100. The mounting bracket 702 may include a base 710 (e.g., a foot) and an attachment member 720 that may be connected to the base 710 via an arm 722. The base 710 may be configured to attach the mounting bracket 702 to a structure (e.g., a window frame, a wall, a ceiling, or other structure as with the motorized window treatment 100 shown in FIG. 1). The arm 722 may extend substantially perpendicular from the base 710 to the attachment member 720. When the mounting bracket 702 is attached to a vertical structure (e.g., such as a wall), the arm 722 may extend horizontally (e.g., in the radial direction R) from the base 710 to the attachment member 720. When the mounting bracket 702 is attached to a horizontal structure (e.g., such as a ceiling), the arm 722 may extend vertically (e.g., in the transverse direction T) from the base 710 to the attachment member 720.

The base 710 may define depressions 712 that may have a reduced thickness when compared to a remainder of the base 710. The base 710 may include holes 714 therethrough. Each of the holes 714 may be configured to receive a fastener (not shown) for securing the mounting bracket 702 to the structure. The holes 714 may be located within the depressions 712, such that the fasteners may be countersunk with respect to a front surface 716 of the base 710. Each of the holes 714 may be oblong shaped. For example, the holes 714 may be oblong shaped to allow for alignment of the mounting bracket 702 and/or alignment of the fasteners.

As shown in FIG. 12B, the attachment member 720 may include a drum 703 (e.g., a cylindrical drum). The drum 703 may extend in the longitudinal direction L. The drum 703 may be configured to receive an end portion of a roller tube assembly of a motorized window treatment (e.g., the end portion 114 of the roller tube assembly 111 of the motorized window treatment 100). For example, the drum 703 may define a channel 730 that may be configured receive (e.g., for sliding receipt of) the end portion of the roller tube assembly of the motorized window treatment (e.g., similar to the channel 138A of the first mounting bracket 141A). The channel 730 may define an opening 732 in the attachment member 720. The channel 730 may extend from the opening 732 to a rear wall 734. The channel 730 may define slots 736 (such as two slots) on either side of the channel 730. The slots 736 may be configured such that the channel 730 is T-shaped (e.g., has a T-shaped cross section). The slots 736 may be defined by respective flanges 738 of the drum 703 of the attachment member 720. The slots 736 may also be defined by a side wall 742 of the channel 730. The flanges 738 may be configured to retain the end portion of the roller tube assembly within the channel 730. The flanges 738 may be configured to secure the roller tube in the transverse direction T and/or longitudinal direction L. The mounting bracket 702 may also comprise a spring 740, which may be secured to the attachment member 720, for example, in the channel 730. For example, the spring 740 may be secured to a side wall 742 of the channel 730 using fasteners 744. FIGS. 12A-12C show spring 740 detached from the bracket. The spring may be secured to the attachment member 720 in the channel 730 (e.g., using one or more fasteners 744). FIG. 12D shows the spring 740 secured to the attachment member, here with sliding cover 750 in the closed position. The spring 740 of the mounting bracket 702 may operate in a similar manner as the springs 240, 340, 440, 540, 640 to retain the end portion of the roller tube assembly within the channel 730.

The mounting bracket 702 may define multiple trenches including, for example, a first trench 774A and a second trench 774B. Specifically, one or more trenches, such as first trench 774A, may be defined on the arm 722. For example, the first trench 774A may be recessed from an inside surface 723 of the arm 722. The first trench 774A may extend from the channel 730 to the base 710. For example, the arm 722 may include an opening 775 (e.g., a U-shaped opening) where the first trench 774A reaches the channel 730. The attachment member 720 may define a notch 721 in the drum 703 that is aligned with the opening 775. One or more trenches, such as second trench 774B, may be defined on the base 710. For example, the second trench 774B may be recessed from the front surface 716 of the base 710. The second trench 774B may extend from the arm 722 (e.g., from the first trench 774A in the arm 722) to an interior face 778 of the base 710. The first trench 774A and the second trench 774B may be configured to enable access within the mounting bracket 702 to install an electrical wiring (e.g., cable 770) within the mounting bracket 702 without drilling a bore through the mounting bracket 702 and routing wires therethrough. While the opening 775, notch 721, first trench 774A, and second trench 774B are shown centered on the bracket, they may be located off center.

The mounting system 700 may comprise a connector 760 configured to provide electrical connection to the drive assembly of the motorized window treatment. The connector 760 may be received in the channel 730 of the attachment member 720 of the mounting bracket 702. For example, the connector 760 may be configured to freely float in the channel 730. The connector 760 may be configured to be received in an opening of the drive assembly to engage with a socket of the drive assembly (e.g., the socket 166 of the drive assembly 160 shown in FIG. 5B) to be electrically connected to the socket of the drive assembly. The connector 760 may be provided at the end of a cable 770, which may have one or more electrical conductors, such as wires 772. For example, the cable 770 may have a flexible sleeve, which may be cut into segments to allow the cable 770 to be bent (e.g., easily bent) to fit within the channel 730 when the end portion of the drive assembly is fully inserted into the channel 730. The cable 770 may be received within the first trench 774A in the arm 722 of the mounting bracket 702. The cable 770 may extend into the channel 730 via the opening 775. The notch 721 may be aligned with the opening 775, for example, to enable installation and removal of the cable 770 into/from the first trench 774A and channel 730. The cable 770 may be received within the second trench 774B in the base 710 of the mounting bracket 702. The first trench 774A in the arm 722 may be aligned with the second trench 774B in the base 710. A depth of the first trench 774A and the second trench 774B may be configured such that the cable 770 is recessed within the first trench 774A and the second trench 774B. The first trench 774A and/or the second trench 774B may be sized and configured and the cable 770 selected such that the cable 770 remains in the first and second trenches 774A, 774B via a friction fit.

The mounting bracket 702 (e.g., the base 710) may define a notch 779 on an interior face 778 of the base 710. The interior face 778 may be distal from the arm 722. For example, the interior face 778 may face another mounting bracket (e.g., such as the mounting bracket 141B shown in FIG. 2) of the motorized window treatment. The interior face 778 may be parallel to the arm 722. The notch 779 may extend from the interior face 778 towards the arm 722. The notch 779 may be configured to receive the cable 770/wires 772. The notch 779 may be configured such that the cable 770/wires 772 enter the structure proximate to the notch 779 when the mounting bracket 702 is mounted to the structure. The second trench 774B may extend from the arm 722 towards the interior face 778 of the base 710, such that the cable 770 is received through the notch 779 in the base 710 and into an electrical wallbox (e.g., such as the electrical wallbox 170) mounted in the structure behind the base 710. For example, the second trench 774B may extend between the arm 722 and the notch 779.

According to other examples, the mounting system 700 (e.g., the base 710 of the mounting bracket 702) may include a second connector as similarly described herein (e.g., such as the terminal block 480 shown in FIGS. 9A-9B, and/or the plug-in connector assembly 580 shown in FIGS. 10A-10D) that is electrically connected to the connector 760 and is configured to electrically connect connector 760 to wires extending from the structure (e.g., such as the wires 490 shown in FIGS. 9A-9B and/or the wires 590 shown in FIGS. 10A-10D). The mounting bracket 702 in such configurations and as described herein may include multiple trenches in the base 710 (e.g., similar to trenches 576A, 576B), and/or multiple trenches in arm 722 (e.g., similar to bores 574A, 574B) to accommodate wiring/cables (and thus may further include multiple openings 775 and/or multiple notches 721 in the attachment member to match multiple trenches in the arm). In addition and/or as an alternative, the mounting system 700 may include a connector similar to any of connectors 260, 360, 460, 560, and 660 as described herein. As a still further alternative and/or addition, bracket 702 may include trench 774A and further include an opening in base 710 where trench 774A meets the base 710 for passage of cable 770 therethrough (e.g., rather than using trench 774B and notch 779) (i.e., similar to that shown in FIG. 7B where wire 270 extends from the rear surface 276 of the base 210). Other variations are possible.

The mounting system 700 may include a sliding cover 750. The sliding cover 750 is in an open position in FIG. 12A and in a closed position in FIG. 12D. The sliding cover 750 may be received by the attachment member 720 of the mounting bracket 702. The sliding cover 750 may have a circular shape or a substantially circular shape. The sliding cover 750 may be rotatably received by the drum 703 of the attachment member 720 and may surround or partially surround the drum 703. The sliding cover 750 may be configured to cover the channel 730 when the end portion of the roller tube assembly is fully received within the channel 730. For example, the sliding cover 750 may be operable between a closed position (e.g., as shown in FIG. 3A for motorized window treatment 100) and an open position (e.g., as shown in FIG. 3B for the motorized window treatment 100). The sliding cover 750 may rotate in a plane defined by the transverse direction T and the radial direction R between the closed position and the open position. When the sliding cover 750 is in the open position, the end portion of the roller tube assembly may be installed into the channel 730 of the attachment member 720. When the end portion of the roller tube assembly is fully installed in the channel 730, the sliding cover 750 may be rotated into the closed position in which the sliding cover 750 hides the end portion of the roller tube assembly and the channel 730 from view.

The sliding cover 750 may be rotatably received by the attachment member 720. As shown in FIG. 12B, the drum 703/attachment member 720 may define a slot 725. The slot 725 may extend around an outer surface 704 of the drum 703/attachment member 720. For example, the slot 725 may extend circumferentially about the drum 703/attachment member 720 (e.g., the outer surface 704). The sliding cover 750 may define a rib 752 extending from an inner surface 751 of the sliding cover 750. The rib 752 may extend circumferentially about the inner surface 751 of the sliding cover 750. The rib 752 may be configured to be received within the slot 725, for example, when the inner surface 751 of the sliding cover is proximate to the outer surface 704 of the drum 703/attachment member 720. The rib 752 and the slot 725 may be configured to guide the sliding cover 750 as it operates between the open position and the closed position. For example, the rib 752 and the slot 725 may be configured to operably couple the sliding cover 750 to the drum 703/attachment member 720. The sliding cover 750 may define a side surface 753 and an outer surface 755. The side surface 753 may be configured to be proximate to the roller tube assembly when the roller tube assembly is received within the channel 730 of the mounting bracket 702. The outer surface 755 may be configured to be exposed when the roller tube assembly is received within the channel 730 of the mounting bracket 702.

It should be appreciated that the although the sliding cover 750 is shown as a circular shape, the sliding cover 750 may alternatively be straight and may be configured to slide linearly (e.g., up or down) to move between the closed position and the open position (e.g., to slide out of the way of the channel 730).

The sliding cover 750 may define one or more protrusions 754 (e.g., barbs) that may extend from the inner surface 751 of the sliding cover 750. The protrusions 754 may be located proximate to end portions 756 of the sliding cover. The protrusions 754 may be configured to secure the sliding cover 750 in the closed position and/or the open position. For example, the protrusions 754 may be configured to engage complementary features in the drum 703/attachment member 720 (e.g., the outer surface 704). For example, the outer surface 704 of the drum 703/attachment member 720 may define one or more notches or detents (not shown). The one or more notches or detents may be located proximate to the slot 725. One will appreciate that each of the sliding covers and respective drums/attachment members described herein for the various mounting systems (e.g., mounting systems 200, 200′, 300, 300′, 400, 400′, 500, 500′, and 600) may have a similar structure/configuration as sliding cover 750 and drum 703/attachment member 720.

The mounting system 700 may include one or more bracket covers, such as an arm cover 780 and a base cover 790. For example, the arm cover 780 may be configured to be detachably attached to the arm 722 of the mounting bracket 702. The base cover 790 may be configured to be detachably mounted over the base 710 of the mounting bracket 702. The arm cover 780 may be configured to conceal or cover at least a portion of the arm 722. For example, the arm cover 780 may be configured to conceal or cover the first trench 774A (e.g., and a portion of the cable 770). The base cover 790 may be configured to conceal or cover at least a portion of the base 710 and fasteners. For example, the base cover 790 may be configured to conceal the second trench 774B (e.g., and a portion of the cable 770) and the notch 779. The base cover 790 may define a cavity 795 that is configured to receive the base 710. The cavity 795 may be defined by a top wall 796, a bottom wall 798, a side wall 792, and an edge 794.

The mounting bracket 702 (e.g., the arm 722) may define a recess 727 that is configured to receive the arm cover 780. The recess 727 may be defined by an inner surface 723 that extends between a rim 724 defined on opposing upper and lower edges of the arm 722. The recess 727 may be bounded by the drum 703/attachment member 720, the rim 724, and the base 710. The rim 724 may extend between the base 710 and the drum 703/attachment member 720. The rim 724 may be unfinished. The rim 724 may define a thickness in the transverse direction T that is substantially equal to the width (e.g., length in the transverse direction T) of the outer surface 755 of the sliding cover 750. One will appreciate that the height of arm cover 780 may be made smaller, for example, and the rim 724 made proportionally larger, for example.

The arm cover 780 may be detachably retained within the recess 727 by the base cover 790, the sliding cover 750, and the rim 724. The sliding cover 750 may be configured to prevent a curved edge 784 of the arm cover 780 from being removed from the recess 727 once the sliding cover is installed. For example, the sliding cover 750 may abut or over-lay a portion of the arm cover 780 that is proximate to the curved edge 784. The base cover 790 may be configured to prevent a straight edge 782 of the arm cover 780 from being removed from the recess 727 once the base cover is installed by over-laying a portion of the arm cover 780. For example, the base cover 790 (e.g., edge 794) may abut or over-lay a portion of the arm cover 780 that is proximate to the straight edge 782. The arm cover 780 may be installed within the recess 727 prior to the sliding cover 750 being attached to the attachment member 720 and prior to the base cover 790 being mounted over the base 710. The arm cover may also be retained in the recess 727 by rim 724 via a friction fit, for example. An adhesive, such as tape, may also be used. When the arm cover 780 is received within the recess 727, the arm cover 780 (e.g., a front surface of the arm cover 780) may be substantially flush with the rim 724. The arm cover 780 and/or base cover 790 may be used when no cable 770 is being used with the mounting bracket 702, such as when an idler of a roller tube assembly is connected to the bracket.

According to another example, any of the center brackets described herein may be configured similar to mounting system 700 as described above, and in particular, may be configured, for example, to include trenches and notches and openings and a recess (similar to trenches 774A, 774B, and notch 721, and opening 775, and recess 727) on each opposing side of the arm and on each of the first and second portions of the base, and configured to receive respective first and second arm covers (e.g., similar to arm cover 780) on each opposing side of the arm and to receive respective first and second base covers (e.g., similar to base cover 790) on each of the first and second portions of the base. It should be appreciated that the base 710 may be substantially the width of the arm 722 such that the base 710 does not extend beyond the arm 722. According to another example, a mounting system may be configured similar to mounting system 700 but not include a base.

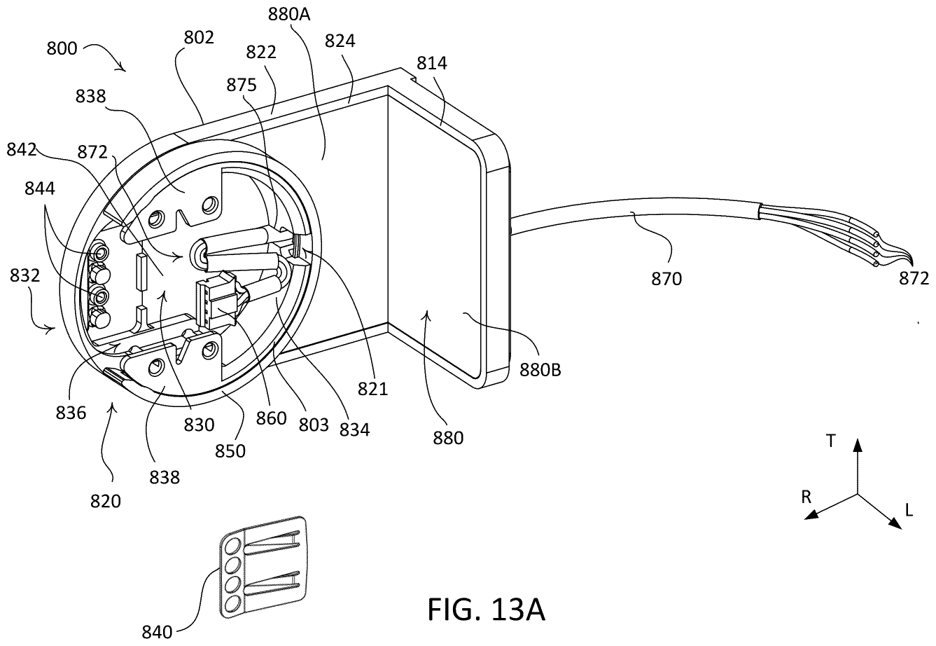

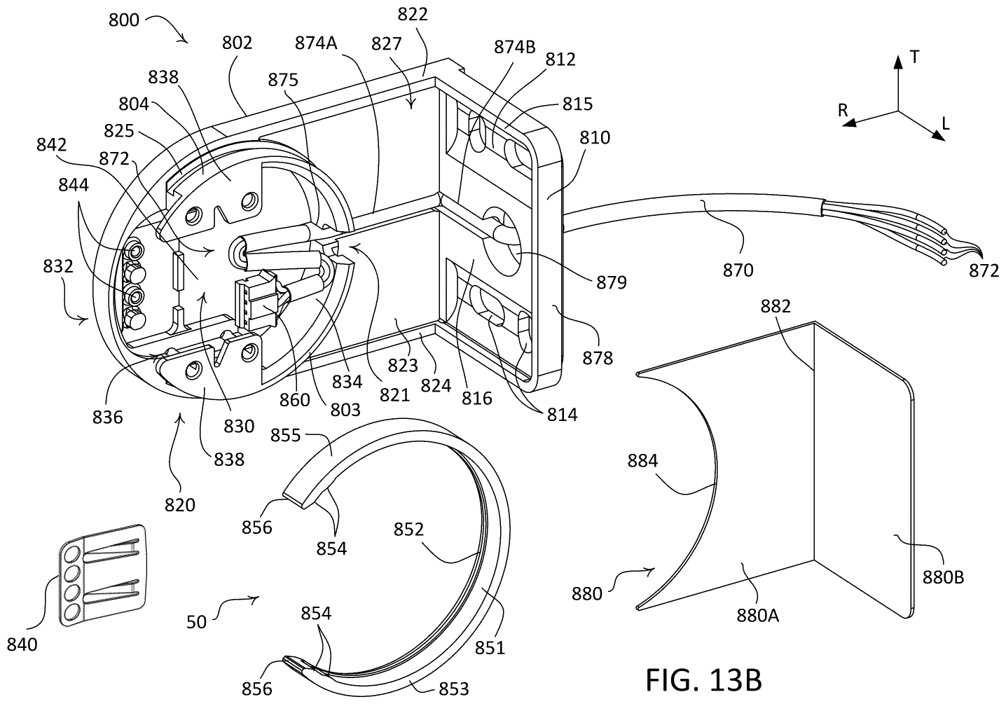

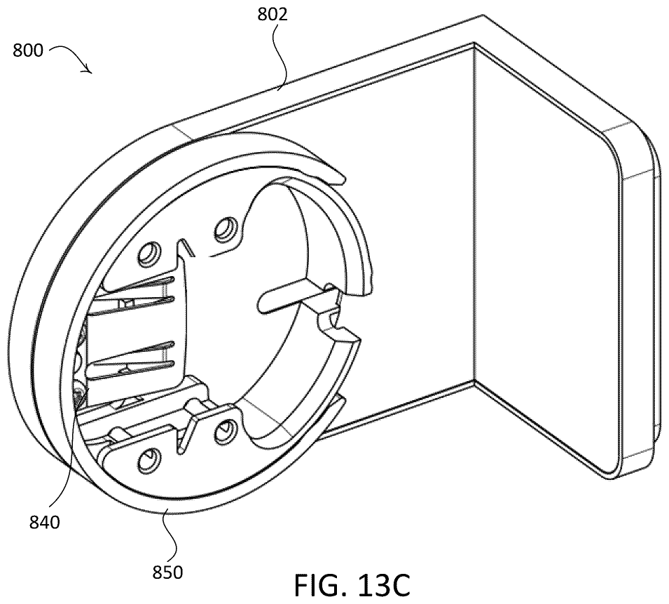

FIG. 13A is a front perspective view, FIG. 13B is a partially exploded view, and FIG. 13C is another front perspective view of an example mounting system 800 for mounting a roller tube assembly (e.g., roller tube assembly 111 of motorized window treatment 100 shown in FIGS. 1-5B). For example, the mounting system 800 may comprise a mounting bracket 802 that may be deployed as the first mounting bracket 141A of the motorized window treatment 100. The mounting bracket 802 may include a base 810 (e.g., a foot) and an attachment member 820 that may be connected to the base 810 via an arm 822. The base 810 may be configured to attach the mounting bracket 802 to a structure (e.g., a window frame, a wall, a ceiling, or other structure as with the motorized window treatment 100 shown in FIG. 1). The arm 822 may extend substantially perpendicular from the base 810 to the attachment member 820. When the mounting bracket 802 is attached to a vertical structure (e.g., such as a wall), the arm 822 may extend horizontally (e.g., in the radial direction R) from the base 810 to the attachment member 820. When the mounting bracket 802 is attached to a horizontal structure (e.g., such as a ceiling), the arm 822 may extend vertically (e.g., in the transverse direction T) from the base 810 to the attachment member 820.

The base 810 may define depressions 812 that may have a reduced thickness when compared to a remainder of the base 810. The base 810 may include holes 814 therethrough. Each of the holes 814 may be configured to receive a fastener (not shown) for securing the mounting bracket 802 to the structure. The holes 814 may be located within the depressions 812, such that the fasteners may be countersunk with respect to a front surface 816 of the base 810. Each of the holes 814 may be oblong shaped. For example, the holes 814 may be oblong shaped to allow for alignment of the mounting bracket 802 and/or alignment of the fasteners.

As shown in FIG. 13B, the attachment member 820 may include a drum 803 (e.g., a cylindrical drum). The drum 803 may extend in the longitudinal direction L. The drum 803 may be configured to receive an end portion of a roller tube assembly of a motorized window treatment (e.g., the end portion 114 of the roller tube assembly 111 of the motorized window treatment 100). For example, the drum 803 may define a channel 830 that may be configured receive (e.g., for sliding receipt of) the end portion of the roller tube assembly of the motorized window treatment (e.g., similar to the channel 138A of the first mounting bracket 141A). The channel 830 may define an opening 832 in the attachment member 820. The channel 830 may extend from the opening 832 to a rear wall 834. The channel 830 may define slots 836 (such as two slots) on either side of the channel 830. The slots 836 may be configured such that the channel 830 is T-shaped (e.g., has a T-shaped cross section). The slots 836 may be defined by respective flanges 838 of the drum 803 of the attachment member 820. The slots 836 may also be defined by a side wall 842 of the channel 830. The flanges 838 may be configured to retain the end portion of the roller tube assembly within the channel 830. The flanges 838 may be configured to secure the roller tube in the transverse direction T and/or longitudinal direction L. The mounting bracket 802 may also comprise a spring 840, which may be secured to the attachment member 820, for example, in the channel 830. For example, the spring 840 may be secured to a side wall 842 of the channel 830 using fasteners 844. FIGS. 13A-13BC show spring 840 detached from the bracket. The spring may be secured to the attachment member 820 in the channel 830 (e.g., using one or more fasteners 844). FIG. 13C shows the spring 840 secured to the attachment member, here with sliding cover 850 in the closed position. The spring 840 of the mounting bracket 802 may operate in a similar manner as the springs 240, 340, 440, 540, 640 to retain the end portion of the roller tube assembly within the channel 830.

The mounting bracket 802 may define multiple trenches including, for example, a first trench 874A and a second trench 874B. The first trench 874A may be defined on the arm 822. Specifically, one or more trenches, such as first trench 874A, may be recessed from an inside surface 823 of the arm 822. The first trench 874A may extend from the channel 830 to the base 810. For example, the arm 822 may include an opening 875 (e.g., a U-shaped opening) where the first trench 874A reaches the channel 830. The attachment member 820 may define a notch 821 in the drum 803 that is aligned with the opening 875. One or more trenches, such as second trench 874B, may be defined in the base 810. For example, the second trench 874B may be recessed from the front surface 816 of the base 810. The first trench 874A and the second trench 874B may be configured to enable access within the mounting bracket 802 to install electrical wiring (e.g., cable 870) within the mounting bracket 802 without drilling a bore through the mounting bracket 802 and routing wires therethrough. While the opening 875, notch 821, first trench 874A, and second trench 874B are shown centered on the bracket, they may be located off center.

The mounting system 800 may comprise a connector 860 configured to provide electrical connection to the drive assembly of the motorized window treatment. The connector 860 may be received in the channel 830 of the attachment member 820 of the mounting bracket 802. For example, the connector 860 may be configured to freely float within the channel 830. The connector 860 may be configured to be received in an opening of the drive assembly to engage with a socket of the drive assembly (e.g., the socket 166 of the drive assembly 160 shown in FIG. 5B) to be electrically connected to the socket of the drive assembly. The connector 860 may be provided at the end of a cable 870, which may have one or more electrical conductors, such as wires 872. For example, the cable 870 may have a flexible sleeve, which may be cut into segments to allow the cable 870 to be bent (e.g., easily bent) to fit within the channel 830 when the end portion of the drive assembly is fully inserted into the channel 830. The cable 870 may be received within the first trench 874A in the arm 822 of the mounting bracket 802. The cable 870 may extend into the channel 830 via the opening 875. The notch 821 may be aligned with the opening 875, for example, to enable installation and removal of the cable 870 into/from the first trench 874A and channel 830. The cable 870 may be received within the second trench 874B in the base 810 of the mounting bracket 802. The first trench 874A in the arm 822 may be aligned with the second trench 874B in the base 810. A depth of the first trench 874A and the second trench 874B may be configured such that the cable 870 is recessed within the first trench 874A and the second trench 874B. The first trench 874A and/or the second trench 874B may be sized and configured and the cable 870 selected such that the cable 870 remains in the first and second trenches 874A, 874B via a friction fit.

The mounting bracket 802 (e.g., the base 810) may define an opening 879 that is configured to receive the cable 870. The opening 879 may be configured such that the cable 870 enters the structure proximate to the opening 879 when the mounting bracket 802 is mounted to the structure. The second trench 874B may extend from the arm 822 towards an interior face 878 of the base 810, for example, to the opening 879. The cable 870 may be extended through the opening 879 in the base 810 and into an electrical wallbox (e.g., such as the electrical wallbox 170) mounted in the structure behind the base 810, for example. For example, the second trench 874B may extend between the arm 822 and the opening 879.

According to other examples, the mounting system 800 (e.g., the base 810 of the mounting bracket 802) may include a second connector as similarly described herein (e.g., such as the terminal block 480 shown in FIGS. 9A-9B, and/or the plug-in connector assembly 580 shown in FIGS. 10A-10D) that is electrically connected to connector 860 and is configured to electrically connect connector 860 to wires extending from the structure (e.g., such as the wires 490 shown in FIGS. 9A-9B and/or the wires 590 shown in FIGS. 10A-10D). The mounting bracket 802 in such configurations and as described herein may include multiple trenches in the base 810 (e.g., similar to trenches 576A, 576B), and/or multiple trenches in arm 822 (e.g., similar to bores 574A, 574B) to accommodate wiring/cables (and thus may further include multiple openings 875 and/or multiple notches 821 in the attachment member to match multiple trenches in the arm). In addition and/or as an alternative, the mounting system 800 may include a connector similar to any of connectors 260, 360, 460, 560, and 660 as described herein. As a still further alternative and/or addition, bracket 802 may include trench 874A and further include an opening in base 810 where the trench 874A meets the base 810 for passage of cable 870 therethrough (e.g., rather than using opening 879) (i.e., similar to that shown in FIG. 7B where wire 270 extends from the rear surface 276 of the base 210). Other variations are possible.

The mounting system 800 may include a sliding cover 850. The sliding cover 850 is shown in an open position in FIG. 13A and in a closed position in FIG. 13C. The sliding cover 850 may be received by the attachment member 820 of the mounting bracket 802. The sliding cover 850 may have a circular shape or a substantially circular shape. The sliding cover 850 may be rotatably received by the drum 803 of the attachment member 820 and may surround or partially surround the drum 803. As shown in FIG. 13B, the attachment member 820 may define a channel 830 that is configured to receive an end portion of the roller tube assembly. The channel 830 may be configured for sliding receipt of the end portion of the roller tube assembly. The sliding cover 850 may be configured to cover the channel 830 when the end portion of the roller tube assembly is fully received within the channel 830. For example, the sliding cover 850 may be operable between a closed position (e.g., as shown in FIG. 3A for motorized window treatment 100) and an open position (e.g., as shown in FIG. 3B for the motorized window treatment 100). The sliding cover 850 may rotate in a plane defined by the transverse direction T and the radial direction R between the closed position and the open position. When the sliding cover 850 is in the open position, the end portion of the roller tube assembly may be installed into the channel 830 of the attachment member 820. When the end portion of the roller tube assembly is fully installed in the channel 830, the sliding cover 850 may be rotated into the closed position in which the sliding cover 850 hides the end portion of the roller tube assembly and the channel 830 from view.

The sliding cover 850 may be rotatably received by the attachment member 820. As shown in FIG. 13B, the drum 803/attachment member 820 may define a slot 825. The slot 825 may extend around an outer surface 804 of the drum 803/attachment member 820. For example, the slot 825 may extend circumferentially about the drum 803/attachment member 820 (e.g., the outer surface 804). The sliding cover 850 may define a rib 852 extending from an inner surface 851 of the sliding cover 850. The rib 852 may extend circumferentially about the inner surface 851 of the sliding cover 850. The rib 852 may be configured to be received within the slot 825, for example, when the inner surface 851 of the sliding cover is proximate to the outer surface 804 of the drum 803/attachment member 820. The rib 852 and the slot 825 may be configured to guide the sliding cover 850 as it operates between the open position and the closed position. For example, the rib 852 and the slot 825 may be configured to operably couple the sliding cover 850 to the drum 803/attachment member 820. The sliding cover 850 may define a side surface 853 and an outer surface 855. The side surface 853 may be configured to be proximate to the roller tube assembly when the roller tube assembly is received within the channel 830 of the mounting bracket 802. The outer surface 855 may be configured to be exposed when the roller tube assembly is received within the channel 830 of the mounting bracket 802.

It should be appreciated that the although the sliding cover 850 is shown as a circular shape, the sliding cover 850 may alternatively be straight and may be configured to slide linearly (e.g., up or down) to move between the closed position and the open position (e.g., to slide out of the way of the channel 830).

The sliding cover 850 may define one or more protrusions 854 (e.g., barbs) that may extend from the inner surface 851 of the sliding cover 850. The protrusions 854 may be located proximate to end portions 856 of the sliding cover. The protrusions 854 may be configured to secure the sliding cover 850 in the closed position and/or the open position. For example, the protrusions 854 may be configured to engage complementary features in the drum 803/attachment member 820 (e.g., the outer surface 804). For example, the outer surface 804 of the drum 803/attachment member 820 may define one or more notches or detents (not shown). The one or more notches or detents may be located proximate to the slot 825.

The mounting system 800 may include a detachable bracket cover 880. The bracket cover 880 may be configured to be detachably attached to the arm 822 and/or the base 810 of the mounting bracket 802. The bracket cover 880 may be configured to conceal at least a portion of the arm 822 and at least a portion of the base 810. The bracket cover 880 may define an L-shaped cross-section. For example, the bracket cover 880 may include an arm portion 880A and a base portion 880B. The arm portion 880A may be configured to conceal or cover the first trench 874A (e.g., and a portion of the cable 870). The base portion 880B may be configured to conceal or cover the second trench 874B (e.g., and a portion of the cable 870) and the opening 879. The base portion 880B may extend substantially perpendicular to the arm portion 880A.

The mounting bracket 802 (e.g., the arm 822 and the base 810) may define a recess 827 (e.g., a L-shaped recess) that is configured to receive the bracket cover 880. The recess 827 may be defined by an inner surface 823 of the arm 822 and an inner surface 816 of the base 810. The inner surface 823 of the arm 822 may extend between a rim 824 defined on opposing upper and lower edges of the arm 822. The inner surface 816 of the base 810 may extend between a rim 815 (e.g., a U shaped rim) defined on upper and lower edges of the base 810 and on the edge of surface 878 of the base. The recess 827 may be bounded by the drum 803/attachment member 820, the rim 824, and the rim 815. The rim 824 may extend between the base 810 and the attachment member 820. The rim 815 may extend between surface 878 of the base 810 and the arm 822. The rim 824 may be unfinished. The rim 815 may extend from the arm 822, around the surface 878 that is distal from and parallel to the arm, and back to the arm 822. The rim 815 may be aligned in the transverse direction with the rim 824. The rim 815 may be unfinished. The rim 815 and the rim 824 may have the same thickness in the transverse direction T that is substantially equal to the width (e.g., length in the transverse direction T and longitudinal direction L) of the outer surface 855 of the sliding cover 850. One will appreciate that the height of the bracket cover 880 (i.e., the height of arm portion 880A and base portion 880B) may be made smaller, for example, and the rims 824, 815 made proportionally larger, for example.

The bracket cover 880 may be detachably retained within the recess 827. The sliding cover 850 may be configured to prevent a curved edge 884 of the bracket cover 880 from being removed from the recess 827 once the sliding cover is installed. For example, the sliding cover 850 may abut or over-lay a portion of the bracket cover 880 that is proximate to the curved edge 884. The bracket cover 880 may also be retained within the recess 827 by rims 815 and 824 via a friction fit, for example. An adhesive, such as tape, may also be used. When the bracket cover 880 is received within the recess 827, the bracket cover 880 (e.g., a front surface of the bracket cover 880) may be substantially flush with the rim 815 and the rim 824. The bracket cover 880 may be used when no cable 870 is being used with the mounting bracket 802, such as when an idler of a roller tube assembly is connected to the mounting bracket 802.

According to another example, any of the center brackets described herein may be configured similar to mounting system 800 as described above, and in particular, may be configured, for example, to include trenches and notches and openings and a recess (similar to trenches 874A, 874B, and notch 821, and opening 875, and recess 827) on each opposing side of the arm and on each of the first and second portions of the base, and configured to receive respective bracket covers (e.g., similar to bracket cover 880) on each opposing side of the arm.

It should be appreciated that the base 810 may be substantially the width of the arm 822 such that the base 810 does not extend beyond the arm 822. According to another example, a mounting system may be configured similar to mounting system 800 but not include a base.

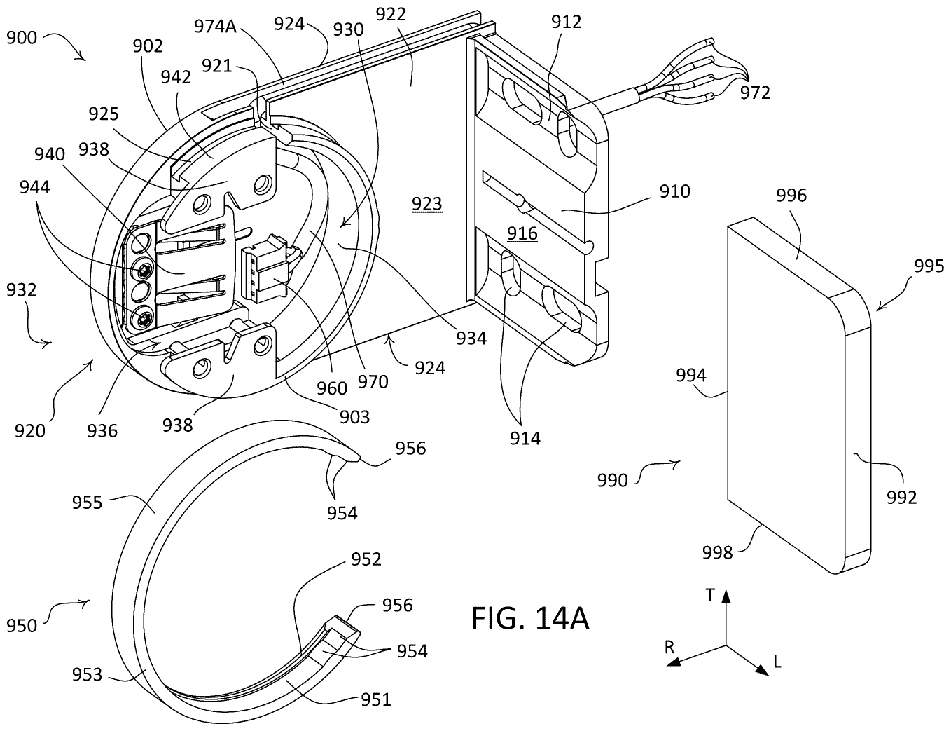

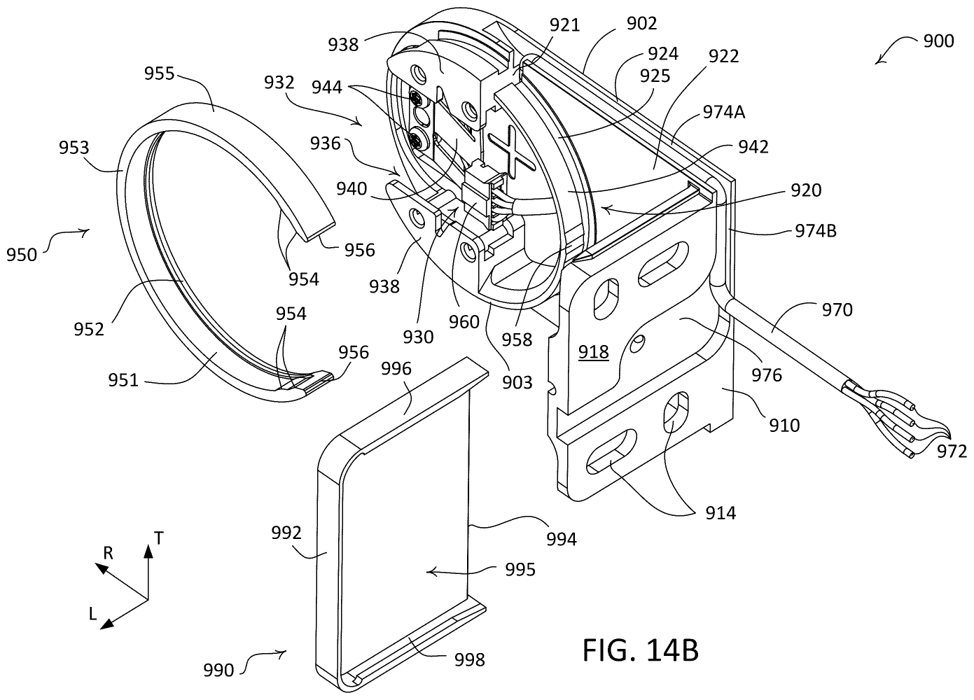

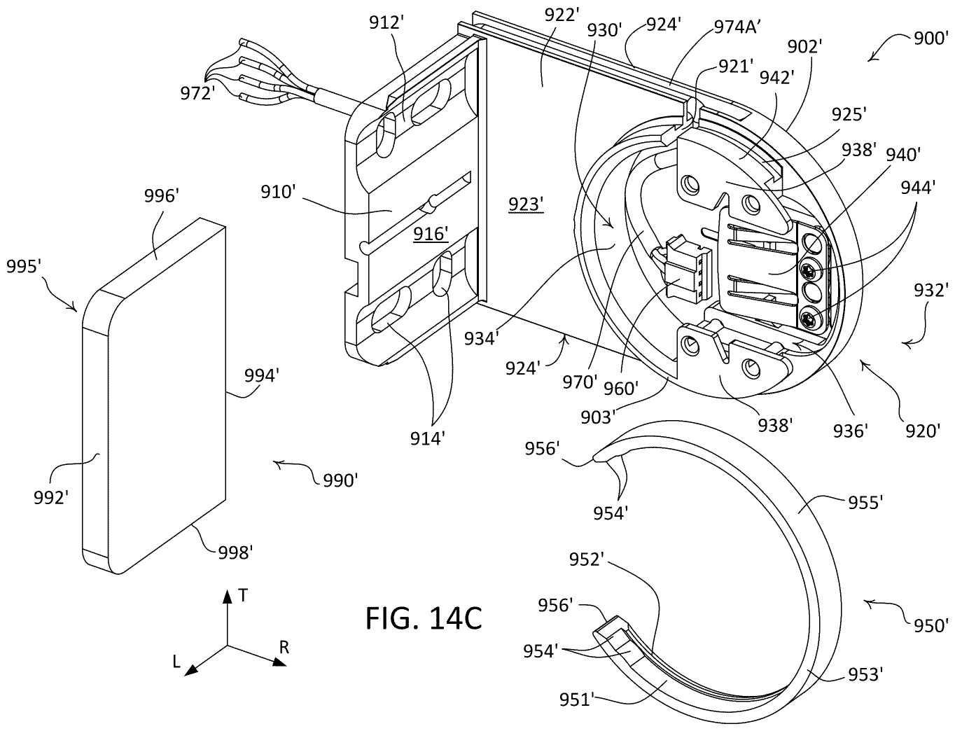

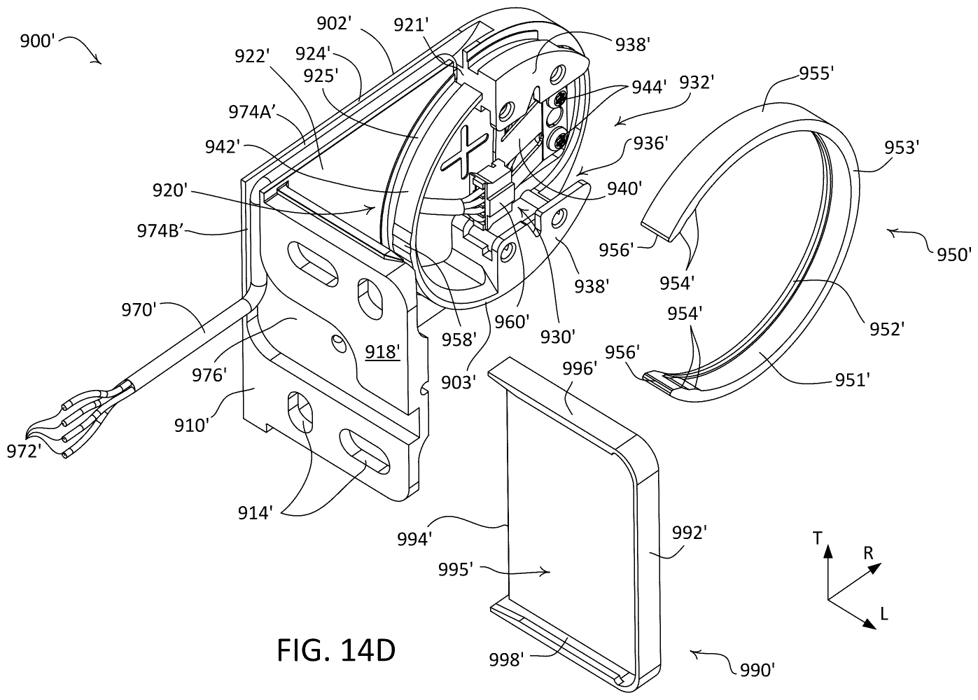

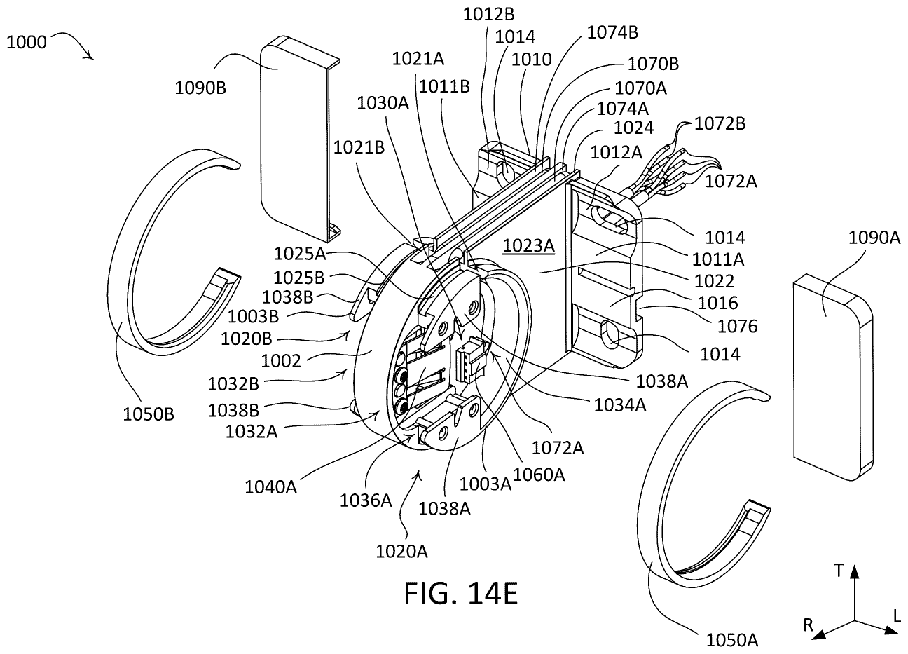

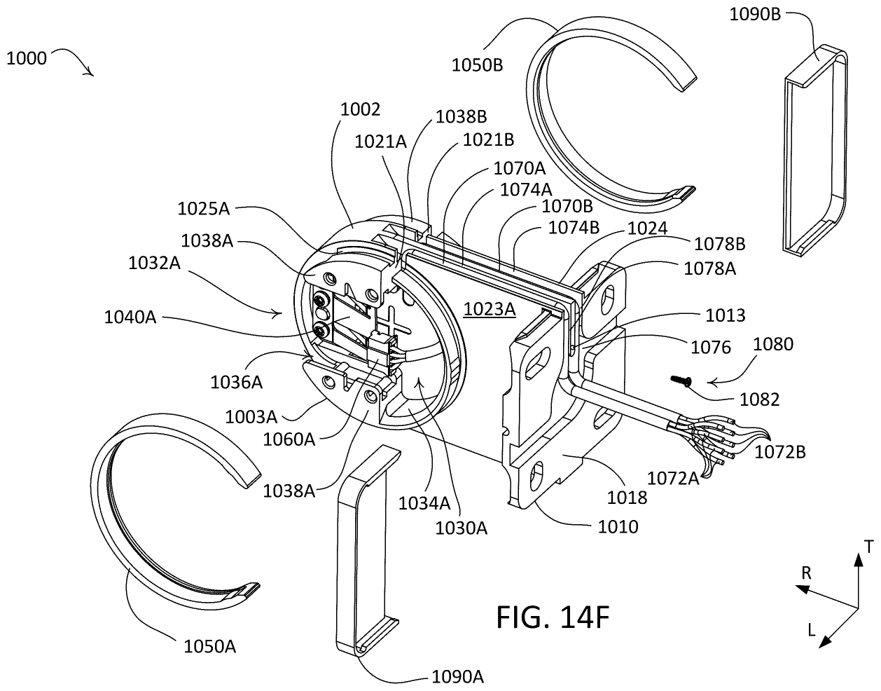

FIGS. 14A-14B depict an example mounting system 900 for mounting a roller tube assembly (e.g., roller tube assembly 111 of motorized window treatment 100 shown in FIGS. 1-5B). FIG. 14A is a partially exploded front perspective view and FIG. 14B is a partially exploded rear perspective view of a mounting bracket 902 of the example mounting system 900. For example, the mounting bracket 902 may be deployed as the first mounting bracket 141A of the motorized window treatment 100 (e.g., the left side of the motorized window treatment) The mounting bracket 902 may include a base 910 (e.g., a foot) and an attachment member 920 that may be connected to the base 910 via an arm 922. The base 910 may be configured to attach the mounting bracket 902 to a structure (e.g., a window frame, a wall, a ceiling, or other structure as with the motorized window treatment 100 shown in FIG. 1). The arm 922 may extend substantially perpendicular from the base 910 to the attachment member 920. When the mounting bracket 902 is attached to a vertical structure (e.g., such as a wall), the arm 922 may extend horizontally (e.g., in the radial direction R) from the base 910 to the attachment member 920. When the mounting bracket 902 is attached to a horizontal structure (e.g., such as a ceiling), the arm 922 may extend vertically (e.g., in the transverse direction T) from the base 910 to the attachment member 920. The arm 922 may comprise an inside surface 923 (that may be perpendicular to a front surface 916 of the base 910) and opposing top and bottom edge surfaces 924 that may each be perpendicular to inside surface 923. For example, the edge surfaces 924 may be located on top and bottom sides of the mounting bracket 902 when the mounting bracket 902 is attached to a vertical structure.

The base 910 may define depressions 912 that may have a reduced thickness when compared to a remainder of the base 910. The base 910 may include holes 914 therethrough. Each of the holes 914 may be configured to receive a fastener (not shown) for securing the mounting bracket 902 to the structure. The holes 914 may be located within the depressions 912, such that the fasteners may be countersunk with respect to a front surface 916 of the base 910. Each of the holes 914 may be oblong shaped. For example, the holes 914 may be oblong shaped to allow for alignment of the mounting bracket 902 and/or alignment of the fasteners.

As shown in FIG. 14A, the attachment member 920 may include a drum 903 (e.g., a cylindrical drum). The drum 903 may extend in the longitudinal direction L. The drum 903 may be configured to receive an end portion of a roller tube assembly of a motorized window treatment (e.g., the end portion 114 of the roller tube assembly 111 of the motorized window treatment 100). For example, the drum 903 may define a channel 930 that may be configured receive (e.g., for sliding receipt of) the end portion of the roller tube assembly of the motorized window treatment (e.g., similar to the channel 138A of the first mounting bracket 141A). The channel 930 may define an opening 932 in the attachment member 920. The channel 930 may extend from the opening 932 to a rear wall 934. The channel 930 may define slots 936 (such as two slots) on either side of the channel 930. The slots 936 may be configured such that the channel 930 is T-shaped (e.g., has a T-shaped cross section). The slots 936 may be defined by respective flanges 938 of the drum 903 of the attachment member 920. The slots 936 may also be defined by a side wall 942 of the channel 930. The flanges 938 may be configured to retain the end portion of the roller tube assembly within the channel 930. The flanges 938 may be configured to secure the roller tube in the transverse direction T and/or longitudinal direction L. The attachment member 920 of the mounting bracket 902 may also comprise a spring 940, which may be secured to the attachment member 920 in the channel 930 (e.g., using one or more fasteners 944). The spring 940 of the mounting bracket 902 may have a similar structure to the springs 240, 340, 440, 540, 640 and may operate in a similar manner as the springs 240, 340, 440, 540, 640 to retain the end portion of the roller tube assembly within the channel 930.

The mounting bracket 902 may define multiple trenches including, for example, a first trench 974A and a second trench 974B. The first trench 974A may be defined on the arm 922. For example, the first trench 974A may be formed in/defined by one (or both) of the edge surfaces 924 of the arm 922. The first trench 974A may extend from the channel 930 to the base 910. The attachment member 920 may define a notch 921 in the drum 903 that extends between the first trench 974A and the channel 930. The second trench 974B may be defined by a rear surface 918 of the base 910. The second trench 974B may extend from the arm 922 to a recess 976 formed in/defined by the rear surface 918 of the base 910.

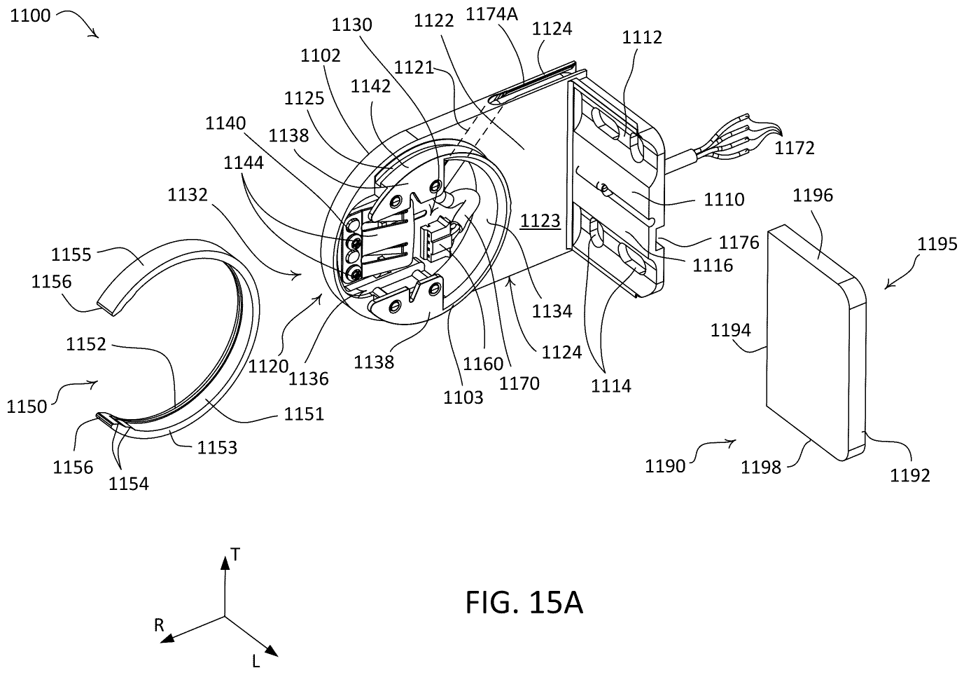

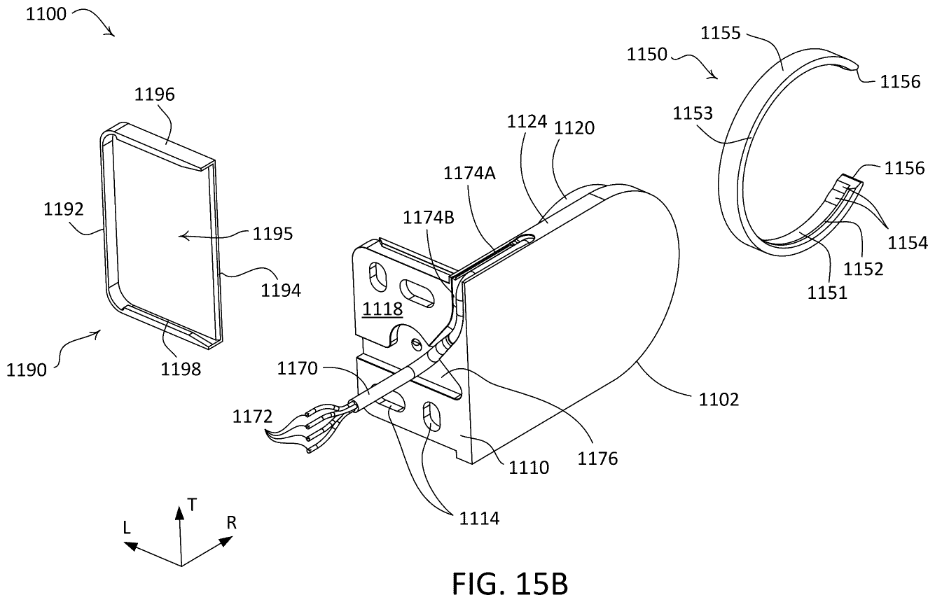

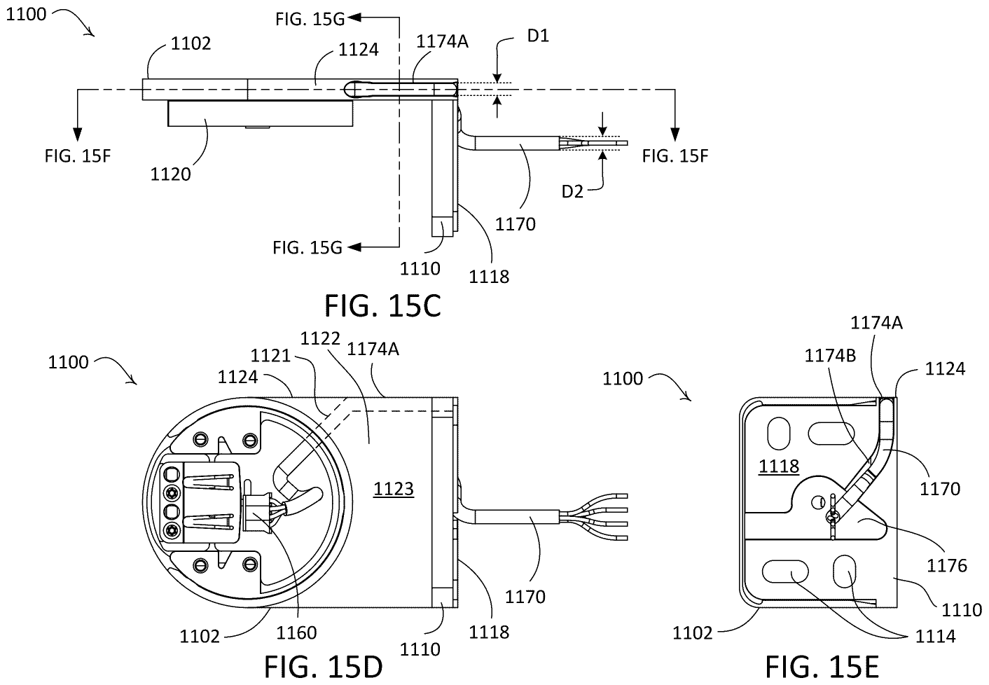

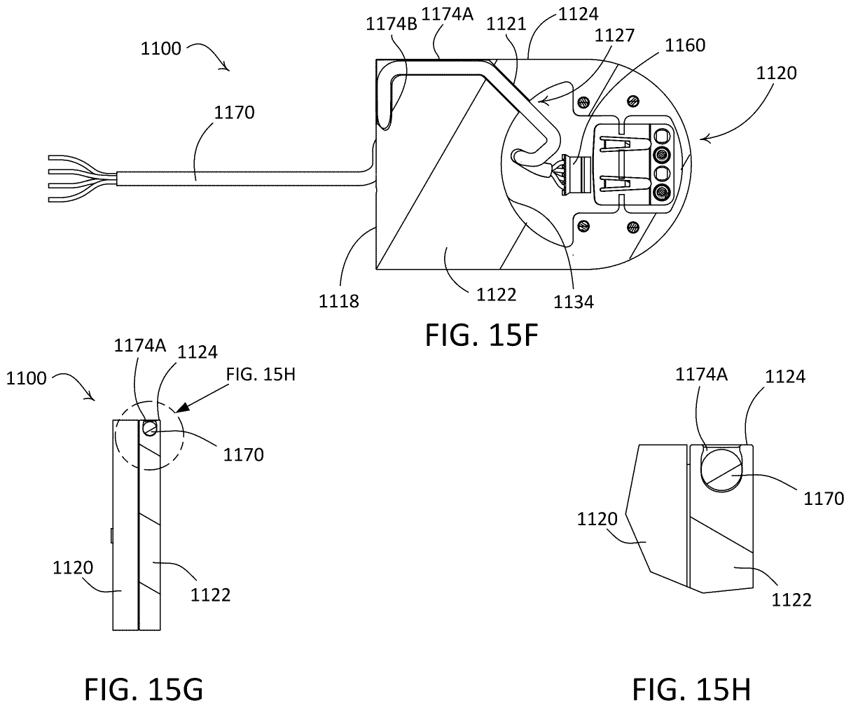

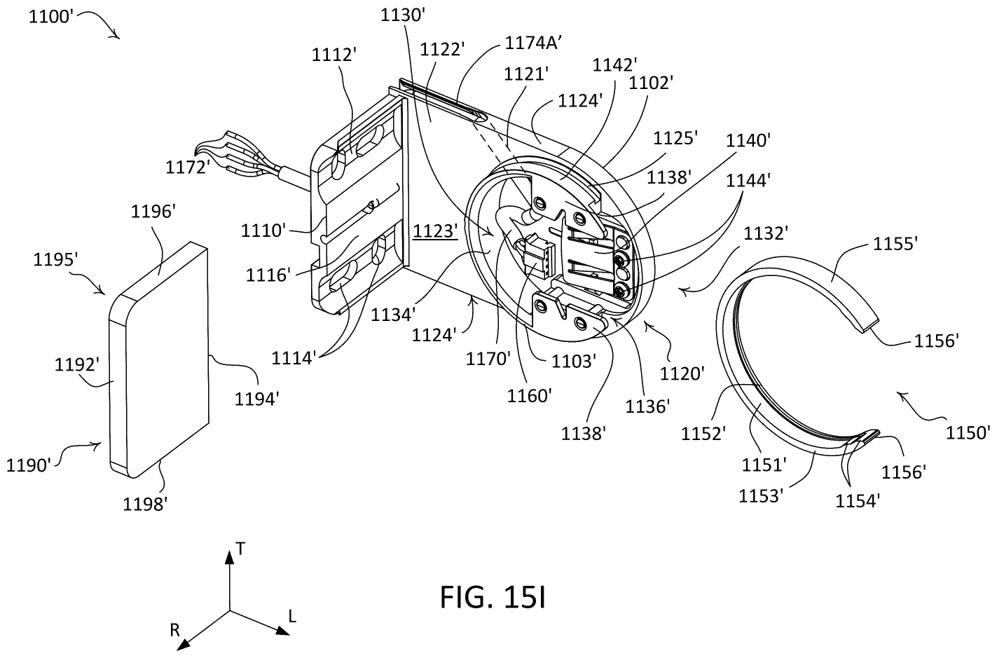

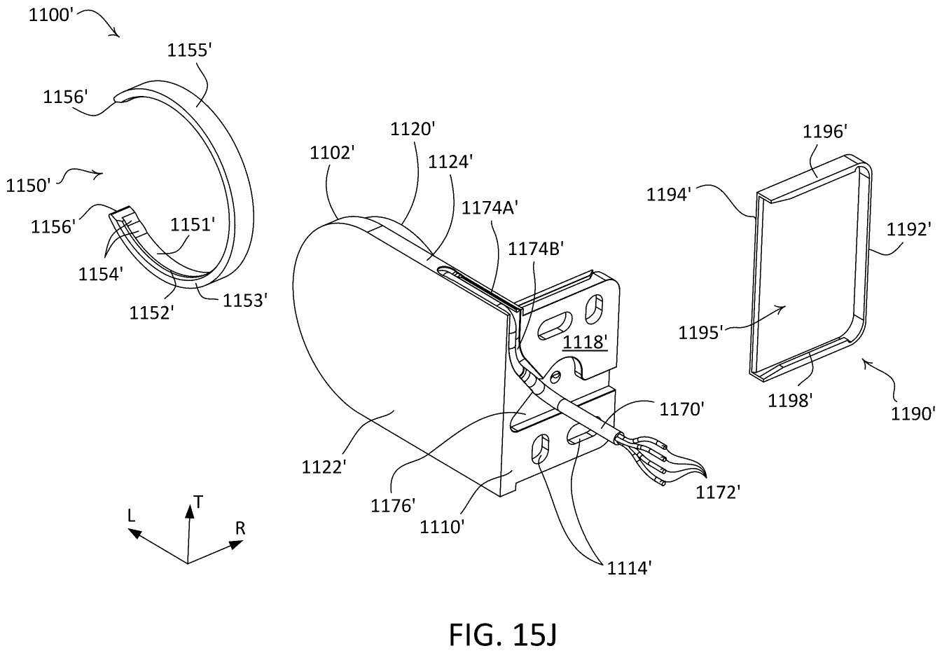

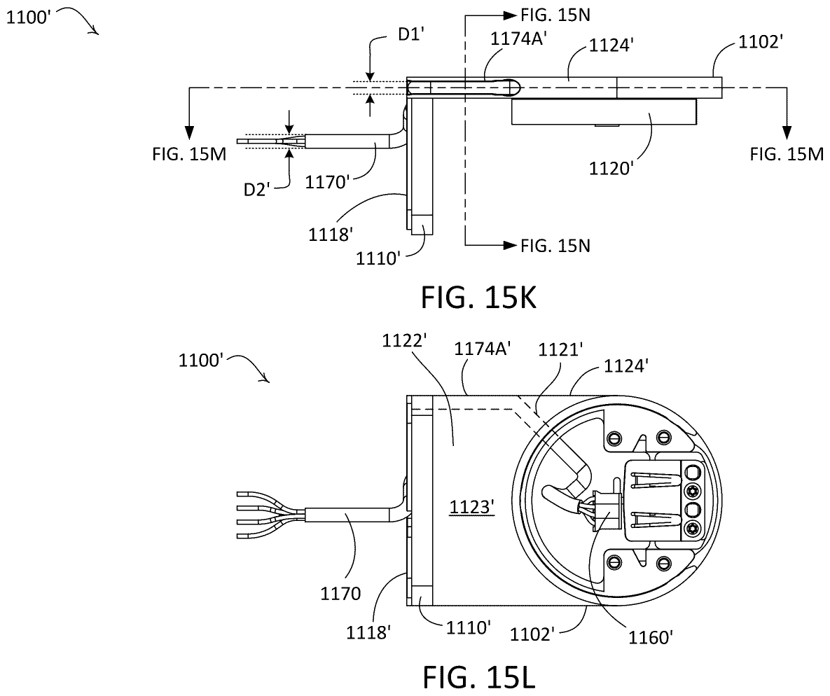

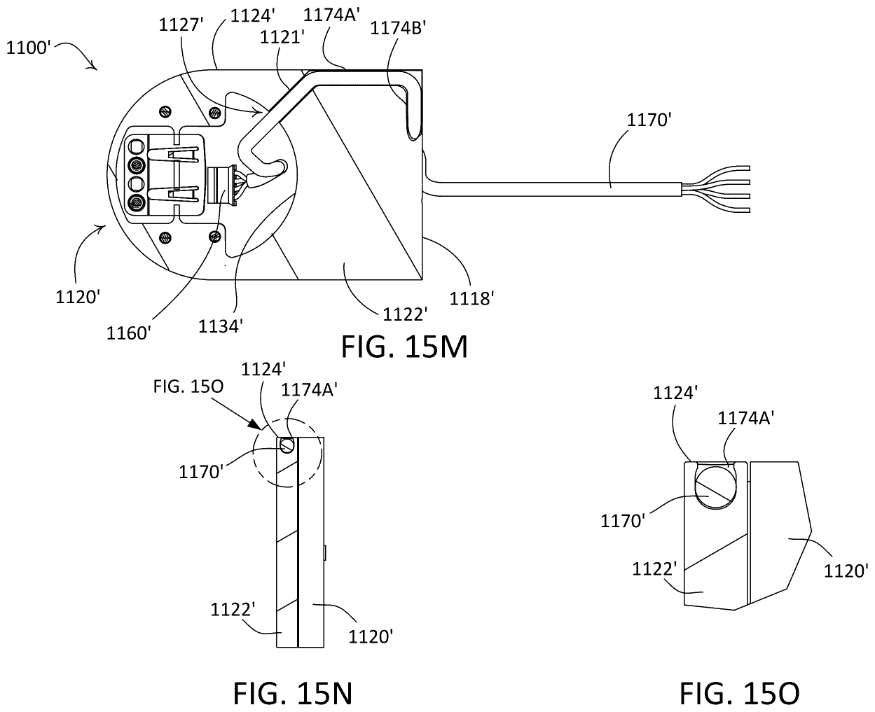

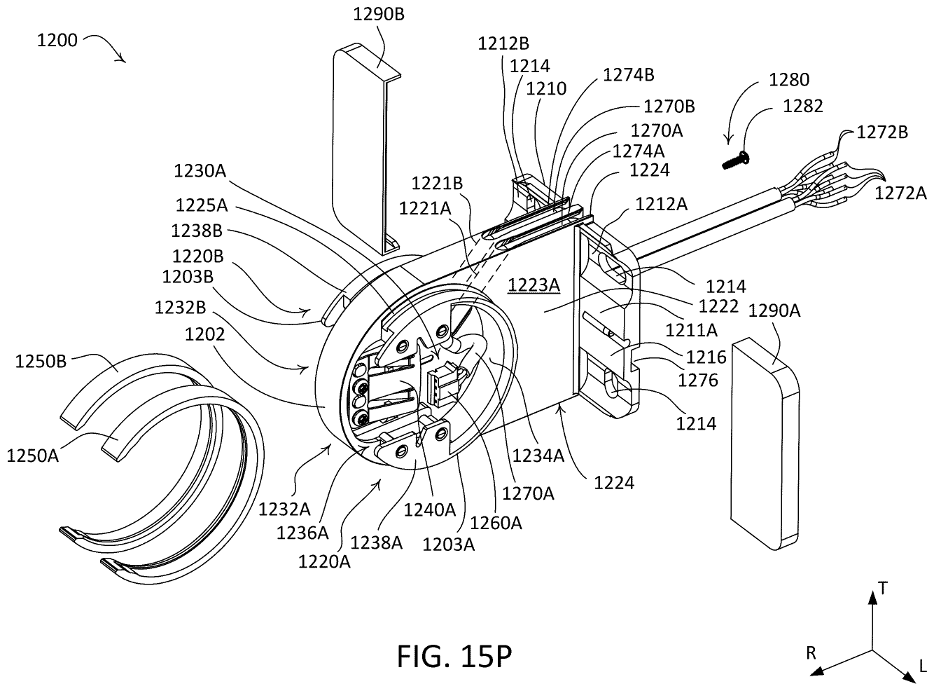

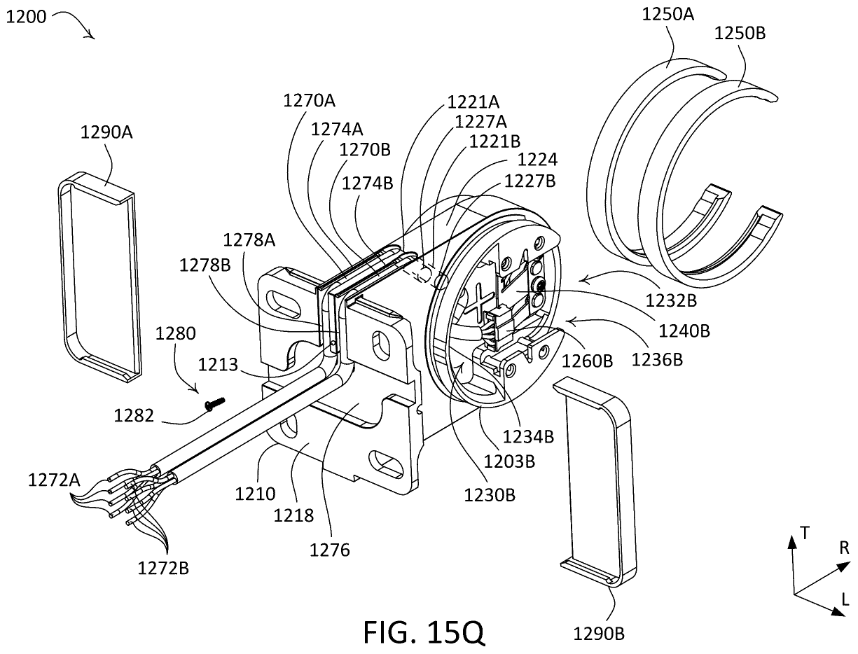

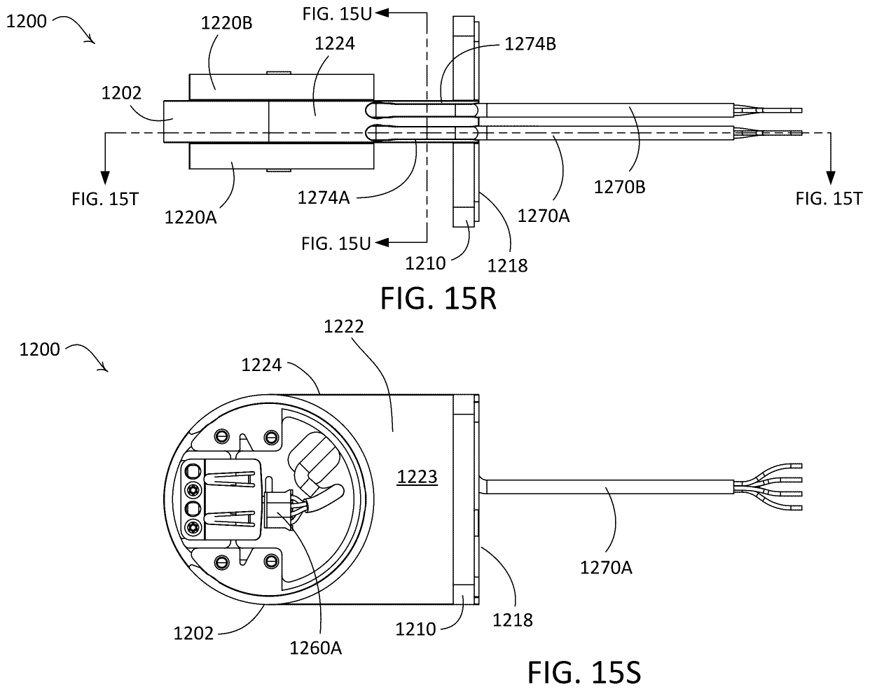

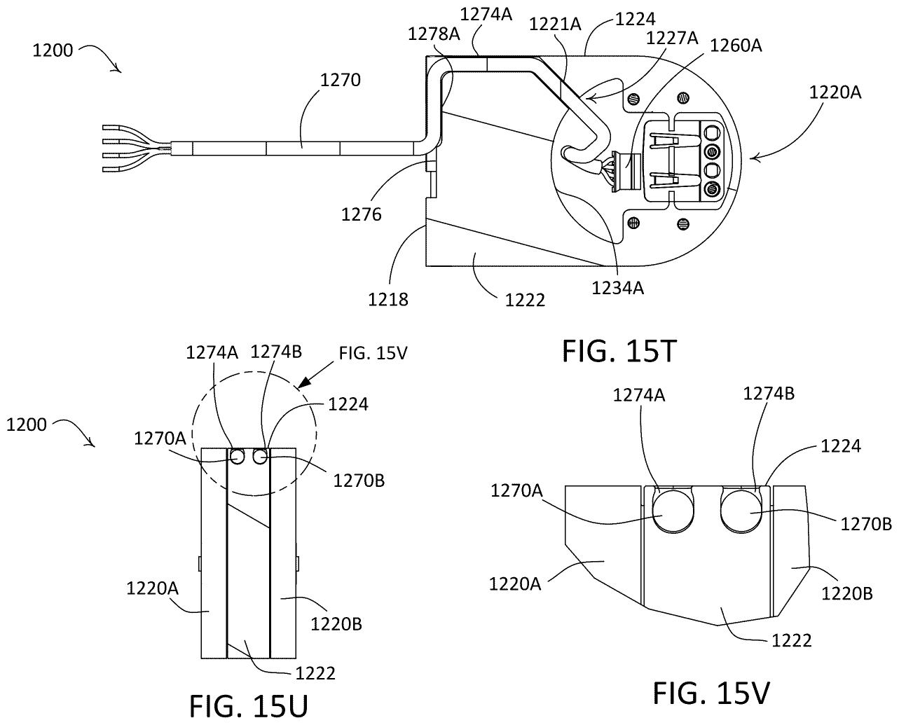

The mounting system 900 may comprise a connector 960 configured to provide electrical connection to the drive assembly of the motorized window treatment. The connector 960 may be received in the channel 930 of the attachment member 920 of the mounting bracket 902. For example, the connector 960 may be configured to freely float in the channel 930. The connector 960 may be configured to be received in an opening of the drive assembly to engage with a socket of the drive assembly (e.g., the socket 166 of the drive assembly 160 shown in FIG. 5B) to be electrically connected to the socket of the drive assembly. The connector 960 may be provided at the end of a cable 970, which may have one or more electrical conductors, such as wires 972. For example, the cable 970 may have a flexible sleeve. In some examples, the sleeve of the cable 970 may be cut into segments to allow the cable 970 to be bent (e.g., easily bent) to fit within the channel 930 when the end portion of the drive assembly is fully inserted into the channel 930. The cable 970 may be received within the first trench 974A in the arm 922 of the mounting bracket 900. The cable 970 may extend into the channel 930 via the notch 921 in the drum 903 of the attachment member 920. The cable 970 may be received within the second trench 974B in the base 910 of the mounting bracket 902. The first trench 974A in the arm 922 may be aligned with the second trench 974B in the base 910, for example, such that the cable 970 extends from the first trench 974A to the second trench 974B. A depth of the first trench 974A and the second trench 974B may be configured such that the cable 970 is recessed within the first trench 974A and the second trench 974B. The second trench 974B may extend from the arm 922 towards the recess 976 of the base 910, such that the cable 970 may be received in the recess 976 in the base 910 and extend into an electrical wallbox (e.g., such as the electrical wallbox 170) mounted in the structure behind the base 910. The first trench 974A in the arm 922 and the second trench 974B in the base may be configured (and the cable 970 selected) such that a depth of the respective trenches 974A, 974B is deep enough so that the cable 970 is flush with or below the outermost surface of the edge surface 924 of the arm 922 and below the outermost surface of the surface 918 of the base 910. Additionally, the first trench 974A in the arm 922 and the second trench 974B in the base 910 may be configured (and the cable 970 selected) such that the cable 970 is retained in the respective trenches 974A, 974B by friction fit, although an adhesive, such as tape, may also be used. In addition, or alternatively, the walls that define the trenches 974A, 974B may define a slight circular shape (e.g., such as a tubular shape) that may retain the cable. It should be appreciated that the mounting system 900 may include a fastener (e.g., such as the fastener 1080 shown in FIG. 14F and/or the fastener 1280 shown in FIGS. 15P and 15Q) that is configured to secure the cable 970 within the second trench 974B.

According to other examples, the mounting system 900 (e.g., the base 910 of the mounting bracket 902) may include a second connector (e.g., such as, the terminal block 480 shown in FIGS. 9A-9B, and/or the plug-in connector assembly 580 shown in FIGS. 10A-10D) that is electrically connected to connector 960 and is configured to electrically connect to wires extending from the structure (e.g., such as the wires 490 shown in FIGS. 9A-9B and/or the wires 590 shown in FIGS. 10A-10D). The mounting bracket 902 in such configurations and as described herein may include the trench 974A, for example, in the arm 922 and the notch 921 to accommodate wiring which may be routed to the base 910. In addition and/or as an alternative, the mounting system 900 may include a connector similar to any of connectors 260, 360, 460, 560, and 660 as described herein, with the cable or wiring routed from the connector to the notch 921 and to the trench 974A and possibly to trench 974B, for example, in the base. Other variations are possible.

The mounting system 900 may include a sliding cover 950. The sliding cover 950 may be received by the attachment member 920 of the mounting bracket 902. The sliding cover 950 may have a circular shape or a substantially circular shape. The sliding cover 950 may be rotatably received by the drum 903 of the attachment member 920 and may surround or partially surround the drum 903. The sliding cover 950 may be configured to cover the channel 930 when the end portion of the roller tube assembly is fully received within the channel 930. For example, the sliding cover 950 may be operable between a closed position (e.g., as shown in FIG. 3A for motorized window treatment 100) and an open position (e.g., as shown in FIG. 3B for the motorized window treatment 100). The sliding cover 950 may rotate in a plane defined by the transverse direction T and the radial direction R between the closed position and the open position. When the sliding cover 950 is in the open position, the end portion of the roller tube assembly may be installed into the channel 930 of the attachment member 920. When the end portion of the roller tube assembly is fully installed in the channel 930, the sliding cover 950 may be rotated into the closed position in which the sliding cover 950 hides the end portion of the roller tube assembly and the channel 930 from view.

The sliding cover 950 may be rotatably received by the attachment member 920. The attachment member 920 may define a slot 925. The slot 925 may extend around an outer surface 942 of the drum 903/attachment member 920. For example, the slot 925 may extend circumferentially about the drum 903/attachment member 920 (e.g., the outer surface 942). The sliding cover 950 may define a rib 952 extending from an inner surface 951 of the sliding cover 950. The rib 952 may extend circumferentially about the inner surface 951 of the sliding cover 950. The rib 952 may be configured to be received within the slot 925, for example, when the inner surface 951 of the sliding cover 950 is proximate to the outer surface 942 of the drum 903/attachment member 920. The rib 952 and the slot 925 may be configured to guide the sliding cover 950 as it operates between the open position and the closed position. For example, the rib 952 and the slot 925 may be configured to operably couple the sliding cover 950 to the drum 903/attachment member 920. The sliding cover 950 may define a side surface 953 and an outer surface 955. The side surface 953 may be configured to be proximate to the roller tube assembly when the roller tube assembly is received within the channel 930 of the mounting bracket 902. The outer surface 955 may be configured to be exposed when the roller tube assembly is received within the channel 930 of the mounting bracket 902.

It should be appreciated that the although the sliding cover 950 is shown as a circular shape, the sliding cover 950 may alternatively be straight and may be configured to slide linearly (e.g., up or down) to move between the closed position and the open position (e.g., to slide out of the way of the channel 930).

The sliding cover 950 may define one or more protrusions 954 (e.g., barbs) that may extend from the inner surface 951 of the sliding cover 950. The protrusions 954 may be located proximate to end portions 956 of the sliding cover 950. The protrusions 954 may be configured to secure the sliding cover 950 in the closed position and/or the open position. For example, the protrusions 954 may be configured to engage complementary features in the drum 903/attachment member 920 (e.g., the outer surface 942). For example, the outer surface 942 of the drum 903/attachment member 920 may define one or more notches 958 (e.g., detents). The one or more notches 958 may be located proximate to the slot 925.

The mounting system 900 may include a base cover 990. For example, the base cover 990 may be configured to be detachably mounted over the base 910 of the mounting bracket 902. The base cover 990 may be configured to conceal at least a portion of the base 910 and fasteners. The base cover 990 may define a cavity 995 that is configured to receive the base 910. The cavity 995 may be defined by a top wall 996, a bottom wall 998, a side wall 992, and an edge 994. According to another example, any of the center brackets described herein may be configured similar to mounting system 900 as described above, and in particular, may be configured, for example, to include trenches and notches (e.g., similar to trenches 974A, 974B, and notch 921). For example, a center bracket, may include one or two trenches (e.g., similar to trench 974A) defined by/along the top edge surface of the arm, each with a respective notch (e.g., similar to notch 921) directed to a respective attachment member on opposing sides of the bracket for routing cables/wires to each attachment member. One or both of the first and second portions of the base may further include one or two trenches (e.g., similar to trench 974B) that is connected to the trench(es) on the arm and configured to receive cables/wires.

Although the trench 974A is shown in the upper edge surface 924 of the arm 922, it should be appreciated that the trench 974A may also or alternatively be located in/defined by the lower edge surface 924.

It should be appreciated that the base 910 may be substantially the width of the arm 922 such that the base 910 does not extend beyond the arm 922. According to another example, a mounting system may be configured similar to mounting system 900 but not include a base.

FIGS. 14C-14D depict an example mounting system 900′ for mounting a roller tube assembly (e.g., roller tube assembly 111 of motorized window treatment 100 shown in FIGS. 1-5B). FIG. 14C is a partially exploded front perspective view and FIG. 14D is a partially exploded rear perspective view of a mounting bracket 902′ of the example mounting system 900′. For example, the mounting bracket 902′ may be deployed as the second mounting bracket 141B of the motorized window treatment 100 (assuming for example, drive assembly 160 was located at the second end 108 of the roller tube assembly 111) (e.g., the right side of the motorized window treatment). The mounting bracket 902′ may include a base 910′ (e.g., a foot) and an attachment member 920′ that may be connected to the base 910′ via an arm 922′. The base 910′ may be configured to attach the mounting bracket 902′ to a structure (e.g., a window frame, a wall, a ceiling, or other structure as with the motorized window treatment 100 shown in FIG. 1). The arm 922′ may extend substantially perpendicular from the base 910′ to the attachment member 920′. When the mounting bracket 902′ is attached to a vertical structure (e.g., such as a wall), the arm 922′ may extend horizontally (e.g., in the radial direction R) from the base 910′ to the attachment member 920′. When the mounting bracket 902′ is attached to a horizontal structure (e.g., such as a ceiling), the arm 922′ may extend vertically (e.g., in the transverse direction T) from the base 910′ to the attachment member 920′. The arm 922′ may comprise an inside surface 923′ (that may be perpendicular to a front surface 916′ of the base 910′) and opposing top and bottom edge surfaces 924′ that may each be perpendicular to inside surface 923′. For example, the edge surfaces 924′ may be located on top and bottom sides of the mounting bracket 902′ when the mounting bracket 902′ is attached to a vertical structure.

The base 910′ may define depressions 912′ that may have a reduced thickness when compared to a remainder of the base 910′. The base 910′ may include holes 914′ therethrough. Each of the holes 914′ may be configured to receive a fastener (not shown) for securing the mounting bracket 902′ to the structure. The holes 914′ may be located within the depressions 912′, such that the fasteners may be countersunk with respect to a front surface 916′ of the base 910′. Each of the holes 914′ may be oblong shaped. For example, the holes 914′ may be oblong shaped to allow for alignment of the mounting bracket 902′ and/or alignment of the fasteners.

As shown in FIG. 14C, the attachment member 920′ may include a drum 903′ (e.g., a cylindrical drum). The drum 903′ may extend in the longitudinal direction L. The drum 903′ may be configured to receive an end portion of a roller tube assembly of a motorized window treatment (e.g., the end portion 114 of the roller tube assembly 111 of the motorized window treatment 100). For example, the drum 903′ may define a channel 930′ that may be configured receive (e.g., for sliding receipt of) the end portion of the roller tube assembly of the motorized window treatment (e.g., similar to the channel 138B of the second mounting bracket 141B). The channel 930′ may define an opening 932′ in the attachment member 920′. The channel 930′ may extend from the opening 932′ to a rear wall 934′. The channel 930′ may define slots 936′ (such as two slots) on either side of the channel 930′. The slots 936′ may be configured such that the channel 930′ is T-shaped (e.g., has a T-shaped cross section). The slots 936′ may be defined by respective flanges 938′ of the drum 903′ of the attachment member 920′. The slots 936′ may also be defined by a side wall 942′ of the channel 930′. The flanges 938′ may be configured to retain the end portion of the roller tube assembly within the channel 930′. The flanges 938′ may be configured to secure the roller tube in the transverse direction T and/or longitudinal direction L. The attachment member 920′ of the mounting bracket 902′ may also comprise a spring 940′, which may be secured to the attachment member 920′ in the channel 930′ (e.g., using one or more fasteners 944′). The spring 940′ of the mounting bracket 902′ may have a similar structure to the springs 240, 340, 440, 540, 640 and may operate in a similar manner as the springs 240, 340, 440, 540, 640 to retain the end portion of the roller tube assembly within the channel 930′.

The mounting bracket 902′ may define multiple trenches including, for example, a first trench 974A′ and a second trench 974B′. The first trench 974A′ may be defined on the arm 922′. For example, the first trench 974A′ may be formed in/defined by one (or both) of the edge surfaces 924′ of the arm 922′. The first trench 974A′ may extend from the channel 930′ to the base 910′. The attachment member 920′ may define a notch 921′ in the drum 903′ that extends between the first trench 974A′ and the channel 930′. The second trench 974B′ may be defined by a rear surface 918′ of the base 910′. The second trench 974B′ may extend from the arm 922′ to a recess 976′ formed in/defined by the rear surface 918′ of the base 910′.

The mounting system 900′ may comprise a connector 960′ configured to provide electrical connection to the drive assembly of the motorized window treatment. The connector 960′ may be received in the channel 930′ of the attachment member 920′ of the mounting bracket 902′. For example, the connector 960′ may be configured to freely float in the channel 930′. The connector 960′ may be configured to be received in an opening of the drive assembly to engage with a socket of the drive assembly (e.g., the socket 166 of the drive assembly 160 shown in FIG. 5B) to be electrically connected to the socket of the drive assembly. The connector 960′ may be provided at the end of a cable 970′, which may have one or more electrical conductors, such as wires 972′. For example, the cable 970′ may have a flexible sleeve. In some examples, the sleeve of the cable 970′ may be cut into segments to allow the cable 970′ to be bent (e.g., easily bent) to fit within the channel 930′ when the end portion of the drive assembly is fully inserted into the channel 930′. The cable 970′ may be received within the first trench 974A′ in the arm 922′ of the mounting bracket 900′. The cable 970′ may extend into the channel 930′ via the notch 921′ in the drum 903′ of the attachment member 920′. The cable 970′ may be received within the second trench 974B′ in the base 910′ of the mounting bracket 902′. The first trench 974A′ in the arm 922′ may be aligned with the second trench 974B′ in the base 910′, for example, such that the cable 970′ extends from the first trench 974A′ to the second trench 974B′. A depth of the first trench 974A′ and the second trench 974B′ may be configured such that the cable 970′ is recessed within the first trench 974A′ and the second trench 974B′. The second trench 974B′ may extend from the arm 922′ towards the recess 976′ of the base 910′, such that the cable 970′ may be received in the recess 976′ in the base 910′ and extend into an electrical wallbox (e.g., such as the electrical wallbox 170) mounted in the structure behind the base 910′. The first trench 974A′ in the arm 922′ and the second trench 974B′ in the base may be configured (and the cable 970′ selected) such that a depth of the respective trenches 974A′, 974B′ is deep enough so that the cable 970′ is flush with or below the outermost surface of the edge surface 924′ of the arm 922′ and below the outermost surface of the surface 918′ of the base 910′. Additionally, the first trench 974A′ in the arm 922′ and the second trench 974B′ in the base 910′ may be configured (and the cable 970′ selected) such that the cable 970′ is retained in the respective trenches 974A′, 974B′ by friction fit, although an adhesive, such as tape, may also be used. It should be appreciated that the mounting system 900′ may include a fastener (e.g., such as the fastener 1080 shown in FIG. 14F and/or the fastener 1280 shown in FIGS. 15P and 15Q) that is configured to secure the cable 970′ within the second trench 974B′.

According to other examples, the mounting system 900′ (e.g., the base 910′ of the mounting bracket 902′) may include a second connector (e.g., such as, the terminal block 480 shown in FIGS. 9A-9B, and/or the plug-in connector assembly 580 shown in FIGS. 10A-10D) that is electrically connected to connector 960′ and is configured to electrically connect to wires extending from the structure (e.g., such as the wires 490 shown in FIGS. 9A-9B and/or the wires 590 shown in FIGS. 10A-10D). The mounting bracket 902′ in such configurations and as described herein may include the trench 974A′, for example, in the arm 922′ and the notch 921′ to accommodate wiring which may be routed to the base 910′. In addition and/or as an alternative, the mounting system 900′ may include a connector similar to any of connectors 260, 360, 460, 560, and 660 as described herein, with the cable or wiring routed from the connector to the notch 921′ and to the trench 974A′ and possibly to trench 974B′, for example, in the base 902′. Other variations are possible.

The mounting system 900′ may include a sliding cover 950′. The sliding cover 950′ may be received by the attachment member 920′ of the mounting bracket 902′. The sliding cover 950′ may have a circular shape or a substantially circular shape. The sliding cover 950′ may be rotatably received by the drum 903′ of the attachment member 920′ and may surround or partially surround the drum 903′. The sliding cover 950′ may be configured to cover the channel 930′ when the end portion of the roller tube assembly is fully received within the channel 930′. For example, the sliding cover 950′ may be operable between a closed position (e.g., as shown in FIG. 3A for motorized window treatment 100) and an open position (e.g., as shown in FIG. 3B for the motorized window treatment 100). The sliding cover 950′ may rotate in a plane defined by the transverse direction T and the radial direction R between the closed position and the open position. When the sliding cover 950′ is in the open position, the end portion of the roller tube assembly may be installed into the channel 930′ of the attachment member 920′. When the end portion of the roller tube assembly is fully installed in the channel 930′, the sliding cover 950′ may be rotated into the closed position in which the sliding cover 950′ hides the end portion of the roller tube assembly and the channel 930′ from view.

The sliding cover 950′ may be rotatably received by the attachment member 920′. The attachment member 920′ may define a slot 925′. The slot 925′ may extend around an outer surface 942′ of the drum 903′/attachment member 920′. For example, the slot 925′ may extend circumferentially about the drum 903′/attachment member 920′ (e.g., the outer surface 942′). The sliding cover 950′ may define a rib 952′ extending from an inner surface 951′ of the sliding cover 950′. The rib 952′ may extend circumferentially about the inner surface 951′ of the sliding cover 950′. The rib 952′ may be configured to be received within the slot 925′, for example, when the inner surface 951′ of the sliding cover 950′ is proximate to the outer surface 942′ of the drum 903′/attachment member 920′. The rib 952′ and the slot 925′ may be configured to guide the sliding cover 950′ as it operates between the open position and the closed position. For example, the rib 952′ and the slot 925′ may be configured to operably couple the sliding cover 950′ to the drum 903′/attachment member 920′. The sliding cover 950′ may define a side surface 953′ and an outer surface 955′. The side surface 953′ may be configured to be proximate to the roller tube assembly when the roller tube assembly is received within the channel 930′ of the mounting bracket 902′. The outer surface 955′ may be configured to be exposed when the roller tube assembly is received within the channel 930′ of the mounting bracket 902′.

It should be appreciated that the although the sliding cover 950′ is shown as a circular shape, the sliding cover 950′ may alternatively be straight and may be configured to slide linearly (e.g., up or down) to move between the closed position and the open position (e.g., to slide out of the way of the channel 930′).

The sliding cover 950′ may define one or more protrusions 954′ (e.g., barbs) that may extend from the inner surface 951′ of the sliding cover 950′. The protrusions 954′ may be located proximate to end portions 956′ of the sliding cover 950′. The protrusions 954′ may be configured to secure the sliding cover 950′ in the closed position and/or the open position. For example, the protrusions 954′ may be configured to engage complementary features in the drum 903′/attachment member 920′ (e.g., the outer surface 942′). For example, the outer surface 942′ of the drum 903′/attachment member 920′ may define one or more notches 958′ (e.g., detents). The one or more notches 958′ may be located proximate to the slot 925′.

The mounting system 900′ may include a base cover 990′. For example, the base cover 990′ may be configured to be detachably mounted over the base 910′ of the mounting bracket 902′. The base cover 990′ may be configured to conceal at least a portion of the base 910′ and fasteners. The base cover 990′ may define a cavity 995′ that is configured to receive the base 910′. The cavity 995′ may be defined by a top wall 996′, a bottom wall 998′, a side wall 992′, and an edge 994′. According to another example, any of the center brackets described herein may be configured similar to mounting system 900′ as described above, and in particular, may be configured, for example, to include trenches and notches (e.g., similar to trenches 974A′, 974B′, and notch 921′). For example, a center bracket, may include one or two trenches (similar to trench 974A′) defined by/along the top edge surface of the arm, each with a respective notch (similar to notch 921′) directed to a respective attachment member on opposing sides of the bracket for routing cables/wires to each attachment member. One or both of the first and second portions of the base may further include one or two trenches (similar to trench 974B′) that is connected to the trench(es) on the arm and configured to receive cables/wires.

It should be appreciated that the base 910′ may be substantially the width of the arm 922′ such that the base 910′ does not extend beyond the arm 922′. According to another example, a mounting system may be configured similar to mounting system 900′ but not include a base.

FIGS. 14E-14F depict an example mounting system 1000 for mounting one or more roller tube assemblies (e.g., multiple roller tube assemblies 111 of motorized window treatment 100 shown in FIGS. 1-5B). FIG. 14E is a right-side front perspective view of the mounting system 1000. FIG. 14F is a right-side rear perspective view of the mounting system 1000. For example, the mounting system 1000 may comprise a mounting bracket 1002, such as a center bracket, which may be located between two roller tube assemblies of respective adjacent motorized window treatments (e.g., which each may be similar to the roller tube assembly 111 of the motorized window treatment 100). It should be appreciated that the mounting system 1000 may include one or more other mounting brackets (e.g., such as the first mounting bracket 141A and/or the second mounting bracket 141B of the motorized window treatment 100).

The mounting bracket 1002 may include a base 1010 (e.g., a foot), which may comprise a first portion 1011A (e.g., on the right side of the mounting bracket 1002) and a second portion 1011B (e.g., on the opposing left side of the mounting bracket 1002). The mounting bracket 1002 may also comprise a first attachment member 1020A (e.g., on the right side of the mounting bracket 1002) and a second attachment member 1020B (e.g., on the opposing left side of the mounting bracket 1002). The second attachment member 1020B may be similarly configured as the first attachment member 1020A. The first attachment member 1020A and the second attachment member 1020B may be connected to the base 1010 via an arm 1022. The second portion 1011B of the base 1010 may be located on an opposite side of the arm 1022 as the first portion 1011A of the base 1010. The second attachment member 1020B may be located on an opposite side of the arm 1022 as the first attachment member 1020A, and may be a mirror copy of the first attachment member 1020A. The base 1010 may be configured to attach the mounting bracket 1002 to a structure (e.g., a window frame, a wall, a ceiling, or other structure as with the motorized window treatment 100 shown in FIG. 1). The arm 1022 may extend substantially perpendicular from the base 1010 to the first attachment member 1020A and the second attachment member 1020B. When the mounting bracket 1002 is attached to a vertical structure (e.g., such as a wall), the arm 1022 may extend horizontally (e.g., in the radial direction R) from the base 1010 to the first attachment member 1020A and the second attachment member 1020B. When the mounting bracket 1002 is attached to a horizontal structure (e.g., such as a ceiling), the arm 1022 may extend vertically (e.g., in the transverse direction T) from the base 1010 to the first attachment member 1020A and the second attachment member 1020B.

The base 1010 may define depressions (e.g., such as the depressions 1012A, 1012B) that may have a reduced thickness when compared to a remainder of the base 1010. The base 1010 may include holes 1014 therethrough. Each of the holes 1014 may be configured to receive a fastener (not shown) for securing the mounting bracket 1002 to the structure. The holes 1014 may be located within the depressions, such that the fasteners may be countersunk with respect to a front surface (e.g., such as the front surface 1016) of the base 1010. One or more of the holes 1014 may be oblong shaped. For example, the oblong shaped holes of the holes 1014 may allow for alignment of the mounting bracket 1002 and/or alignment of the fasteners. The mounting system 1000 may comprise a first base cover 1090A that may be configured to be detachably mounted over the first portion 1011A of the base 1010 and a second base cover 1090B that may be configured to be detachably mounted over the second portion 1011B of the base 1010, e.g., for covering and/or concealing the base 1010 and fasteners.

The first attachment member 1020A and the second attachment member 1020B of the mounting bracket 1002 may include respective drums (e.g., such as drums 1003A, 1003B). The drums 1003A, 1003B may be cylindrical drums. The drums 1003A, 1003B may extend in the longitudinal direction L. The drums 1003A, 1003B may each be configured to receive an end portion of a roller tube assembly of a respective motorized window treatment (e.g., such as the end portion 114 of the roller tube assembly 111 of the motorized window treatment 100). For example, the drum 1003A may define a first channel 1030A (e.g., similar to channel 230A shown in FIGS. 7E and 7G) that may be configured to receive (e.g., for sliding receipt of) the end portion of the roller tube assembly of the respective motorized window treatment (e.g., similar to the channel 138A of the first mounting bracket 141A). The first channel 1030A may define an opening 1032A. The first channel 1030A may extend from the opening 1032A to a rear wall 1034A of the drum 1024A of the first attachment member 1020A. It should be appreciated that the drum 1003B of the second attachment member 1020B may also define a second channel (e.g., similar to the channel 230B shown in FIGS. 7F and 7H) that is configured to receive (e.g., sliding receipt of) an end portion of another roller tube assembly of another motorized window treatment. The second channel may define an opening 1032B. The second channel may extend from the opening 1032B to a rear wall of the drum of the second attachment member 1020B.

The first channel 1030A of the first attachment member 1020A may define a first pair of slots 1036A (such as two slots) (e.g., similar to slots 236A) located on either side of the first channel 1030A. The second channel of the second attachment member 1020B may define a second pair of slots (such as two slots) (e.g., similar to slots 236B) on either side of the second channel. The first slots 1036A may be configured such that the first channel 1030A is T-shaped (e.g., having a T-shaped cross section). The second slots may be configured such that the second channel is T-shaped (e.g., having a T-shaped cross section). The first slots 1036A of the first channel 1030A of the first attachment member 1020A may be defined by respective flanges 1038A of the drum 1003A. The first slots 1036A may also be defined by a first side wall 1042A of the first channel 1030A. The second slots of the second channel of the second attachment member 1020B may be defined by respective flanges 1038B of the drum 1003B of the second attachment member 1020B. The second slots may also be defined by a second side wall of the second channel. The flanges 1038A, 1038B may be configured to retain the end portions of respective roller tube assemblies within the respective channels, and may be configured to secure the respective roller tube assemblies in the transverse direction T and/or longitudinal direction L.

The first attachment member 1020A and the second attachment member 1020B of the mounting bracket 1002 may also comprise respective springs (e.g., such as spring 1040A) (and similar to springs 240A and 240B), which may be secured to the respective one of the first attachment member 1020A or the second attachment member 1020B, for example, in the respective channels. The springs may each have a similar structure to the spring 240 of the mounting bracket 202, and may operate in a similar manner as the spring 240 of the mounting bracket 202 to retain the end portion of the respective roller tube assembly within the respective channel.

The mounting system 1000 may include a first sliding cover 1050A that may be rotatably mounted around the drum 1003A of the first attachment member 1020A and a second sliding cover 1050B that may be rotatably mounted around the drum 1003B of the second attachment member 1020B. The first and second sliding covers 1050A, 1050B may each have a similar structure to the sliding cover 950 of the mounting system 900, for example, and may function in a similar manner as the sliding cover 950 of the mounting system 900 to be operated into an open position in which the end portion of the respective roller tube assembly may be installed into the respective channel and into a closed position in which the end portion of the respective roller tube assembly is not accessible and hidden from view.

The mounting bracket 1002 may define multiple trenches including, for example, a first upper trench 1074A, a second upper trench 1074B, a first rear trench 1078A, and a second rear trench 1078B. The first upper trench 1074A and the second upper trench 1074B may be defined on the arm 1022. For example, the first upper trench 1074A and the second upper trench 1074B may be formed in/defined by an upper surface 1024 of the arm 1022 (e.g., mounting bracket 1002 may include an inside surface 1023A and opposing top edge surface 1024 that may be perpendicular to inside surface 1023A). The first upper trench 1074A and the second upper trench 1074B may be substantially parallel and may extend along the arm 1022 in the radial direction R. The first upper trench 1074A may extend from the first channel 1030A to the base 1010. The first attachment member 1020A may define a notch 1021A in the drum 1024A that extends between the first upper trench 1074A and the first channel 1030A. The second upper trench 1074B may extend from the second channel to the base 1010. The second attachment member 1020B may define a notch 1021B in the drum 1003B of the second attachment member 1020B that extends between the second upper trench 1074B and the second channel of the second attachment member 1020B. The first rear trench 1078A and the second rear trench 1078B may be defined by a rear surface 1018 of the base 1010. The first rear trench 1078A may extend to the first upper trench 1074A and the second rear trench 1078B may extend to the second upper trench 1074B. The first rear trench 1078A and the second rear trench 1078B may extend from the arm 1022 to a recess 1076 formed in/defined by the rear surface 1018 of the base 1010.

The mounting system 1000 may comprise a first connector 1060A removably attached to the mounting bracket 1002 within the first channel 1030A of the first attachment member 1020A, and a second connector (similar to first connector 1060A) removably attached to the mounting bracket 1002 within the second channel of the second attachment member 1020B. The first connector 1060A and the second connector may each have a similar structure to the connector 960 of the mounting system 900, for example, and may operate in a similar manner as the connector 960 of the mounting system 900 to provide electrical connection to the drive assembly of a respective roller tube assembly mounted to the first attachment member 1020A and the second attachment member 1020B, respectfully. The first connector 1060A may be provided at the end of a first cable 1070A, which may include one or more electrical conductors, such as wires 1072A. The second connector may be provided at the end of a second cable 1070B, which may include one or more electrical conductors, such as wires 1072B. The cable 1070A may be received within the first upper trench 1074A in the arm 1022 of the mounting bracket 1002. The cable 1070A may extend into the first channel 1030A via the notch 1021A in the drum 1003A of the first attachment member 1020A. The cable 1070A may be received within the first rear trench 1078A in the base 1010 of the mounting bracket 1002. The first upper trench 1074A in the arm 1022 may be aligned with the first rear trench 1078A in the base 1010, for example, such that the cable 1070A extends from the first upper trench 1074A to the first rear trench 1078A. The cable 1070B may be received within the second upper trench 1074B in the arm 1022 of the mounting bracket 1002. The cable 1070B may extend into the second channel via the notch 1021B in the drum 1003B of the second attachment member 1020B. The cable 1070B may be received within the second rear trench 1078B in the base 1010 of the mounting bracket 1002. The second upper trench 1074B in the arm 1022 may be aligned with the second rear trench 1078B in the base 1010, for example, such that the cable 1070B extends from the second upper trench 1074B to the second rear trench 1078B.

A depth of the first upper trench 1074A, the second upper trench 1074B, the first rear trench 1078A, and the second rear trench 1078B may be configured such that the cables 1070A, 1070B are recessed within the first upper trench 1074A, the second upper trench 1074B, the first rear trench 1078A, and the second rear trench 1078B, respectively. The first rear trench 1078A and the second rear trench 1078B may extend from the first upper trench 1074A and the second upper trench 1074B, respectively towards the recess 1076 of the base 1010, such that the cables 1070A, 1070B may be received in the recess 1076 in the base 1010 and extend into an electrical wallbox (e.g., such as the electrical wallbox 170) mounted in the structure behind the base 1010. The first upper trench 1074A and the second upper trench 1074B in the arm 1022 and first rear trench 1078A and the second rear trench 1078B in the base 1010 may be configured (and the cables 1070A, 1070B selected) such that a depth of the trenches 1074A, 1074B, 1078A, 1078B is deep enough so that the cables 1070A, 1070B are flush with or below the outermost surface of the upper edge surface 1024 of the arm 1022 and below the outermost surface of the surface 1018 of base 1010. Additionally, the first upper trench 1074A and the second upper trench 1074B in the arm 1022 and the first rear trench 1078A and the second rear trench 1078B in the base 1010 may be configured (and the cables 1070A, 1070B selected) such that the cables 1070A, 1070B are retained in the respective trenches 1074A, 1074B, 1078A, 1078B by friction fit, although an adhesive, such as tape, may also be used. In addition, or alternatively, the walls that define the trenches 1074A, 1074B, 1078A, 1078B may define a slight circular shape (e.g., such as a tubular shape) that may retain the cables. The mounting system 1000 may include a fastener 1080 (e.g., such as a screw) that is configured to secure the cables 1070A, 1070B within the respective rear trenches 1078A, 1078B. For example, the fastener 1080 may be configured to be secured to the base 1010 such that the fastener 1080 abuts the cables 1070A, 1070B (e.g., respective outer surfaces of the cables 1070A, 1070B) to retain the cables 1070A, 1070B in the respective rear trenches 1078A, 1078B. For example, the base 1010 may define an opening 1013 that is configured to receive the fastener 1080. The opening 1013 may be located between the rear trenches 1078A, 1078B. A portion (e.g., a head 1082) of the fastener 1080 may be configured to prevent the cables 1070A, 1070B from disengaging from the respective rear trenches 1078A, 1078B. The head 1082 of the fastener 1080 may extend over at least a portion of each of the rear trenches 1078A, 1078B, for example, such that the head 1082 of the fastener 1080 is configured to abut the cables 1070A, 1070B to prevent the cables 1070A, 1070B from being removed from the respective rear trenches 1078A, 1078B. It should be appreciated that although the figures depict the fastener 1080 as a screw, the fastener 1080 is not limited to a screw and instead could be a clip, a pin, a clasp, a catch, and/or another type of fastener. It should also be appreciated that although the figures show one fastener 1080, a plurality of fasteners 1080 can be used to retain the cables 1070A, 1070B in the respective rear trenches 1078A, 1078B.

According to other examples, the mounting system 1000 (e.g., the base 1010 of the mounting bracket 1002) may include one or more second connectors (e.g., such as, the terminal block 480 shown in FIGS. 9A-9B, and/or the plug-in connector assembly 580 shown in FIGS. 10A-10D) that is electrically connected to the connectors 1060A, 1060B within the channels of the attachment members and are configured to electrically connect to wires extending from the structure (e.g., such as the wires 490 shown in FIGS. 9A-9B and/or the wires 590 shown in FIGS. 10A-10D).

The mounting bracket 1002 in such configurations and as described herein may include the trenches 1074A, 1074B, for example, in the arm 1022 and the notches 1021A and 1021B to accommodate wiring which may be routed to the base 1010. In addition and/or as an alternative, rather than connectors similar to connectors 1060A, 1060B, the mounting system 1000 may include connectors similar to any of connectors 260, 360, 460, 560, and 660 as described herein within the channels of the attachment members, with the cables 1070A and 1070B routed from the connectors to the notches 1021A, 1021B and to the trenches 1074A, 1074B and possibly to trenches 1078A, 1078B, for example, in the base 1010. Other variations are possible.

It should be appreciated that the base 1010 may be substantially the width of the arm 1022 such that the base 1010 does not extend beyond the arm 1022. According to another example, a mounting system may be configured similar to mounting system 1000 but not include a base.

FIGS. 15A-15H depict another example mounting system 1100 for mounting a roller tube assembly (e.g., roller tube assembly 111 of motorized window treatment 100 shown in FIGS. 1-5B). FIG. 15A is a partially exploded front perspective view and FIG. 15B is a partially exploded rear perspective view of a mounting bracket 1102 of the example mounting system 1100. FIG. 15C is a top view of the mounting system 1100. FIG. 15D is a side view of the mounting system 1100. FIG. 15E is a rear view of the mounting system 1100. FIGS. 15F and 15G are respective cross-section views of the mounting system 1100. FIG. 15H is a detailed view of the cross-section view of FIG. 15G. For example, the mounting bracket 1102 may be deployed as the first mounting bracket 141A of the motorized window treatment 100 (e.g., the left side of the motorized window treatment). The mounting bracket 1102 may include a base 1110 (e.g., a foot) and an attachment member 1120 that may be connected to the base 1110 via an arm 1122. The base 1110 may be configured to attach the mounting bracket 1102 to a structure (e.g., a window frame, a wall, a ceiling, or other structure as with the motorized window treatment 100 shown in FIG. 1). The arm 1122 may extend substantially perpendicular from the base 1110 to the attachment member 1120. When the mounting bracket 1102 is attached to a vertical structure (e.g., such as a wall), the arm 1122 may extend horizontally (e.g., in the radial direction R) from the base 1110 to the attachment member 1120. When the mounting bracket 1102 is attached to a horizontal structure (e.g., such as a ceiling), the arm 1122 may extend vertically (e.g., in the transverse direction T) from the base 1110 to the attachment member 1120. The arm 1122 may comprise an inside surface 1123 (that may be perpendicular to a front surface 1116 of the base 1110) and opposing top and bottom edge surfaces 1124 that may each be perpendicular to inside surface 1123. For example, the edge surfaces 1124 may be located on top and bottom sides of the mounting bracket 1102 when the mounting bracket 1102 is attached to a vertical structure.

The base 1110 may define depressions 1112 that may have a reduced thickness when compared to a remainder of the base 1110. The base 1110 may include holes 1114 therethrough. Each of the holes 1114 may be configured to receive a fastener (not shown) for securing the mounting bracket 1102 to the structure. The holes 1114 may be located within the depressions 1112, such that the fasteners may be countersunk with respect to a front surface 1116 of the base 1110. Each of the holes 1114 may be oblong shaped. For example, the holes 1114 may be oblong shaped to allow for alignment of the mounting bracket 1102 and/or alignment of the fasteners.

As shown in FIG. 15A, the attachment member 1120 may include a drum 1103 (e.g., a cylindrical drum). The drum 1103 may extend in the longitudinal direction L. The drum 1103 may be configured to receive an end portion of a roller tube assembly of a motorized window treatment (e.g., the end portion 114 of the roller tube assembly 111 of the motorized window treatment 100). For example, the drum 1103 may define a channel 1130 that may be configured receive (e.g., for sliding receipt of) the end portion of the roller tube assembly of the motorized window treatment (e.g., similar to the channel 138A of the first mounting bracket 141A). The channel 1130 may define an opening 1132 in the attachment member 1120. The channel 1130 may extend from the opening 1132 to a rear wall 1134. The channel 1130 may define slots 1136 (such as two slots) on either side of the channel 1130. The slots 1136 may be configured such that the channel 1130 is T-shaped (e.g., has a T-shaped cross section). The slots 1136 may be defined by respective flanges 1138 of the drum 1103 of the attachment member 1120. The slots 1136 may also be defined by a side wall 1142 of the channel 1130. The flanges 1138 may be configured to retain the end portion of the roller tube assembly within the channel 1130. The flanges 1138 may be configured to secure the roller tube in the transverse direction T and/or longitudinal direction L. The attachment member 1120 of the mounting bracket 1102 may also comprise a spring 1140, which may be secured to the attachment member 1120 in the channel 1130 (e.g., using one or more fasteners 1144). The spring 1140 of the mounting bracket 1102 may have a similar structure to the springs 240, 340, 440, 540, 640, 940, 940′, 1040 and may operate in a similar manner as the springs 240, 340, 440, 540, 640, 940, 940′, 1040 to retain the end portion of the roller tube assembly within the channel 1130.

The mounting bracket 1102 may define one or more trenches including, for example, a first trench 1174A and a second trench 1174B. The first trench 1174A may be defined on the arm 1122. For example, the first trench 1174A may be formed in/defined by one (or both) of the edge surfaces 1124 of the arm 1122. The first trench 1174A may extend from the channel 1130 to the base 1110. The mounting bracket 1102 may define a bore 1121 (e.g., a tunnel) in/defined by the arm 1122 that extends between the first trench 1174A and the channel 1130. The bore 1121 may extend in the transverse direction T and the radial direction R (e.g., angularly) between the channel 1130 and the upper edge surface 1124 (e.g., the first trench 1174A). For example, the bore 1121 may extend at a substantially 45 degree angle from the radial direction R. It should be appreciated that the bore 1121 may extend at other angles (e.g., from the radial direction R) and the other angles may result in the first trench 1174A being longer or shorter, respectively. The bore 1121 may define an opening 1127 in the rear wall 1134. The bore 1121 may also define an opening in the first trench 1174A. The second trench 1174B may be defined by a rear surface 1118 of the base 1110. The second trench 1174B may extend from the arm 1122 to a recess 1176 formed in/defined by the rear surface 1118 of the base 1110.

The mounting system 1100 may comprise a connector 1160 configured to provide electrical connection to the drive assembly of the motorized window treatment. The connector 1160 may be received in the channel 1130 of the attachment member 1120 of the mounting bracket 1102. For example, the connector 1160 may be configured to freely float in the channel 1130. The connector 1160 may be configured to be received in an opening of the drive assembly to engage with a socket of the drive assembly (e.g., the socket 166 of the drive assembly 160 shown in FIG. 5B) to be electrically connected to the socket of the drive assembly. The connector 1160 may be provided at the end of a cable 1170, which may have one or more electrical conductors, such as wires 1172. For example, the cable 1170 may have a flexible sleeve. In some examples, the sleeve of the cable 1170 may be cut into segments to allow the cable 1170 to be bent (e.g., easily bent) to fit within the channel 1130 when the end portion of the drive assembly is fully inserted into the channel 1130. The cable 1170 may be received within and through the bore 1121 in the arm 1122 of the mounting bracket 1102, for example, via the opening 1127. The cable 1170 may be received within the first trench 1174A in the arm 1122 of the mounting bracket 1102. The cable 1170 may extend into the channel 1130 via the bore 1121 in the arm 1122 and the opening 1127 of the rear wall 1134 of the attachment member 1120. The cable 1170 may be received within the second trench 1174B in the base 1110 of the mounting bracket 1102. The first trench 1174A in the arm 1122 may be aligned with the second trench 1174B in the base 1110, for example, such that the cable 1170 extends from the first trench 1174A to the second trench 1174B. A depth of the first trench 1174A and the second trench 1174B may be configured such that the cable 1170 is recessed within the first trench 1174A and the second trench 1174B. The second trench 1174B may extend from the arm 1122 towards the recess 1176 of the base 1110, such that the cable 1170 may be received in the recess 1176 in the base 1110 and extend into an electrical wallbox (e.g., such as the electrical wallbox 170) mounted in the structure behind the base 1110. The first trench 1174A and the second trench 1174B may include features configured to keep the cable 1170 in place (e.g., within the respective trench 1174A, 1174B). For example, the walls that define the trenches 1174A, 1174B may define a slight circular shape (e.g., such as a tubular shape).

The first trench 1174A in the arm 1122 and the second trench 1174B in the base 1110 may be configured (and the cable 1170 selected) such that a depth of the respective trenches 1174A, 1174B is deep enough so that the cable 1170 is flush with or below the outermost surface of edge surface 1124 of arm 1122 and below the outermost surface of the surface 1118 of base 1110. Additionally, the first trench 1174A in the arm 1122 and the second trench 1174B in the base may be configured (and the cable 1170 selected) such that the cable 1170 is retained in the trenches 1174A, 1174B by friction fit, although an adhesive, such as tape, may also be used. For example, the first trench 1174A may define a distance D1 in the longitudinal direction that is less than a width of the cable 1170 that is defined by distance D2. It should be appreciated that the mounting system 1100 may include a fastener (e.g., such as the fastener 1080 shown in FIG. 14F and/or the fastener 1280 shown in FIGS. 15P and 15Q) that is configured to secure the cable 1170 within the second trench 1174B.

According to other examples, the mounting system 1100 (e.g., the base 1110 of the mounting bracket 902) may include a second connector (e.g., such as, the terminal block 480 shown in FIGS. 9A-9B, and/or the plug-in connector assembly 580 shown in FIGS. 10A-10D) that is electrically connected to connector 1160 and is configured to electrically connect to wires extending from the structure (e.g., such as the wires 490 shown in FIGS. 9A-9B and/or the wires 590 shown in FIGS. 10A-10D). The mounting bracket 1102 in such configurations and as described herein may include the trench 174A, for example, in arm 1122 and bore 1121 to accommodate wiring which may be routed to the base 1110. In addition and/or as an alternative, the mounting system 1100 may include a connector similar to any of connectors 260, 360, 460, 560, 660, 960, 960′, 1060 as described herein, with cable or wiring routed from the connector to the bore 1121 and the trench 1174A and possibly to trench 1174B, for example, in the base 1110. Other variations are possible.

The mounting system 1100 may include a sliding cover 1150. The sliding cover 1150 may be received by the attachment member 1120 of the mounting bracket 1102. The sliding cover 1150 may have a circular shape or a substantially circular shape. The sliding cover 1150 may be rotatably received by the drum 1103 of the attachment member 1120 and may surround or partially surround the drum 1103. The sliding cover 1150 may be configured to cover the channel 1130 when the end portion of the roller tube assembly is fully received within the channel 1130. For example, the sliding cover 1150 may be operable between a closed position (e.g., as shown in FIG. 3A for motorized window treatment 100) and an open position (e.g., as shown in FIG. 3B for the motorized window treatment 100). The sliding cover 1150 may rotate in a plane defined by the transverse direction T and the radial direction R between the closed position and the open position. When the sliding cover 1150 is in the open position, the end portion of the roller tube assembly may be installed into the channel 1130 of the attachment member 1120. When the end portion of the roller tube assembly is fully installed in the channel 1130, the sliding cover 1150 may be rotated into the closed position in which the sliding cover 1150 hides the end portion of the roller tube assembly and the channel 1130 from view.

The sliding cover 1150 may be rotatably received by the attachment member 1120. The attachment member 1120 may define a slot 1125. The slot 1125 may extend around an outer surface 1142 of the drum 1103/attachment member 1120. For example, the slot 1125 may extend circumferentially about the drum 1103/attachment member 1120 (e.g., the outer surface 1142). The sliding cover 1150 may define a rib 1152 extending from an inner surface 1151 of the sliding cover 1150. The rib 1152 may extend circumferentially about the inner surface 1151 of the sliding cover 1150. The rib 1152 may be configured to be received within the slot 1125, for example, when the inner surface 1151 of the sliding cover is proximate to the outer surface 1142 of the drum 1103/attachment member 1120. The rib 1152 and the slot 1125 may be configured to guide the sliding cover 1150 as it operates between the open position and the closed position. For example, the rib 1152 and the slot 1125 may be configured to operably couple the sliding cover 1150 to the drum 1103/attachment member 1120. The sliding cover 1150 may define a side surface 1153 and an outer surface 1155. The side surface 1153 may be configured to be proximate to the roller tube assembly when the roller tube assembly is received within the channel 1130 of the mounting bracket 1102. The outer surface 1155 may be configured to be exposed when the roller tube assembly is received within the channel 1130 of the mounting bracket 1102.

It should be appreciated that the although the sliding cover 1150 is shown as a circular shape, the sliding cover 11950 may alternatively be straight and may be configured to slide linearly (e.g., up or down) to move between the closed position and the open position (e.g., to slide out of the way of the channel 1130).

The sliding cover 1150 may define one or more protrusions 1154 (e.g., barbs) that may extend from the inner surface 1151 of the sliding cover 1150. The protrusions 1154 may be located proximate to end portions 1156 of the sliding cover 1150. The protrusions 1154 may be configured to secure the sliding cover 1150 in the closed position and/or the open position. For example, the protrusions 1154 may be configured to engage complementary features in the drum 1103/attachment member 1120 (e.g., the outer surface 1142). For example, the outer surface 1142 of the drum 1103/attachment member 1120 may define one or more notches 1158 (e.g., detents). The one or more notches 1158 may be located proximate to the slot 1125.

The mounting system 1100 may include a base cover 1190. For example, the base cover 1190 may be configured to be detachably mounted over the base 1110 of the mounting bracket 1102. The base cover 1190 may be configured to conceal at least a portion of the base 1110 and fasteners. The base cover 1190 may define a cavity 1195 that is configured to receive the base 1110. The cavity 1195 may be defined by a top wall 1196, a bottom wall 1198, a side wall 1192, and an edge 1194. According to another example, any of the center brackets described herein may be configured similar to mounting system 1100 as described above, and in particular, may be configured, for example, to include trenches and bores (similar to trenches 1174A, 1174B, and bore 1121). For example, a center bracket, may include one or two trenches (similar to trench 1174A) defined by/along the top edge surface of the arm, each with a respective bore (similar to bore 1121) directed to a respective attachment member on opposing sides of the bracket for routing cables/wires to each attachment member. One or both of the first and second portions of the base may further include one or two trenches (similar to trench 1174B) that is connected to the trench(es) on the arm and configured to receive cables/wires.

Although the trench 1174A is shown in the upper edge surface 1124 of the arm 1122, it should be appreciated that the trench 1174A may also or alternatively be located in/defined by the lower edge surface 1124. (It should be appreciated that the base 1110 may be substantially the width of the arm 1122 such that the base 1110 does not extend beyond the arm 1122. According to another example, a mounting system may be configured similar to mounting system 1100 but not include a base.

FIGS. 15I-150 depict another example mounting system 1100′ for mounting a roller tube assembly (e.g., roller tube assembly 111 of motorized window treatment 100 shown in FIGS. 1-5B). FIG. 15I is a partially exploded front perspective view and FIG. 15J is a partially exploded rear perspective view of a mounting bracket 1102′ of the example mounting system 1100′. FIG. 15K is a top view of the mounting system 1100′. FIG. 15L is a side view of the mounting system 1100′. FIGS. 15M and 15N are respective cross-section views of the mounting system 1100′. FIG. 15O is a detailed view of the cross-section view of FIG. 15N. For example, the mounting bracket 1102′ may be deployed as the second mounting bracket 141B of the motorized window treatment 100 (e.g., the right side of the motorized window treatment). The mounting bracket 1102′ may include a base 1110′ (e.g., a foot) and an attachment member 1120′ that may be connected to the base 1110′ via an arm 1122′. The base 1110′ may be configured to attach the mounting bracket 1102′ to a structure (e.g., a window frame, a wall, a ceiling, or other structure as with the motorized window treatment 100 shown in FIG. 1). The arm 1122′ may extend substantially perpendicular from the base 1110′ to the attachment member 1120′. When the mounting bracket 1102′ is attached to a vertical structure (e.g., such as a wall), the arm 1122′ may extend horizontally (e.g., in the radial direction R) from the base 1110′ to the attachment member 1120′. When the mounting bracket 1102′ is attached to a horizontal structure (e.g., such as a ceiling), the arm 1122′ may extend vertically (e.g., in the transverse direction T) from the base 1110′ to the attachment member 1120′. The arm 1122′ may comprise an inside surface 1123′ (that may be perpendicular to a front surface 1116′ of the base 1110′) and opposing top and bottom edge surfaces 1124′ that may each be perpendicular to inside surface 1123′. For example, the edge surfaces 1124′ may be located on top and bottom sides of the mounting bracket 1102′ when the mounting bracket 1102′ is attached to a vertical structure.

The base 1110′ may define depressions 1112′ that may have a reduced thickness when compared to a remainder of the base 1110′. The base 1110 ‘may include holes 1114’ therethrough. Each of the holes 1114′ may be configured to receive a fastener (not shown) for securing the mounting bracket 1102′ to the structure. The holes 1114′ may be located within the depressions 1112′, such that the fasteners may be countersunk with respect to a front surface 1116′ of the base 1110′. Each of the holes 1114′ may be oblong shaped. For example, the holes 1114′ may be oblong shaped to allow for alignment of the mounting bracket 1102′ and/or alignment of the fasteners.

As shown in FIG. 15I, the attachment member 1120′ may include a drum 1103′ (e.g., a cylindrical drum). The drum 1103′ may extend in the longitudinal direction L. The drum 1103′ may be configured to receive an end portion of a roller tube assembly of a motorized window treatment (e.g., the end portion 114 of the roller tube assembly 111 of the motorized window treatment 100). For example, the drum 1103′ may define a channel 1130′ that may be configured receive (e.g., for sliding receipt of) the end portion of the roller tube assembly of the motorized window treatment (e.g., similar to the channel 138B of the first mounting bracket 141B). The channel 1130′ may define an opening 1132′ in the attachment member 1120′. The channel 1130′ may extend from the opening 1132′ to a rear wall 1134′. The channel 1130′ may define slots 1136′ (such as two slots) on either side of the channel 1130′. The slots 1136′ may be configured such that the channel 1130′ is T-shaped (e.g., has a T-shaped cross section). The slots 1136′ may be defined by respective flanges 1138′ of the drum 1103′ of the attachment member 1120′. The slots 1136′ may also be defined by a side wall 1142′ of the channel 1130′. flanges 1138′ may be configured to retain the end portion of the roller tube assembly within the channel 1130′. The flanges 1138′ may be configured to secure the roller tube in the transverse direction T and/or longitudinal direction L. The attachment member 1120′ of the mounting bracket 1102′ may also comprise a spring 1140′, which may be secured to the attachment member 1120′ in the channel 1130′ (e.g., using one or more fasteners 1144′). The spring 1140′ of the mounting bracket 1102′ may have a similar structure to the springs 240, 340, 440, 540, 640, 940, 940′, 1040, 1140 and may operate in a similar manner as the springs 240, 340, 440, 540, 640, 940, 940′, 1040, 1140 to retain the end portion of the roller tube assembly within the channel 1130′.

The mounting bracket 1102′ may define one or more trenches including, for example, a first trench 1174A′ and a second trench 1174B′. The first trench 1174A′ may be defined on the arm 1122′. For example, the first trench 1174A′ may be formed in/defined by one (or both) of the edge surfaces 1124′ of the arm 1122′. The first trench 1174A′ may extend from the channel 1130′ to the base 1110′. The mounting bracket 1102′ may define a bore 1121′ (e.g., a tunnel) in/defined by the arm 1122′ that extends between the first trench 1174A ‘and the channel 1130’. The bore 1121′ may extend in the transverse direction T and the radial direction R (e.g., angularly) between the channel 1130′ and the upper edge surface 1124′ (e.g., the first trench 1174A′). For example, the bore 1121′ may extend at a 45 degree angle from the radial direction R. It should be appreciated that the bore 1121′ may extend at other angles (e.g., from the radial direction R) and the other angles may result in the first trench 1174A′ being longer or shorter, respectively. The bore 1121′ may define an opening 1127′ in the rear wall 1134′. The bore 1121′ may also define an opening in the first trench 1174A′. The second trench 1174B′ may be defined by a rear surface 1118 ‘of the base 1110’. The second trench 1174B′ may extend from the arm 1122′ to a recess 1176′ formed in/defined by the rear surface 1118 ‘of the base 1110’.

The mounting system 1100′ may comprise a connector 1160′ configured to provide electrical connection to the drive assembly of the motorized window treatment. The connector 1160′ may be received in the channel 1130′ of the attachment member 1120′ of the mounting bracket 1102′. For example, the connector 1160′ may be configured to freely float in the channel 1130′. The connector 1160′ may be configured to be received in an opening of the drive assembly to engage with a socket of the drive assembly (e.g., the socket 166 of the drive assembly 160 shown in FIG. 5B) to be electrically connected to the socket of the drive assembly. The connector 1160′ may be provided at the end of a cable 1170′, which may have one or more electrical conductors, such as wires 1172′. For example, the cable 1170′ may have a flexible sleeve. In some examples, the sleeve of the cable 1170′ may be cut into segments to allow the cable 1170′ to be bent (e.g., easily bent) to fit within the channel 1130′ when the end portion of the drive assembly is fully inserted into the channel 1130′. The cable 1170′ may be received within the bore 1121′ in the arm 1122′ of the mounting bracket 1102′, for example, via the opening 1127′. The cable 1170′ may be received within the first trench 1174A′ in the arm 1122′ of the mounting bracket 1102′. The cable 1170′ may extend into the channel 1130′ via the bore 1121′ in the arm 1122′ and the opening 1127′ of the rear wall 1134′ of the attachment member 1120′. The cable 1170′ may be received within the second trench 1174B′ in the base 1110′ of the mounting bracket 1102′. The first trench 1174A′ in the arm 1122′ may be aligned with the second trench 1174B′ in the base 1110′, for example, such that the cable 1170′ extends from the first trench 1174A′ to the second trench 1174B′. A depth of the first trench 1174A′ and the second trench 1174B′ may be configured such that the cable 1170′ is recessed within the first trench 1174A′ and the second trench 1174B′. The second trench 1174B′ may extend from the arm 1122′ towards the recess 1176′ of the base 1110′, such that the cable 1170′ may be received in the recess 1176′ in the base 1110′ and extend into an electrical wallbox (e.g., such as the electrical wallbox 170) mounted in the structure behind the base 1110′. The first trench 1174A′ and the second trench 1174B′ may include features configured to keep the cable 1170′ in place (e.g., within the respective trench 1174A′, 1174B′). For example, the walls that define the trenches 1174A′, 1174B′ may define a slight circular shape (e.g., such as a tubular shape).

The first trench 1174A′ in the arm 1122′ and the second trench 1174B′ in the base 1110′ may be configured (and the cable 1170′ selected) such that a depth of the respective trenches 1174A′, 1174B′ is deep enough so that the cable 1170′ is flush with or below the outermost surface of edge surface 1124′ of arm 1122′ and below the outermost surface of the surface 1118′ of base 1110′. Additionally, the first trench 1174A′ in the arm 1122′ and the second trench 1174B′ in the base 1110′ may be configured (and the cable 1170′ selected) such that the cable 1170′ is retained in the trenches 1174A′, 1174B′ by friction fit, although an adhesive, such as tape, may also be used. For example, the first trench 1174A′ may define a distance D1′ in the longitudinal direction that is less than a width of the cable 1170′ that is defined by distance D2′. It should be appreciated that the mounting system 1100′ may include a fastener (e.g., such as the fastener 1080 shown in FIG. 14F and/or the fastener 1280 shown in FIGS. 15P and 15Q) that is configured to secure the cable 1170′ within the second trench 1174B′.

According to other examples, the mounting system 1100′ (e.g., the base 1110′ of the mounting bracket 1102′) may include a second connector (e.g., such as, the terminal block 480 shown in FIGS. 9A-9B, and/or the plug-in connector assembly 580 shown in FIGS. 10A-10D) that is electrically connected to connector 1160′ and is configured to electrically connect to wires extending from the structure (e.g., such as the wires 490 shown in FIGS. 9A-9B and/or the wires 590 shown in FIGS. 10A-10D). The mounting bracket 1102′ in such configurations and as described herein may include the trench 1174A′, for example, in arm 1122′ and bore 1121′ to accommodate wiring which may be routed to the base 1110′. In addition and/or as an alternative, the mounting system 1100′ may include a connector similar to any of connectors 260, 360, 460, 560, 660, 960, 960′, 1060, 1160 as described herein, with cable or wiring routed from the connector to the bore 1121′ and the trench 1174A′ and possibly to trench 1174B′, for example, in the base 1110′. Other variations are possible.

The mounting system 1100′ may include a sliding cover 1150′. The sliding cover 1150′ may be received by the attachment member 1120′ of the mounting bracket 1102′. The sliding cover 1150′ may have a circular shape or a substantially circular shape. The sliding cover 1150′ may be rotatably received by the drum 1103′ of the attachment member 1120′ and may surround or partially surround the drum 1103′. The sliding cover 1150′ may be configured to cover the channel 1130′ when the end portion of the roller tube assembly is fully received within the channel 1130′. For example, the sliding cover 1150′ may be operable between a closed position (e.g., as shown in FIG. 3A for motorized window treatment 100) and an open position (e.g., as shown in FIG. 3B for the motorized window treatment 100). The sliding cover 1150′ may rotate in a plane defined by the transverse direction T and the radial direction R between the closed position and the open position. When the sliding cover 1150′ is in the open position, the end portion of the roller tube assembly may be installed into the channel 1130′ of the attachment member 1120′. When the end portion of the roller tube assembly is fully installed in the channel 1130′, the sliding cover 1150′ may be rotated into the closed position in which the sliding cover 1150′ hides the end portion of the roller tube assembly and the channel 1130′ from view.

The sliding cover 1150′ may be rotatably received by the attachment member 1120′. The attachment member 1120′ may define a slot 1125′. The slot 1125′ may extend around an outer surface 1142′ of the drum 1103′/attachment member 1120′. For example, the slot 1125′ may extend circumferentially about the drum 1103′/attachment member 1120′ (e.g., the outer surface 1142′). The sliding cover 1150′ may define a rib 1152′ extending from an inner surface 1151′ of the sliding cover 1150′. The rib 1152′ may extend circumferentially about the inner surface 1151′ of the sliding cover 1150′. The rib 1152′ may be configured to be received within the slot 1125′, for example, when the inner surface 1151′ of the sliding cover 1150′ is proximate to the outer surface 1142′ of the drum 1103′/attachment member 1120′. The rib 1152′ and the slot 1125′ may be configured to guide the sliding cover 1150′ as it operates between the open position and the closed position. For example, the rib 1152′ and the slot 1125′ may be configured to operably couple the sliding cover 1150′ to the drum 1103′/attachment member 1120′. The sliding cover 1150′ may define a side surface 1153′ and an outer surface 1155′. The side surface 1153′ may be configured to be proximate to the roller tube assembly when the roller tube assembly is received within the channel 1130′ of the mounting bracket 1102′. The outer surface 1155′ may be configured to be exposed when the roller tube assembly is received within the channel 1130′ of the mounting bracket 1102′.

It should be appreciated that the although the sliding cover 1150′ is shown as a circular shape, the sliding cover 1150′ may alternatively be straight and may be configured to slide linearly (e.g., up or down) to move between the closed position and the open position (e.g., to slide out of the way of the channel 1130′).

The sliding cover 1150′ may define one or more protrusions 1154′ (e.g., barbs) that may extend from the inner surface 1151′ of the sliding cover 1150′. The protrusions 1154′ may be located proximate to end portions 1156′ of the sliding cover 1150′. The protrusions 1154′ may be configured to secure the sliding cover 1150′ in the closed position and/or the open position. For example, the protrusions 1154′ may be configured to engage complementary features in the drum 1103′/attachment member 1120′ (e.g., the outer surface 1142′). For example, the outer surface 1142′ of the drum 1103′/attachment member 1120′ may define one or more notches 1158′ (e.g., detents). The one or more notches 1158′ may be located proximate to the slot 1125′.

The mounting system 1100′ may include a base cover 1190′. For example, the base cover 1190′ may be configured to be detachably mounted over the base 1110′ of the mounting bracket 1102′. The base cover 1190′ may be configured to conceal at least a portion of the base 1110′ and fasteners. The base cover 1190′ may define a cavity 1195′ that is configured to receive the base 1110′. The cavity 1195′ may be defined by a top wall 1196′, a bottom wall 1198′, a side wall 1192′, and an edge 1194′. According to another example, any of the center brackets described herein may be configured similar to mounting system 1100′ as described above, and in particular, may be configured, for example, to include trenches and bores (similar to trenches 1174A′, 1174B′, and bore 1121′). For example, a center bracket, may include one or two trenches (similar to trench 1174A′) defined by/along the top edge surface of the arm, each with a respective bore (similar to bore 1121′) directed to a respective attachment member on opposing sides of the bracket for routing cables/wires to each attachment member. One or both of the first and second portions of the base may further include one or two trenches (similar to trench 1174B′) that is connected to the trench(es) on the arm and configured to receive cables/wires.

It should be appreciated that the base 1110′ may be substantially the width of the arm 1122′ such that the base 1110′ does not extend beyond the arm 1122′. According to another example, a mounting system may be configured similar to mounting system 1100′ but not include a base.

FIGS. 15P-15V depict another example mounting system 1200 for mounting one or more roller tube assemblies of a motorized window treatment (e.g., multiple roller tube assemblies 111 of motorized window treatment 100 shown in FIGS. 1-5B). FIG. 15P is a right-side front perspective view of the mounting system 1200. FIG. 15Q is a right-side rear perspective view of the mounting system 1200. FIG. 15R is a top view of the mounting system 1200. FIG. 15S is a side view of the mounting system 1200. FIGS. 15T and 15U are respective cross-section views of the mounting system 1200. FIG. 15V is a detailed view of the cross-section view of FIG. 15U. For example, the mounting system 1200 may comprise a mounting bracket 1202, such as a center bracket, which may be located between two roller tube assemblies of respective adjacent motorized window treatments (e.g., which each may be similar to the roller tube assembly 111 of the motorized window treatment 100). It should be appreciated that the mounting system 1200 may include one or more other mounting brackets (e.g., such as the first mounting bracket 141A and/or the second mounting bracket 141B of the motorized window treatment 100).

The mounting bracket 1202 may include a base 1210 (e.g., a foot), which may comprise a first portion 1211A (e.g., on the right side of the mounting bracket 1202) and a second portion 1211B (e.g., on the left side of the mounting bracket 1202). The mounting bracket 1202 may also comprise a first attachment member 1220A (e.g., on the right side of the mounting bracket 1202) and a second attachment member 1220B (e.g., on the left side of the mounting bracket 1202). The second attachment member 1220B may be similarly configured as the first attachment member 1220A. The first attachment member 1220A and the second attachment member 1220B may be connected to the base 1210 via an arm 1222. The second portion 1211B of the base 1210 may be located on an opposite side of the arm 1222 as the first portion 1211A of the base 1210. The second attachment member 1220B may be located on an opposite side of the arm 1222 as the first attachment member 1220A, and may be a mirror copy of the first attachment member 1220A. The base 1210 may be configured to attach the mounting bracket 1202 to a structure (e.g., a window frame, a wall, a ceiling, or other structure as with the motorized window treatment 100 shown in

FIG. 1). The arm 1222 may extend substantially perpendicular from the base 1210 to the first attachment member 1220A and the second attachment member 1220B. When the mounting bracket 1202 is attached to a vertical structure (e.g., such as a wall), the arm 1222 may extend horizontally (e.g., in the radial direction R) from the base 1210 to the first attachment member 1220A and the second attachment member 1220B. When the mounting bracket 1202 is attached to a horizontal structure (e.g., such as a ceiling), the arm 1222 may extend vertically (e.g., in the transverse direction T) from the base 1210 to the first attachment member 1220A and the second attachment member 1220B.

The base 1210 may define depressions (e.g., such as the depressions 1212A, 1212B) that may have a reduced thickness when compared to a remainder of the base 1210. The base 1210 may include holes 1214 therethrough. Each of the holes 1214 may be configured to receive a fastener (not shown) for securing the mounting bracket 1202 to the structure. The holes 1214 may be located within the depressions, such that the fasteners may be countersunk with respect to a front surface (e.g., such as the front surface 1216) of the base 1210. One or more of the holes 1214 may be oblong shaped. For example, the oblong shaped holes of the holes 1214 may allow for alignment of the mounting bracket 1202 and/or alignment of the fasteners. The mounting system 1200 may comprise a first base cover 1290A that may be configured to be detachably mounted over the first portion 1211A of the base 1210 and a second base cover 1290B that may be configured to be detachably mounted over the second portion 1211B of the base 1210, e.g., for covering and/or concealing the base 1210 and fasteners.

The first attachment member 1220A and the second attachment member 1220B of the mounting bracket 1202 may include respective drums (e.g., such as drums 1203A, 1203B). The drums 1203A, 1203B may be cylindrical drums. The drums 1203A, 1203B may extend in the longitudinal direction L. The drums 1203A, 1203B may each be configured to receive an end portion of a roller tube assembly of a respective motorized window treatment (e.g., such as the end portion 114 of the roller tube assembly 111 of the motorized window treatment 100). For example, the drum 1203A may define a first channel 1230A (e.g., similar to channel 230A shown in FIGS. 7E and 7G) that may be configured to receive (e.g., for sliding receipt of) the end portion of the roller tube assembly of the respective motorized window treatment (e.g., similar to the channel 138A of the first mounting bracket 141A). The first channel 1230A may define an opening 1232A. The first channel 1230A may extend from the opening 1232A to a rear wall 1234A of the drum 1203A of the first attachment member 1220A. It should be appreciated that the drum 1203B of the second attachment member 1220B may also define a second channel 1230B (e.g., such as the channel 230B shown in FIGS. 7F and 7H) that is configured to receive (e.g., sliding receipt of) an end portion of another roller tube assembly of another motorized window treatment. The second channel may define an opening 1232B. The second channel 1230B may extend from the opening 1232B to a rear wall of the drum 1203B of the second attachment member 1220B.

The first channel 1230A of the first attachment member 1220A may define a first pair of slots 1236A (such as two slots) (e.g., similar to slots 236) located on either side of the first channel 1230A. The second channel 1230B of the second attachment member 1220B may define a second pair of slots (such as two slots) 1236B (e.g., similar to slots 236) on either side of the second channel 1230B. The first slots 1236A may be configured such that the first channel 1230A is T-shaped (e.g., having a T-shaped cross section). The second slots 1236B may be configured such that the second channel 1230B is T-shaped (e.g., having a T-shaped cross section). The first slots 1236A of the first channel 1230A of the first attachment member 1220A may be defined by respective flanges (such as two) 1238A of the drum 1203A. The first slots 1236A may also be defined by a first side wall 1242A of the first channel 1230A. The second slots 1236B of the second channel 1230B of the second attachment member 1220B may be defined by respective flanges (such as two) 1238B of the drum 1203B of the second attachment member 1220B. The second slots 1236B may also be defined by a second side wall 1242B of the second channel 1230B. The flanges 1238A, 1238B may be configured to retain the end portions of respective roller tube assemblies within the respective channels, and may be configured to secure the respective roller tube assemblies in the transverse direction T and/or longitudinal direction L.

The first attachment member 1220A and the second attachment member 1220B of the mounting bracket 1202 may also comprise respective springs (e.g., such as spring 1240A, 1240B), which may be secured to the respective one of the first attachment member 1220A or the second attachment member 1220B, for example, in the respective channels. The springs may each have a similar structure to the springs 240, 340, 440, 540, 640, 940, 940′, 1040, 1140 for example and may operate in a similar manner as the springs 240, 340, 440, 540, 640, 940, 940′, 1040, 1140 to retain the end portion of the respective roller tube assembly within the respective channel.

The mounting system 1200 may include a first sliding cover 1250A that may be rotatably mounted around the drum 1203A of the first attachment member 1220A and a second sliding cover 1250B that may be rotatably mounted around the drum 1203B of the second attachment member 1220B. The first and second sliding covers 1250A, 1250B and respective drums 1203A, 1250B of the first and second attachment members 1220A, 1220B may each have a similar structure to the drums and sliding covers of mounting systems 900, 1100, 1100′ for example and may function in a similar manner as those sliding covers to be operated into an open position in which the end portion of the respective roller tube assembly may be installed into the respective channel and into a closed position in which the end portion of the respective roller tube assembly is not accessible and hidden from view.

The mounting bracket 1202 may define multiple trenches including, for example, a first upper trench 1274A, a second upper trench 1274B, a first rear trench 1278A, and a second rear trench 1278B. The first upper trench 1274A and the second upper trench 1274B may be defined on the arm 1222. For example, the first upper trench 1274A and the second upper trench 1274B may be formed in/defined by an upper edge surface 1224 of the arm 1222 (e.g., mounting bracket 1202 may include an inside surface 1223A and an opposing top edge surface 1224 that may be perpendicular to inside surface 1223A). The first upper trench 1274A and the second upper trench 1274B may be substantially parallel and may extend along the arm 1222 in the radial direction R. The first upper trench 1274A may extend from the first channel 1230A to the base 1210. The mounting bracket 1202 may define a bore 1221A (e.g., a tunnel) in/defined by the arm 1222 that extends between the first upper trench 1274A and the first channel 1230A. The second upper trench 1274B may extend from the second channel to the base 1210. The mounting bracket 1202 may define a bore 1221B in the arm 1222 that extends between the second upper trench 1274B and the second channel of the second attachment member 1220B. The bores 1221A, 1221B may extend in the transverse direction T and the radial direction R (e.g., angularly) between the respective channel and the upper edge surface 1224 (e.g., the first upper trench 1274A or the second upper trench 1274B). For example, the bores 1221A, 1221B may extend at a substantially 45 degree angle from the radial direction R. It should be appreciated that the bores 1221A, 1221B may extend at other angles (e.g., from the radial direction R) and the other angles may result in the first upper trench 1274A and the second upper trench 1274B being longer or shorter, respectively. The first bore 1221A may define an opening 1227A in the rear wall 1234A. The second bore 1221B may define an opening 1227B in the rear wall 1234B. The bores 1221A, 1221B may also define respective openings in the first upper trench 1274A and the second upper trench 1274B. The first rear trench 1278A and the second rear trench 1278B may be defined by a rear surface 1218 of the base 1210. The first rear trench 1278A may extend to the first upper trench 1274A and the second rear trench 1278B may extend to the second upper trench 1274B. The first rear trench 1278A and the second rear trench 1278B may extend from the arm 1222 to a recess 1276 formed in/defined by the rear surface 1218 of the base 1210.

The mounting system 1200 may comprise a first connector 1260A removably attached to the mounting bracket 1202 within the first channel 1230A of the first attachment member 1220A, and a second connector 1260B (similar to first connector 1260A) removably attached to the mounting bracket 1202 within the second channel of the second attachment member 1220B. The first connector 1260A and the second connector 1260B may each have a similar structure to the connector 1160 of the mounting system 1100 and/or the connector 960 of the mounting system 900, for example, and may operate in a similar manner as the connector 1160 of the mounting system 1100 and/or the connector 960 of the mounting system 900 to provide electrical connection to the drive assembly of a respective roller tube assembly mounted to the first attachment member 1220A and the second attachment member 1220B, respectfully. The first connector 1260A may be provided at the end of a first cable 1270A, which may include one or more electrical conductors, such as wires 1272A. The second connector 1260B may be provided at the end of a second cable 1270B, which may include one or more electrical conductors, such as wires 1272B. The first cable 1270A may be received within the first upper trench 1274A in the arm 1222 of the mounting bracket 1202. The first cable 1270A may extend into the first channel 1230A via the bore 1221A in the arm 1222. The first cable 1270A may be received within the first rear trench 1278A in the base 1210 of the mounting bracket 1202. The first upper trench 1274A in the arm 1222 may be aligned with the first rear trench 1278A in the base 1210, for example, such that the first cable 1270A extends from the first upper trench 1274A to the first rear trench 1278A. The second cable 1270B may be received within the second upper trench 1274B in the arm 1222 of the mounting bracket 1202. The second cable 1270B may extend into the second channel via the bore 1221B in the arm 1222. The second cable 1270B may be received within the second rear trench 1278B in the base 1210 of the mounting bracket 1202. The second upper trench 1274B in the arm 1222 may be aligned with the second rear trench 1278B in the base 1210, for example, such that the second cable 1270B extends from the second upper trench 1274B to the second rear trench 1278B.

A depth of the first upper trench 1274A, the second upper trench 1274B, the first rear trench 1278A, and the second rear trench 1278B may be configured such that the respective cables 1270A, 1270B are recessed within the first upper trench 1274A, the second upper trench 1274B, the first rear trench 1278A, and the second rear trench 1278B, respectively. The first rear trench 1278A and the second rear trench 1278B may extend from the first upper trench 1274A and the second upper trench 1274B, respectively towards the recess 1276 of the base 1210, such that the respective cables 1270A, 1270B may be received in the recess 1276 in the base 1210 and extend into an electrical wallbox (e.g., such as the electrical wallbox 170) mounted in the structure behind the base 1210. The first upper trench 1274A, the second upper trench 1274B, the first rear trench 1278A, and/or the second rear trench 1278B may include features configured to keep the respective cables 1270A, 1270B in place (e.g., within the respective trench 1274A, 1274B, 1278A, 1278B). For example, the walls that define the trenches 1274A, 1274B, 1278A, 1278B may define a slight circular shape (e.g., such as a tubular shape).

The first upper trench 1274A and the second upper trench 1274B in the arm 1222 and first rear trench 1278A and the second rear trench 1278B in the base 1210 may be configured (and the cables 1270A, 1270B selected) such that a depth of the trenches 1274A, 1274B, 1278A, 1278B is deep enough so that the cables 1270A, 1270B are flush with or below the outer most surface of the upper edge surface 1224 of arm 1222 and below the outermost surface of the surface 1218 of base 1210. Additionally, the first upper trench 1274A and the second upper trench 1274B in the arm 1222 and the first rear trench 1278A and the second rear trench 1278B in the base 1210 may be configured (and the cables 1270A, 1270B selected) such that the cables 1270A, 1270B are retained in the respective trenches 1274A, 1274B, 1278A, 1278B by friction fit, although an adhesive, such as tape, may also be used. For example, the first upper trench 1274A and the second upper trench 1274B may define a distance similar to D1 and D1′ in the longitudinal direction that is less than a width of the cables 1270A, 1270B that is defined by distance similar to D2 or D2′. The mounting system 1200 may include a fastener 1280 (e.g., such as a screw) that is configured to secure the cables 1270A, 1270B within the respective rear trenches 1278A, 1278B. For example, the fastener 1280 may be configured to be secured to the base 1210 such that the fastener 1280 abuts the cables 1270A, 1270B (e.g., respective outer surfaces of the cables 1270A, 1270B) to retain the cables 1270A, 1270B in the respective rear trenches 1278A, 1278B. For example, the base 1210 may define an opening 1213 that is configured to receive the fastener 1280. The opening 1213 may be located between the rear trenches 1278A, 1278B. A portion (e.g., a head 1282) of the fastener 1280 may prevent the cables 1270A, 1270B from disengaging from the respective rear trenches 1278A, 1278B. The head 1282 of the fastener 1280 may extend over at least a portion of each of the rear trenches 1278A, 1278B, for example, such that the head 1282 of the fastener 1280 is configured to abut the cables 1270A, 1270B to prevent the cables 1270A, 1270B from being removed from the respective rear trenches 1278A, 1278B. It should be appreciated that although the figures depict the fastener 1280 as a screw, the fastener 1280 is not limited to a screw and instead could be a clip, a pin, a clasp, a catch, and/or another type of fastener. It should also be appreciated that although the figures show one fastener 1280, a plurality of fasteners 1280 can be used to retain the cables 1270A, 1270B in the respective rear trenches 1278A, 1278B. It should be appreciated that the connector 1260 of mounting system 1200 may be replaced by the connector 660 shown in FIG. 11A.

According to other examples, the mounting system 1200 (e.g., the base 1210 of the mounting bracket 1202) may include one or more second connectors (e.g., such as, the terminal block 480 shown in FIGS. 9A-9B, and/or the plug-in connector assembly 580 shown in FIGS. 10A-10D) that is electrically connected to the connectors 1260A, 1260B within the channels of the attachment members and are configured to electrically connect to wires extending from the structure (e.g., such as the wires 490 shown in FIGS. 9A-9B and/or the wires 590 shown in FIGS. 10A-10D).

The mounting bracket 1202 in such configurations and as described herein may include the trenches 1274A, 1274B, for example, in the arm 1222 and the bores 1221A and 1221B to accommodate wiring which may be routed to the base 1210. In addition and/or as an alternative, rather than connectors similar to connector 1260A, 1260B, the mounting system 1200 may include connectors similar to any of connectors 260, 360, 460, 560, and 660 as described herein within the channels of the attachment members, with the cables 1270A and 1270B routed from the connectors to the bores 1221A, 1221B and to the trenches 1274A, 1274B and possibly to trenches 1278A, 1278B, for example, in the base 1210. Other variations are possible.

It should be appreciated that the base 1210 may be substantially the width of the arm 1222 such that the base 1210 does not extend beyond the arm 1222. According to another example, a mounting system may be configured similar to mounting system 1200 but not include a base.

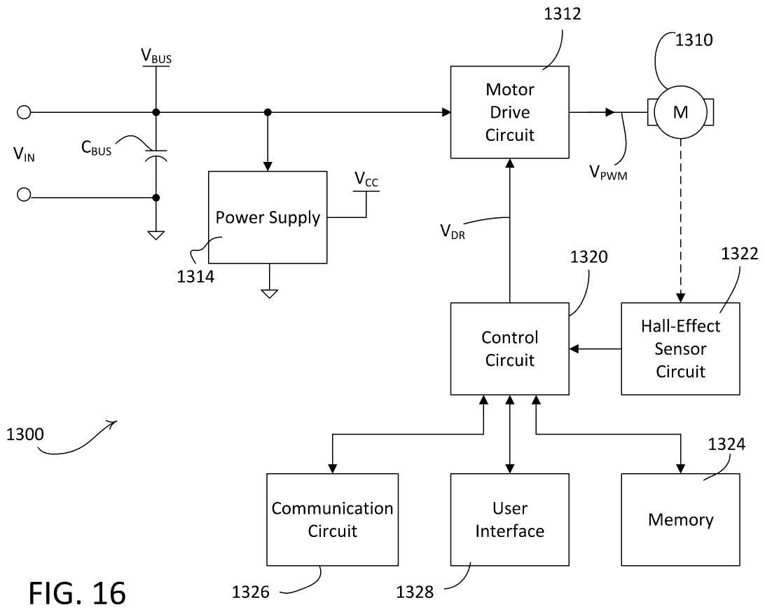

FIG. 16 is a simplified block diagram of a motor drive unit 1300 of a motorized window treatment (e.g., the drive assembly 160 of the motorized window treatment 100). The motor drive unit 1300 may include a motor 1310 (e.g., a direct-current motor) that may be coupled to a roller tube of the motorized window treatment (e.g., the roller tube 110) for rotating the roller tube. Rotation of the roller tube may be configured to raise and lower a covering material (e.g., the flexible material 120). The motor drive unit 1300 may include a motor drive circuit 1312 (e.g., an H-bridge drive circuit) that receives a bus voltage V_{BUS} and may generate a pulse-width modulated (PWM) voltage for driving the motor 1310. The bus voltage V_{BUS} may be produced across a bus capacitor C_{BUS}. The motor drive unit 1300 may include a power supply 1314 that may receive the bus voltage V_{BUS} and generates a supply voltage V_{CC} for powering the low-voltage circuitry of the motor drive unit. The motor drive unit 1300 may be configured to receive an input voltage VIN from, for example, an external power supply, such as a direct-current (DC) supply and/or an alternating-current (AC) supply. Additionally or alternatively, the motor drive unit 1300 may be powered by one or more batteries and/or a photovoltaic power source, such as a solar cell.

The motor drive unit 1300 may include a control circuit 1320 for controlling the operation of the motor 1310. The control circuit 1320 may include, for example, a microprocessor, a programmable logic device (PLD), a microcontroller, an application specific integrated circuit (ASIC), a field-programmable gate array (FPGA), or any suitable processing device or control circuit. The control circuit 1320 may be configured to generate one or more drive signals V_{DR} for controlling the motor drive circuit 1312. The one or more drive signals V_{DR} may be configured to control the rotational speed and/or direction of rotation of the motor 1310.

The motor drive unit 1300 may include a rotational position sensor, such as, for example, a Hall effect sensor (HES) circuit 1322, which may be configured to generate one or more Hall effect sensor signals V_{HES}. The one or more Hall effect sensor signals V_{HES} may indicate a rotational speed and/or a direction of the motor 1310 to the microcontroller. The rotational position sensor may include other suitable position sensors, such as, for example, magnetic, optical, and/or resistive sensors. The control circuit 1320 may be configured to determine a rotational position of the motor 1310 in response to the Hall effect sensor signals V_{HES} generated by the HES circuit 1322. The control circuit 1320 may be configured to determine a present position of the covering material in response to the rotational position of the motor 1310. The control circuit 1320 may be coupled to a memory 1324 (e.g., a non-volatile memory). The present position of the covering material and/or limits for controlling the position of the covering material (e.g., a fully open position and/or a fully closed position) may be stored in the memory 1324. The operation of a motor drive circuit and a Hall effect sensor circuit of an example motor drive unit is described in greater detail in U.S. Pat. No. 5,848,634, issued Dec. 15, 1998, entitled MOTORIZED WINDOW SHADE SYSTEM, and U.S. Pat. No. 7,839,109, issued Nov. 23, 2010, entitled METHOD OF CONTROLLING A MOTORIZED WINDOW TREATMENT, the entire disclosures of which are hereby incorporated by reference.

The motor drive unit 1300 may include a communication circuit 1326 that may allow the control circuit 1320 to transmit and receive communication signals, e.g., wired communication signals and/or wireless communication signals, such as radio-frequency (RF) signals. The motor drive unit 1300 may include a user interface 1328 having one or more buttons that allow a user to provide inputs to the control circuit 1320 during setup and/or configuration of the motorized window treatment. The control circuit 1320 may be configured to control the motor 1310 to control the movement of the covering material in response to a shade movement command received from the communication signals received via the communication circuit 1326 or user inputs received via buttons, for example) of a user interface 1328 (e.g., similar to buttons 117 as shown in FIG. 3B). The user interface 1328 may also include one or more light-emitting diodes (LEDs), for example, (e.g., similar to visual indicator 119 as shown in FIG. 3B) that may be illuminated by the control circuit 1320, for example, to provide feedback to the user of the motorized window treatment.

What is claimed is:

1-136. (canceled)

137. A motorized window treatment comprising:
a roller tube having flexible material that is attached thereto, the roller tube having first and second ends, the roller tube configured to rotate about a longitudinal axis that defines a longitudinal direction;
a motor drive unit located within the roller tube adjacent the first end of the roller tube, the motor drive unit configured to rotate the roller tube to adjust the flexible material between a raised position and a lowered position, the motor drive unit comprising an end portion that is accessible via the first end of the roller tube; and
a mounting bracket configured to support the first end of the roller tube, the mounting bracket comprising:
a base;
an arm configured to extend from the structure;
an attachment member extending from the arm;
a channel defined by the first attachment member, the channel configured to receive the end portion of the motor drive unit, wherein the channel defines a rear wall that is proximate to the arm and a first opening that is distal from the rear wall in a radial direction; and
a first trench formed in an edge surface of the arm, wherein the first trench is configured to be connected to receive electrical wiring for powering the motor drive unit; and
a connector connected to the electrical wiring and configured to be disposed in the channel, the connector further configured to be received within a second opening on the end portion of the motor drive unit to electrically connect the motor drive unit to the electrical wiring for powering the motor drive unit when the end portion of the motor drive unit is received within the channel, and wherein the mounting bracket is configured to mount the roller tube to a structure.

138. The motorized window treatment of claim 137, wherein the connector comprises:
a plug portion configured to be received within the second opening on the end portion of the motor drive unit; and
a base portion configured to abut the rear wall of the channel.

139. The motorized window treatment of claim 138, wherein the connector comprises a pair of arms that are configured to extend within the channel in the radial direction.

140. The motorized window treatment of claim 139, wherein the channel is defined by a first flange, a second flange, and a side wall that is distal from the first and second flanges in the longitudinal direction.

141. The motorized window treatment of claim 140, wherein a first arm of the pair of arms is located within a first slot defined between the first flange, and wherein the second arm of the pair of arms is located within a second slot defined between the second flange.

142. The motorized window treatment of claim 141, wherein the first arm defines a first ridge and a first tab that are configured to abut a first edge of the first slot, and wherein the second arm defines a second ridge and a second tab that are configured to abut a second edge of the second slot.

143. The motorized window treatment of claim 141, wherein the first arm defines a first groove that is configured to receive a first rail of the end portion of the motor drive unit, and wherein the second arm defines a second groove that is configured to receive a second rail of the end portion of the motor drive unit.

144. The motorized window treatment of claim 138, wherein the connector is removably attached to the mounting bracket.

145. The motorized window treatment of claim 138, wherein the plug portion comprises a plurality of openings that are configured to receive conductors located within the second opening when the end portion of the motor drive unit is received within the channel of the mounting bracket.

146. The motorized window treatment of claim 138, wherein the first trench extends to the channel.

147. The motorized window treatment of claim 146, wherein the attachment member defines a notch that extends between the first trench and the channel.

148. The motorized window treatment of claim 147, wherein the notch is configured to receive the electrical wiring.

149. The motorized window treatment of claim 146, wherein the arm defines a bore that extends from the channel to the first trench, and wherein the bore is configured to receive the electrical wiring.

150. The motorized window treatment of claim 146, wherein the mounting bracket further comprises:
a base; and
a second trench formed in a rear surface of the base and extending to the first trench, wherein the second trench is configured to receive the electrical wiring.

151. The motorized window treatment of claim 150, wherein the second trench is aligned in a transverse direction with the first trench.

152. The motorized window treatment of claim 151, wherein the base is configured to attach the mounting bracket to the structure.

153. The motorized window treatment of claim 152, wherein the connector is a first connector, and wherein the mounting bracket comprises a second connector configured to electrically couple the motor drive unit to a power source via the electrical wiring.

154. The motorized window treatment of claim 153, wherein the second connector connects the electrical wiring to electrical conductors received through an electrical wallbox.

155. The motorized window treatment of claim 153, wherein the second connector comprises a plurality of terminals that are located within the base.

156. The motorized window treatment of claim 138,
wherein the roller tube comprises a first roller tube;
wherein the attachment member comprises a first attachment member;
wherein the motorized window treatment comprises a second roller tube having flexible material that is attached thereto, the second roller tube configured to rotate about the longitudinal axis; and
wherein the mounting bracket further comprises a second attachment member extending from the arm and opposite the first attachment member, the second attachment member configured to support the second roller tube.

157. A mounting system for a motorized window treatment, the mounting system comprising:
a mounting bracket configured to support a first end of a roller tube of the motorized window treatment, the mounting bracket comprising:
a base;
an arm configured to extend from the structure;
an attachment member extending from the arm;
a channel defined by the first attachment member, the channel configured to receive an end portion of a motor drive unit of the motorized window treatment, wherein the channel defines a rear wall that is proximate to the arm and a first opening that is distal from the rear wall in a radial direction;
a first trench formed in an edge surface of the arm, wherein the first trench is configured to be connected to receive electrical wiring for powering the motor drive unit; and a connector connected to the electrical wiring and configured to be disposed in the channel, the connector further configured to be received within a second opening on the end portion of the motor drive unit to electrically connect the motor drive unit to the electrical wiring for powering the motor drive unit when the end portion of the motor drive unit is received within the channel, and wherein the mounting bracket is configured to mount the roller tube to a structure.

158. The mounting system of claim 157, wherein the connector comprises:
a plug portion configured to be received within the second opening on the end portion of the motor drive unit; and
a base portion configured to abut the rear wall of the channel.

159. The mounting system of claim 158, wherein the connector comprises a pair of arms that are configured to extend within the channel in the radial direction.

160. The mounting system of claim 159, wherein the channel is defined by a first flange, a second flange, and a side wall that is distal from the first and second flanges in the longitudinal direction.

161. The mounting system of claim 160, wherein a first arm of the pair of arms is located within a first slot defined between the first flange, and wherein the second arm of the pair of arms is located within a second slot defined between the second flange.

162. The mounting system of claim 161, wherein the first arm defines a first ridge and a first tab that are configured to abut a first edge of the first slot, and wherein the second arm defines a second ridge and a second tab that are configured to abut a second edge of the second slot.

163. The mounting system of claim 161, wherein the first arm defines a first groove that is configured to receive a first rail of the end portion of the motor drive unit, and wherein the second arm defines a second groove that is configured to receive a second rail of the end portion of the motor drive unit.

164. The mounting system of claim 158, wherein the connector is removably attached to the mounting bracket.

165. The mounting system of claim 157, wherein the plug portion comprises a plurality of openings that are configured to receive conductors located within the second opening when the end portion of the motor drive unit is received within the channel of the mounting bracket.

166. The mounting system of claim 157, wherein the first trench extends to the channel.

167. The mounting system of claim 166, wherein the attachment member defines a notch that extends between the first trench and the channel.

168. The mounting system of claim 167, wherein the notch is configured to receive the electrical wiring.

169. The mounting system of claim 166, wherein the arm defines a bore that extends from the channel to the first trench, and wherein the bore is configured to receive the electrical wiring.

170. The mounting system of claim 165, wherein the mounting bracket further comprises:
a base; and
a second trench formed in a rear surface of the base and extending to the first trench, wherein the second trench is configured to receive the electrical wiring.

171. The mounting system of claim 170, wherein the second trench is aligned in a transverse direction with the first trench.

172. The mounting system of claim 171, wherein the base is configured to attach the mounting bracket to the structure.

173. The mounting system of claim 172, wherein the connector is a first connector, and wherein the mounting bracket comprises a second connector configured to electrically couple the motor drive unit to a power source via the electrical wiring.

174. The mounting system of claim 173, wherein the second connector connects the electrical wiring to electrical conductors received through an electrical wallbox.

175. The mounting system of claim 173, wherein the second connector comprises a plurality of terminals that are located within the base.

176. The mounting system of claim 157,
wherein the roller tube comprises a first roller tube;
wherein the attachment member comprises a first attachment member;
wherein the motorized window treatment comprises a second roller tube having flexible material that is attached thereto, the second roller tube configured to rotate about the longitudinal axis; and
wherein the mounting bracket further comprises a second attachment member extending from the arm and opposite the first attachment member, the second attachment member configured to support the second roller tube.

177-277. (canceled)
